(19) United States
(12) Patent Application Publication
(10) Pub. No.: US 2024/0270902 A1
(43) Pub. Date: Aug. 15, 2024

(54) GROUP 4 COMPLEXES OF AMINE TRIS(PHENOLATE) LIGANDS, RING-OPENING POLYMERIZATION OF CYCLIC ESTERS EMPLOYING SAME, AND POLYMERS AND BLOCK CO-POLYMERS OBTAINED THEREBY

(71) Applicant: Ramot at Tel-Aviv University Ltd., Tel-Aviv (IL)

(72) Inventors: Moshe KOL, Tel-Aviv (IL); Rami HADOR, Tel-Aviv (IL)

(73) Assignee: Ramot at Tel-Aviv University Ltd., Tel-Aviv (IL)

(21) Appl. No.: 18/619,523

(22) Filed: Mar. 28, 2024

Related U.S. Application Data
(63) Continuation of application No. PCT/IL2022/051042, filed on Sep. 30, 2022.
(60) Provisional application No. 63/251,061, filed on Oct. 1, 2021.
(60) Provisional application No. 63/283,253, filed on Nov. 25, 2021.

(51) Int. Cl. C08G 63/82; C07F 7/00

(52) U.S. Cl. CPC C08G 63/823; C07F 7/003

(57) ABSTRACT

A family of organometallic complexes of zirconium and hafnium (or other group 4 metals) bound to amine tris(phenolate) ligands bearing at least one phenolate substituent which is aryl or heteroaryl, and uses of these complexes in a (e.g., sterocontrolled) polymerization of cyclic esters such as lactides are provided. Polyester-containing materials featuring defined stereochemical structures are also provided.

### RELATED APPLICATIONS

This application is a Continuation of PCT Patent Application No. PCT/IL2022/051042 having International filing date of Sep. 30, 2022, which claims the benefit of priority under 35 USC § 119(e) of U.S. Provisional Patent Application No. 63/251,061 filed on Oct. 1, 2021 and of U.S. Provisional Patent Application No. 63/283,253 filed on Nov. 25, 2021.

PCT Patent Application No. PCT/IL2022/051042 is also related to co-filed PCT International Patent Application entitled “STEREOGRADIENT POLYESTER COPOLYMERS AND PROCESSES OF PREPARING SAME” and having Attorney's Docket No. 93425 and to U.S. Provisional Patent Application No. 63/283,254 filed Nov. 25, 2021. The contents of the above applications are all incorporated by reference as if fully set forth herein in their entirety.

### FIELD AND BACKGROUND OF THE INVENTION

The present invention, in some embodiments thereof, relates to chemistry and, more particularly, but not exclusively, to novel organometallic complexes, to uses thereof in catalytic ring opening polymerization of cyclic esters and to polyesters, and block copolymers, including, but not limited to, stereoblcok polyester copolymers, obtained thereby.

Block copolymers are copolymers consisting of regularly or statistically alternating two or more different homopolymer blocks that differ in composition or structure. Each homopolymer block in a block copolymer represents polymerized monomers of one type. The homopolymer blocks can differ from one another by the chemical composition of the monomers composing each homopolymer block and/or by the stereoconfiguration of the homopolymer block (e.g. isotactic and syndiotactic configurations).

For example, while copolymers composed of A and B monomers may be arranged is a random or alternating fashion as follows:

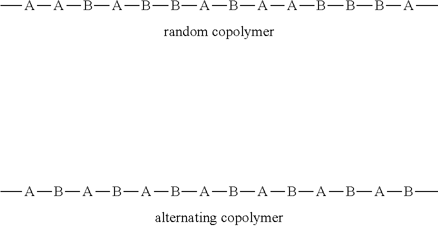

Block copolymers comprise clusters of monomers A and B as exemplified in the following non-limiting example of a diblock copolymer:

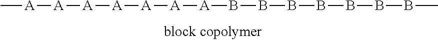

Block copolymers typically combine the properties of their constituent blocks, thus differentiating such copolymers from random copolymers that do not exhibit the characteristics of each of their components.

The number of homopolymer blocks may be specific (e.g., diblock, triblock, tetrablock, etc.) or non-specific, if the blocks are formed randomly (multiblock).

The properties of block copolymers may be similar to the sum of the properties of a mixture of the homopolymers composing them, but the presence of chemical bonds between the blocks ensures their stability and prevents their separation with the release of individual components. In addition, block copolymers may exhibit unique properties such as formation of micelles. Synthesis of block copolymers significantly expands the possibilities for modifying the properties of polymers. The combination of properties of homopolymers in a block copolymer typically manifests itself in the thermomechanical properties and transition temperatures of block copolymers.

Among the sophisticated polymers, block copolymers are the most important group, because they can lead to materials that combine desirable properties of each of the blocks, such as, for example, crystallinity and elasticity, and to specialty morphologies such as lamellae, rods or spheres by microphase separation of the blocks into specific regimes.

Plastic materials play an inseparable role of modern life. Their ready availability from cheap starting materials combined with established technologies for their production, and their immense range of properties make them core ingredients in durable goods such as construction materials, household items, fibers, and auto parts, in disposable materials such as food packaging disposable cups and plates, and in biomedical and biocompatible products and applications including artificial implants, stents, sutures, controlled drug release, etc.

The properties of plastic materials are derived from their molecular structure, namely, the building blocks from which the polymer chains are built, the type and degree of regularity of the building blocks in the chains, such as the regioregularity and stereoregularity, the general type of the polymer, e.g., linear, branched, or cross-linked type polymer, and the possibility of combining different building blocks either within the same chain or in mixtures of separate chains. Properties such as melting transition, glass transition, impact resistance, tackiness, film formation, gas permeability, rate of decomposition, etc., are a direct outcome of the specific structure of the polymeric material.

The ability to manufacture polymeric materials having a ‘tailor-made’ structure is a key-step on the way to improving the properties of existing plastics, replacing old plastics with new ones having lower environmental signature, and finding new applications for plastic materials.

Biodegradable materials derived from bio-renewable resources are attracting considerable current interest as possible alternatives to the commonly employed plastics such as polypropylene, that are derived from the depleting petroleum feedstock. Aliphatic polyesters such as poly(lactic acid) (PLA), and poly(8-caprolactone) (PCL) have been explored and introduced towards this end. Of these, the most commercially promising material is PLA due to its mechanical and physical properties and its synthesis from starting materials originating from biomass such as corn. As the degradation products of PLA are non-toxic, it has found biomedical applications as well as commodity applications. PLA is one of the major growth engines in the area of biopolymers, and its demand is estimated to double every 3-4 years.

The most common process employed for the industrial production of these polyesters is the catalytic Ring Opening Polymerization (ROP) of cyclic esters (lactones), and in particular lactide—the cyclic dilactone of lactic acid—for producing PLA.

Lactide is chiral, having two stereogenic centers leading to three possible stereoisomers: L-lactide (the natural stereoisomer), D-lactide, and meso-lactide. Ring opening polymerization of lactides may therefore lead to PLAs of various tacticities, (e.g., heterotactic, isotactic (racemic and stereoblock), and syndiotactic), as shown in Scheme 1 below. Isotactic PLA may be obtained from either L-lactide or D-lactide, even when non-stereoselective catalysts are employed. On the other hand, the formation of heterotactic PLA from either racemic lactide (rac-lactide) or meso-lactide and the formation of syndiotactic PLA from meso-lactide only, require the use of stereoselective catalysts. Heterotactic PLA is amorphous while syndiotactic PLA may be crystalline, depending on its tacticity degree. Highly syndiotactic PLA (Pₛ=0.96) has previously been prepared only in a low molecular weight form by sluggish catalysts, and as was recently stated by Worch et. al., in Nat. Rev. Chem. 2019, 3, 514-535: “Few studies have focused on the synthesis of this polymer and its full utility perhaps remains to be uncovered”.

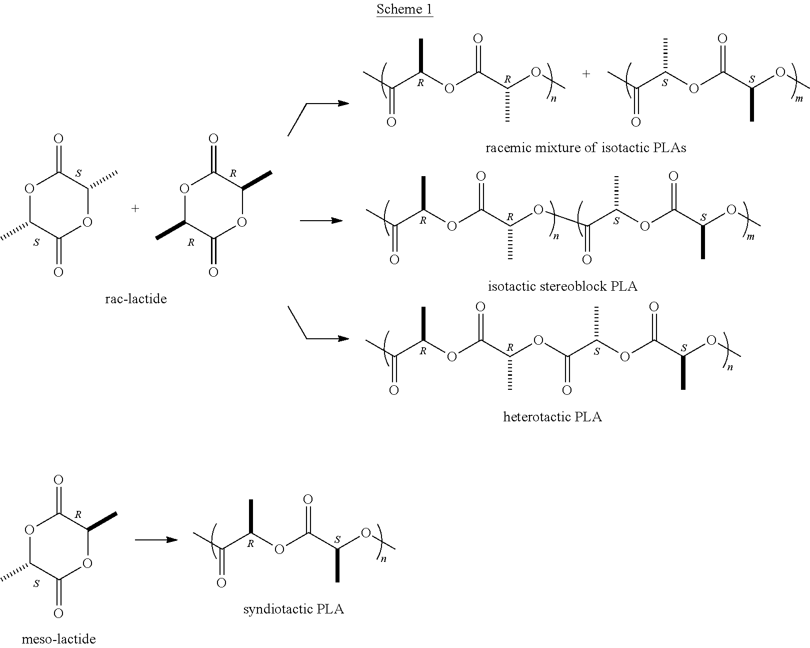

### INCLUDEDPITCTURE

“http://pubs.rsc.org/services/images/RSCpubs.ePlatform.Service.FreeContent.ImageService.svc/I mageSerice/Artcleimae/2010/CS/b81005a/b81065a-s2gif” \*

### MERGEFORMATINETINCLUDEPICTURE

“http://pubs.rsc.org/services/images/RSCpubs.ePlatform.Service.FreeContent.ImageService.svc/I mageService/Articleimage/2010/CS/b810065a/b810065a-s2.gif” \*

### MERGEFORMATINETINCLUDEPICTURE

“http://pubs.rsc.org/services/images/RSCpubs.ePlatform.Service.FreeContent.ImageService.svc/I mageService/Articleimage/2010/CS/b810065a/b810065a-s2.gif” \* MERGEFORMATINET

Ring opening polymerization (ROP) of lactides mediated by metal-based catalysts typically follows the coordination-insertion mechanism of a lactide ester bond to a metal-alkoxo bond. For rac-LA polymerization, the stereochemical preference could be either heterochiral (leading to heterotactic PLA) or homochiral (leading to one of the forms of isotactic PLA).

When mixtures of stereoisomers are polymerized, both S-stereocenters and R-stereocenters will exist in the polymeric chains. The relative amount of stereocenters (R to S ratio) and their order (stereoregularity) will dictate the properties of the PLA. Most relevant mixtures are typically of lactide stereoisomers in which the homochiral monomer (typically L-lactide, but possibly D-lactide) is the dominant constituent, and one of its stereoisomers, in particular meso-lactide, but possibly also D-lactide (or a mixture of meso-lactide and D-lactide), exists as the minor constituent (or meso-lactide or a mixture of meso-lactide and L-lactide when D-lactide is taken as major monomer).

The physical and chemical properties of the PLA depend on its architecture and stereoregularity, which is an outcome of the monomer constitution and the stereoselectivity of the ROP catalyst employed. Of all forms of PLA, the most valuable one is poly(L-lactic acid) (PLLA) formed by the ring opening polymerization of L-lactide. Pure L-lactide leads to a semicrystalline PLLA having a melting temperature of 170-180° C.

L-lactide is industrially produced by the high-temperature “two-step” process wherein lactic acid is first condensed to an oligo(L-lactic acid) and then undergoes a catalytic depolymerization [Van Wouwe et al. ChemSusChem 2016, 9 (9), 907-921]. This process is accompanied by epimerization which leads to substantial formation of stereoisomers and in particular meso-lactide, estimated to form in as much as 5-15% depending on the specific process [Dusselier et al. Science 2015, 349 (6243), 78-80]. See, Background Art FIG. 1.

To avoid the handling of solvents, the industrial catalytic process for ROP of lactide takes place at high temperatures, preferably wherein both the monomer (lactide) and the formed polymer (PLA) are in the molten-state, typically at a temperature of 180° C. or higher.

The currently most employed industrial catalyst for ROP of lactides is tin(II) octanoate or related tin-based compounds. Tin (Sn) octanoate combines several advantages: (1) it is active at high temperatures, enabling its use in melt-processes; (2) it may be employed in low loadings, typically 300 ppm (relative to monomer) or less; and (3) it gives rise to high molecular weight PLA. However, it also suffers from several disadvantages, including, amongst others, toxicity (which may be particularly harmful in medical and food applications), residual activity of the remaining catalyst in the polymeric product (which leads to thermal instability and degradation of the polymeric product and affects, inter alia, the quality of the final product upon processing the polymeric material). Reference can be made in this regard, for example, to Jones et. al. in Materials Science and Engineering C 2017, 80, 69-74; Stjerndahl et. al. in Biomacromolecules 2007, 8, 937-940; WO 2020/002358; Dorgan et. al., in Journal of Rheology, 2005, 49, 607-619; U.S. Pat. No. 5,338,822; and WO 2009/121830, where these disadvantages are discussed.

The drawbacks of the industrially-employed tin octanoate, which include its toxicity on one hand, and its tendency to degrade the PLA during melt-processing post-polymerization on the other hand, has prompted massive efforts for designing catalysts that would be able to replace the tin octanoate in ring opening polymerization catalysis. However, only a small portion of these catalysts were tested under the high-temperature melt conditions employed in the industrial process, while those that were tested under such conditions typically require relatively high catalyst loadings or additional purification steps of the monomer.

For example, EP Patent Application Pub. No. 2799462 describes a method for manufacturing polylactide, employing a metal-coordination compound as polymerization catalyst and polymerizing the lactide in liquid phase, characterized in that the polymerization catalyst comprises a metal-ligand coordination compound whereby the parent ligand is an amine tris(phenolate) ligand bearing ortho,para substituents being either an H atom, an aliphatic group, a halide atom or a nitro group and the metal is at least one of Zr and Hf. Polymerizations were carried out at 180° C. A specific catalyst is employed wherein the ortho,para substituents on the amine tris(phenolate) ligand are methyl groups, and the zirconium complex formed is a zwitterionic bis(homoleptic) complex. The lowest amount of this catalyst described is 308 ppm relative to lactide monomer, that led to 71% conversion of L-lactide within 5 hours. Increasing the relative quantity of the zirconium catalyst of this ligand, led to increased conversions in the same period of time: 676 ppm, 93% conversion; 1345 ppm, 96% conversion. The increase in relative catalyst ratio led to decrease in the stereoregular-integrity of the PLA, apparently resulting from enhanced epimerization in the presence of large catalyst quantities. Examples are also given wherein 1-hexanol was added as a co-initiator: Polymerizations of L-lactide at 180° C. for 5 hours employing 640 ppm of the same zirconium catalyst and 1-hexanol in ratios ranging between 1130 ppm (95% conversion) and 10300 ppm (96% conversion), led to PLA with decreased molecular weights and improved stereoregularities. Reference is also made to U.S. Patent Application Publication No. 2005/0009687, which teaches titanium complexes as a polymerization catalyst for PLA, cited therein.

Hermann et al., in Angew. Chem. Int. Ed. 2020, 59, 21778-21784, report highly active cationic bisguanidine zinc complexes as catalysts for polymerization of unpurified lactide under industrial conditions. Polymerizations were run at 150° C. with unpurified racemic lactide. The lowest ratio of catalyst-to-monomer employed was 1:5000 (200 ppm). However, this was used only for racemic-lactide and not for L-lactide employed in the industrial production of the isotactic PLA. At 200 ppm catalyst loading, the unpurified racemic-lactide was polymerized slowly to a low conversion of 32% after 40 minutes because of impurities in the technical-grade lactide, and purification of the lactide by sublimation was required to attain high conversions. L-lactide was polymerized only in a purified recrystallized form and only in solution, with the lowest ratio of catalyst-to-monomer being 1:1000 (1000 ppm) employing either toluene at 100° C. or diphenyl ether at 150° C.

McKeown, in Polym. Chem. 2018, 9, 5339-5347 describe highly active zinc catalysts for polymerization of L-lactide in the melt at 180° C. The L-lactide was recrystallized prior to its polymerization. The lowest ratio of catalyst-to-monomer employed was 1:10000 (100 ppm). In the presence of 100 equivalents of benzyl alcohol as co-initiator, 1(Zn-catalyst):100(benzyl alcohol):10000(recrystallyzed L-lactide), 90% conversion was recorded after 3 minutes polymerization, giving a low molecular weight polymer of Mw=13050 and a relatively broad molecular weight distribution of PDI=1.47. Reducing the co-initiator ratio to 1:15:10000 gave 63% conversion after 5 minutes, with Mw=60600 and PDI=1.47. Eliminating the co-initiator altogether (1:0:10000) led to lower activities: 38% conversion after 3 minutes with Mw of 48950 and PDI=1.29, and 72% conversion after 15 minutes with Mw of 82400 and PDI=1.64.

Ebrahimi et al. in ACS Catal. 2017, 7, 6413-6418 report air- and moisture-stable indium catalysts for the ring opening polymerization of cyclic esters. In polymerization of racemic-lactide, the lowest ratio of catalyst to monomer was 1:10000 (100 ppm), and a typical polymerization run at 120° C. for 120 minutes resulted in 70-80% conversion. Reported polymerizations of L-lactide aiming at block-copolymer synthesis employed higher catalyst loadings such as 1:(700+500+700) (454 ppm) at 155° C.

Chmura et al., Chem. Commun., 2008, 1293-1295, describe zirconium and hafnium amine tris(phenolate) alkoxides for the ring-opening polymerization of rac-lactide, which yield highly heterotactic polylactide.

Turning back to the plastic industry, block copolymers of polyesters and hydrophilic or amphiphilic polymers such as PEG, have been recognized as highly desirable in many applications, including medical devices and other applications, for being bioresorbable, biocompatible and for enabling control of the mechanical properties as needed. Exemplary such block copolymers are marketed under the trade name Resomer®. PEG-PLA copolymers are broadly employed for drug release, medical implants and other biomedical applications. In the currently available PEG-PLA copolymers, the PLA block(s) is/are either isotactic/homochiral, such as PLLA or PDLA, or atactic like PDLLA.

In addition to the above-mentioned drawbacks of the currently employed industrial catalyst tin(II) octanoate, this catalyst features marginal (if at all) stereoselectivity, and processes employing same do not result in significant preference towards a particular lactide-stereoisomer when such mixtures are being polymerized. Consequently, polymerization of stereoimpure L-lactide leads to essentially a random copolymer in which the stereoerrors (R-centers) are randomly/statistically distributed along the polymer chains. This is particularly true for L-lactide which includes meso-lactide as minor constituent. See, Background Art FIG. 1.

An approximate 5° C. decrease in melting temperature for every 1% of meso-lactide in the L-lactide stream, and complete loss of crystallinity at about 10-12% of meso-lactide were reported, as is further detailed hereinafter. Therefore, the current production processes require an additional step of meso-lactide removal, achieved e.g., by vacuum distillation. The recovered meso-lactide is either discarded, returned to the L-lactide stream, or transformed into racemic lactide and reacted further.

In recent years, vast efforts have been invested in developing alternative methods for production of L-lactide wherein the meso-lactide contamination would be minimized, including “one-step” processes. To date, these processes have not been implemented on an industrial scale.

To a large extent, the random distribution of stereoerrors when tin(II) octanoate is employed as catalyst would also apply to mixtures of D-lactide and L-lactide. As stated by Drumright et. al. (Adv. Mater. 2000, 12, 1841-1846): “To a close approximation, the stereochemical make-up of the lactide monomer stream determines the stereochemical composition of the resulting polymer.” The presence of these stereoerrors leads to PLLA of inferior quality: for example, as demonstrated by Kolstad et. al., in J. Appl. Polym. Sci. 1996, 62, 1079-1091, for every 1% of meso-LA, a decrease of 3° C. in the melting temperature of the polymer is found, and at about 15% of meso-LA in the monomer stream, the polymer becomes amorphous (non-crystalline). Additionally, the crystallization half time increases by roughly 45% for every 1 weight % increase in the meso-lactide.

Therefore, for obtaining high-melting and fast-crystallizing PLLA, the meso-lactide needs to be removed from the monomer mixture. S. Saeidlou et. al., review poly(lactic acid) crystallization in Prog. Polym. Sci. 2012, 37, 1657-1677. They report that the melting temperature decreases linearly with the D-lactate content, and that the slope of these lines varies between −5.5 and −5.0, meaning that 1% D-unit content results in approximately 5° C. reduction in melting temperature. They note that at about 10-12 mol % (in the case of random distribution) of non-crystallizable unit (i.e., R-stereocenters in a majority of S-stereocenters), crystallinity is extremely low and so lengthy that PLA can be considered completely amorphous. Thus, injection molding requires rapid crystallization rates, which can be achieved by PLA that contains less than 1% D-isomer and often with the addition of nucleating agents, while extrusion-thermoforming is optimized at a D-isomer content that does not allow crystallization to occur during the melt processing steps, with an effective range of 4-8% D-isomer content.

The undesired presence of the meso-lactide in the L-lactide stream, its influence on the properties of the resulting PLLA, parameters which affect the extent of meso-lactide formation, processes for removing meso-lactide from the monomer stream, and alternative methods for production of L-lactide with minimal formation of meso-lactide, have been widely addressed in the art, as shown in the following representative reports.

U.S. Pat. No. 5,3247,058 describes parameters that encourage the formation of the undesired meso-lactide, including ionic impurities, increased molecular weight of the oligo-lactide prior to depolymerization, and increase in the level of the catalyst.

U.S. Pat. No. 6,326,458 describes a process which controls the racemization to produce a polymer grade lactide of selected optical purity and composition. It is noted that it may be necessary to subject the substantially purified lactide to further purification in a second distillation system prior to polymerization, so as to form at least two purified lactide streams, one meso-lactide enriched and one meso-lactide depleted. The extent of formation of meso-lactide in the process may be appreciated in example 1.7 of this patent wherein 0.05 weight % of antioxidant yielded a lactide containing about 4-8% meso-lactide while decreasing the antioxidant to 0.025 weight % the meso-lactide content increased to 12-19%.

U.S. Pat. No. 5,521,278 and WO 1996/006092 describe a process for the manufacture of lactide from a solution of lactic acid in de-ionized water. It is noted that while high temperatures are desired for increasing the water removal rate, this high temperature also leads to excessive racemization. The effects of longer time and higher sodium content on the increase in meso-lactide formation are described as well.

U.S. Pat. No. 8,674,056 describes a process in which the meso-lactide is separated from the formed lactide mixture which contains S,S— R,R— and meso-lactide. Meso-lactide is then recycled into the process.

WO 2010/105143 teaches that polylactide grades are distinguished by the relative proportions of R-lactic units and S-lactic units they contain. Polylactides in which one form is very highly predominant are typically used in applications in which a highly crystalline material is needed (typically for its thermal properties), or in which, due to processing constraints, it is important that the product develops its crystallinity rapidly. In those cases, the predominant form of lactic acid, either the R— or the S— form, usually constitutes at least 98% of the lactic units in the polymer. Polylactides containing the two forms of lactic units in a ratio of from 85:15 to 98:2 are used in applications in which only a moderate amount of crystallinity is needed, or in which a slower rate of crystallization is acceptable.

Polylactides containing no more than 85% of either form of lactic units tend to be mainly amorphous materials, which develop only small amounts of crystallinity at most and tend to do so slowly if at all. It is noted that the elevated temperature involved in converting the enantiomerically-pure L-lactic acid to lactide leads to racemization and that perhaps 1-10% of the lactic acid is racemized to form the other enantiomer, although this amount can vary substantially, depending on the actual process. Therefore, the obtained lactide is a mixture of S,S-lactide, R,R-lactide and meso-lactide. It is noted that the lactide mixture contains more meso-lactide than desired in the polymerization step, and in such a case, most or all of the meso-lactide needs to be removed. It is stated that the difficulty and cost of removing the impurities from the meso-lactide have been such that the meso-lactide is usually discarded or used in other, lower-value applications. It is noted that the crystallinity properties of the PLA copolymers prepared from a mixture of S,S-lactide and a given proportion of meso-lactide or S,S-lactide and the same proportion of R,R-lactide will be the same even though the latter includes a double amount of R-centers, because the crystallinity average length of the sequences of consecutive S-lactic units in the polymer is very close statistically. The benefit of converting the removed meso-lactide to racemic lactide is expressed in the crystallization rates, as it is reported that a higher proportion of the less predominant enantiomer can be present in an S,S-lactide/R,R-lactide copolymer than in an S,S-lactide/meso-lactide or R,R-lactide/meso-lactide copolymer, while retaining equivalent crystallization rates.

WO 2009/077615 describes a method for obtaining lactide by thermal cracking of lactic acid oligomers in the presence of phosphite metal salts. The oligo(lactic acid) was found to have a stereospecificity of 98.5% which should amount to a minimum of 3% of meso-lactide following the depolymerization step.

M. Dusselier et. al. in Science 2015, 349, 78-80, note that the industrial two-step process achieves low selectivity of 50-60% mainly due to racemization leading to unwanted meso-lactide (5 and 15 mol % of meso-lactide are claimed to be common in the current industrial process, starting from enantiopure L-lactic acid) and formation of polymeric waste residue which requires strenuous downstream purification. This article describes the direct conversion of aqueous lactic acid to lactide with Brönsted acidic zeolite catalysts with less than 1 mol % of meso-lactide in the total lactide fraction. This process requires the use of high-boiling solvents such as o-xylene for removal of the water.

P. Van Wouwe, et. al. review lactide synthesis and chirality control in ChemSusChem 2016, 9, 907-921. The synthesis of lactide from lactic acid is described as accounting for 30% of the PLA cost. It is noted that while the production of meso-lactide was patented in U.S. Pat. No. 5,214,159, this isomer is generally undesired. PLA of high quality requires minimal racemization and the employment of enantiopure lactide and methods are reviewed which minimize the formation of meso-lactide in the two-step process, or wherein meso-lactide is recycled via hydrolysis.

R. De Clercq et. al., review the heterogeneous catalysis for bio-based polyester monomers from cellulosic biomass in Green Chem., 2017, 19, 5012. They note that although the one-step process simplifies lactide synthesis, it requires the use of organic solvents that are continuously kept under reflux during the reaction.

R. De Clercq et. al., report the catalytic gas-phase production of lactide from alkyl lactates in Angew. Chem. Int. Ed. 2018, 57, 3074-3078. They describe the production of lactide involving a continuous catalytic gas-phase transesterification of alkyl lactates employing supported TiO₂/SiO₂ catalysts which are highly selective to lactide, with minimal lactide racemization limited to <7% of the lactides in meso-form, compared to common values up to 15% in patented industrial processes.

Y. Zhang et. al., report the efficient synthesis of lactide with low racemization catalyzed by sodium bicarbonate and zinc lactate in ACS Sustainable Chem. Eng. 2020, 8, 2865-2873. They describe a complex catalytic system composed of Zn(La)₂ and NaHCO₃ that offers both high yield and high purity, reaching a lactide yield above 95.63% and purity up to 97.86% in 3.25 hours.

M. Ghadamyari et. al., describe the one-step synthesis of stereo-pure L,L lactide from L-lactic acid, in Catal. Commun. 2018, 114, 33-36. They report the one-step synthesis of L,L-lactide with high selectivity and yield (99%) in the absence of racemization by applying Cs₂CO₃ as catalyst.

V. Botvin et. al., review the syntheses and chemical transformations of glycolide and lactide as monomers for biodegradable polymers in Polym. Degrad. Stabil. 2021, 183, 109427. They report that while intensive studies on the synthesis of cyclic diesters have significantly reduced the cost of their production technology, the large-scale producers of biodegradable polymers continue to use the two-stage technology. Among others, the need to remove aromatic solvents is a disadvantage, requiring the need for recycling technology.

Zhu et. al. describe the conversion of meso-lactide to isotactic polylactide by a two step-process including epimerization followed by kinetic resolution in J. Am. Chem. Soc. 2015, 137, 12506-12509. They note that the two-step lactide production process involves the formation of considerable amount of meso-LA as a byproduct or waste that needs to be removed from the rest of the LA stream, substantially affecting the economy of the manufacturing of PLLA. Full conversion of meso-lactide to racemic lactide requires precipitation from solution and the kinetic resolution is conducted in solution.

As shown in the exemplary literature reports above, the two-step industrial production of L-lactide leads to formation of meso-lactide as an undesired side-product, since its presence in the polymerization stream reduces the crystallinity of the produced PLLA. Removing the meso-lactide is costly, and converting it to racemic lactide which is then either re-introduced into the polymerization mixture or reacted in a kinetic resolution polymerization constitute only a partial solution. Intensive research into alternative methods for L-lactide production with reduced formation of meso-lactide such as the one-step conversions have yet to reach industrial implementation. All these reports indicate that meso-lactide is still an obstacle in the current PLA production technology.

There are several reports of complexes of amine tris(phenolate) ligands which promote the stereoselective polymerization of either meso-lactide or rac-lactide. These include, for example, Chmura et. al. in Chem. Commun. 2008, 1293-1295; and Buffet et. al. in Macromolecules 2010, 43,10201-10203.

These previously reported catalysts were never employed in the polymerization of mixtures of meso-lactide and L-lactide nor for the polymerization of mixtures of racemic-lactide and L-lactide. The only reports of polymerization of such mixtures employed the industrial catalyst tin octanoate for which very low, if any, stereoselection was attained in the copolymerization. For example: Thakur et. al. (Macromolecules 1998, 31, 1487-1494) stated that: “. . . poly(80L10D10M): As expected, the meso-lactide fraction in the polymer is almost independent of the conversion, whereas the D-lactide is enriched at lower conversions as was observed for 80L20D polymerization.” For example, Huang et. al. (Macromolecules 1998, 31, 2593-2599) noted regarding copolymers of meso-lactide/L-lactide obtained with tin octanoate: “Previous studies have shown that these copolymers are essentially random”. Selective polymerizations of stereoisomer mixtures of lactide by metal complexes of tris(pyrazolyl)borate ligands were reported by M. H. Chisholm et. al., in J. Am. Chem. Soc. 2000, 122, 11845-11854. These lactide mixtures consisted of racemic-lactide and meso-lactide.

As described in WO 2010/105143, meso-lactide can be converted to racemic-lactide (namely a 1:1 mixture of D-lactide and L-lactide). This racemic-lactide can then be added to either L-lactide or D-lactide to form a non-racemic mixture of D-lactide and L-lactide. Polymerization of this mixture with tin octanoate produces a polymer whose crystallinity is higher in comparison to that produced by the original mixture of meso-lactide and L-lactide, because the average distance between stereoerrors will be longer, as confirmed experimentally by J S. Baratian et. al., in Macromolecules 2001, 34, 4857-4864.

Additional Background Art includes Dae Young Bae et al., Dalton Trans., 2019, 48, 9617; JP Pat. No. 5751422; WO 2017/137990; and WO 2018/002941.

Further additional Background Art includes Hador et al., ACS Catal. 2022, 12, 4872-4879; and Hador et al., Angew. Chem. Int. Ed. 2022, e202207652.

### SUMMARY OF THE INVENTION

As discussed hereinabove, currently available catalysts fail to provide a suitable alternative to tin-based catalysts in the polymerization of cyclic esters by ROP in the melt.

The present inventors have now designed a new family of zirconium and hafnium complexes bound to amine tris(phenolate)-type ligands, wherein at least one of the substituents of at least one of the phenolate-type rings is an aryl group, such as, for example, substituted or unsubstituted phenyl or naphthyl, or a heteroaryl group.

The present inventors have prepared various such metal complexes and have explored their catalytic activity in the ring opening polymerization of various lactides under various conditions, including solution polymerizations at different temperatures and melt polymerizations. In particular, the activities of these complexes were found to be unexpectedly and unprecedentedly high at very low catalyst loadings, being typically below 20 ppm, and reaching or exceeding very high conversions within industrially-relevant melt polymerization times of 30 minutes to several hours at temperatures of 180° C., and yielding PLA of high molecular weights.

The present inventors have demonstrated that these complexes provide precise control on the tacticity of the obtained polymers and have utilized this exceptional performance, along with the living nature of the catalysis, to provide varying block copolymers, including varying stereoblock copolymers.

The present inventors have further practiced the application of in-situ formed complexes, alleviating the requirement for their prior synthesis, isolation and purification. Thus, mixing the ligand precursor and a metal-alkoxo precursor, adding the lactide monomer and heating to the desired temperature resulted in polymerization performance similar to that attained with the pre-fabricated catalysts.

Embodiments of the present invention therefore relate to novel zirconium and hafnium complexes comprising a tetradentate-trianionic {NO₃}-type amine tris(phenolate)-type ligand, represented by Formula I herein, to uses thereof in ring opening polymerization of cyclic esters such as lactides, to polymers and block copolymers (e.g., stereoblock copolymers) obtainable by these processes, to articles-of-manufacturing containing such polyesters, to novel tetradentate-trianionic {NO₃}-type amine tris(phenolate) ligands usable in preparing such complexes, and to processes of preparing the ligands and complexes.

The present inventors have further utilized the newly designed complexes in the development of a new approach for preparing highly stereo-controlled poly(lactic acid), while circumventing the need to purify the lactide precursor monomer prior to the polymerization. As discussed hereinabove, the production of an L-lactide monomer precursor, for example, typically results in a mixture of the L-lactide with meso-lactide, and hence requires removal of the latter in order to reduce stereoerrors in the PLLA polymer (see, Background Art FIG. 1). According to the newly designed approach, and while utilizing the high kinetic preference of the newly designed complexes, instead of avoiding stereoerrors by removing the meso-lactide prior to polymerization, the stereoerrors in the polymer are tolerated, by crowding them in a stereogradient copolymer. The present inventors have utilized the preference of these catalysts for polymerization of, for example, meso-lactide in meso-lactide/L-lactide monomer mixtures, for obtaining gradient rather than random PLA-copolymers. These stereogradient co-polymers exhibit enhanced crystallinities, which are expressed in their reduced solubilities and increased melting enthalpies and temperatures. The present inventors have shown that such co-polymers can be produced in the presence of the newly designed catalysts under industrially-relevant conditions, namely, in the melt at 180° C., as well as at lower temperatures.

Embodiments of the present invention further concern the production of stereogradient copolymers of poly(lactic acid) (PLA) from L-lactide which is contaminated with its stereoisomers, for example, meso-lactide, D-lactide, or mixtures thereof, or from D-lactide which is contaminated with its stereoisomers, for example, meso-lactide, L-lactide, or mixtures thereof, by employing the newly designed catalysts. The stereogradient copolymers feature enhanced crystallinities in comparison to the essentially random copolymers of poly(lactic acid) which are prepared from identical mixtures of lactide stereoisomers but prepared with catalysts which exhibit low or negligible stereoselectivity, such as the industrially-employed tin octanoate.

According to an aspect of some embodiments of the present invention there is provided an organometallic complex represented by Formula I:

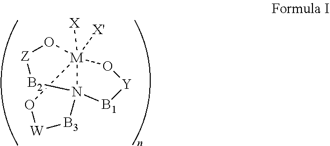

wherein:
n is 1, 2, 3 or 4, representing the nuclearity of the complex;
the dashed line represents a covalent or a coordinative bond representing a bond between a donor atom and a metal;
M is a tetravalent (group 4) metal;
X is a monoanionic ligand;
X′ is a neutral ligand, such as an alcohol, or is absent;
W, Y and Z are each independently arylene or heteroarylene, at least one of W, Y and Z being a substituted arylene or heteroarylene, the at least one substituted arylene or heteroarylene comprising at least one aromatic (aryl or heteroaryl) substituent; and
B1, B2 and B3 are each independently a bridging moiety linking between the respective aryl or heteroaryl and the nitrogen atom, or is absent.

According to some of any of the embodiments described herein, n is 1 and the complex is a mononuclear complex.

According to some of any of the embodiments described herein, n is 2 and the complex is a dinuclear complex.

According to some of any of the embodiments described herein, M is zirconium.

According to some of any of the embodiments described herein, M is hafnium.

According to some of any of the embodiments described herein, X is selected from alkyl, alkaryl, cycloalkyl, aryl, amide, alkoxy, thioalkoxy, aryloxy, thioaryloxy, halo and amine.

According to some of any of the embodiments described herein, X′ is a neutral ligand selected from alkyl alcohol, aryl alcohol, aralkyl alcohol, and amine.

According to some of any of the embodiments described herein, wherein X and X′ form together a monoanionic bidentate ligand.

According to some of any of the embodiments described herein, the monoanionic bidentate ligand is selected from acetyl-acetonato, methyl-lactate, 1,2-ethanediol monomethyl ether, and N,N′-dimethyl-1,2-ethanolamine.

According to some of any of the embodiments described herein, each of the bridging moieties is independently a hydrocarbon of 1 to 6, or from 1 to 4, or from 1 to 2, carbon atoms in length.

According to some of any of the embodiments described herein, B1 is represented by the Formula:

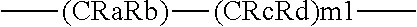

wherein:
m1 is 0 or is a positive integer of from 1 to 5, or from 1 to 3, or from 1 to 2;
Ra, Rb, Rc and Rd are each independently hydrogen, alkyl, cycloalkyl, aryl, heteroaryl, heteroalicyclic, hydroxyl, alkoxy, thiol, thioalkoxy, aryloxy, and amine, or, alternatively, Ra and Rb and/or Rc and Rd, if present, form together a 5-membered, 6-membered or 7-membered alicyclic, heteroalicyclic, aromatic or heteroaromatic ring, wherein when m is other than 1, Rc and Rd in each (CRcRd) unit can be the same or different, and one or both Rc and Rd in one unit can form a 5-membered, 6-membered or 7-membered alicyclic, heteroalicyclic, aromatic or heteroaromatic ring with one or both Rc and Rd of an adjacent unit.

According to some of any of the embodiments described herein, m1 is 0.

According to some of any of the embodiments described herein, Ra and Rb are each hydrogen.

According to some of any of the embodiments described herein, B2 is represented by the Formula:

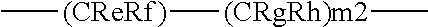

wherein:
m2 is 0 or is a positive integer of from 1 to 5, or from 1 to 3, or from 1 to 2;
Re, Rf, Rg and Rh are each independently hydrogen, alkyl, cycloalkyl, aryl, heteroaryl, heteroalicyclic, hydroxyl, alkoxy, thiol, thioalkoxy, aryloxy, and amine, or, alternatively, Re and Rf and/or Rg and Rh, if present, form together a 5-membered, 6-membered or 7-membered alicyclic, heteroalicyclic, aromatic or heteroaromatic ring, wherein when m is other than 1, Rg and Rh in each (CRgRh) unit can be the same or different, and one or both Rg and Rh in one unit can form a 5-membered, 6-membered or 7-membered alicyclic, heteroalicyclic, aromatic or heteroaromatic ring with one or both Rg and Rh of an adjacent unit.

According to some of any of the embodiments described herein, m2 is 0.

According to some of any of the embodiments described herein, Re and Rf are each hydrogen.

According to some of any of the embodiments described herein, B3 is represented by the Formula:

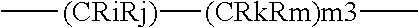

wherein:
m3 is 0 or is a positive an integer of from 1 to 5, or from 1 to 3, or from 1 to 2;
Ri, Rj, Rk and Rm are each independently hydrogen, alkyl, cycloalkyl, aryl, heteroaryl, heteroalicyclic, hydroxyl, alkoxy, thiol, thioalkoxy, aryloxy, and amine, or, alternatively, Ri and Rj and/or Rk and Rm, if present, form together a 5-membered, 6-membered or 7-membered alicyclic, heteroalicyclic, aromatic or heteroaromatic ring, wherein when m is other than 1, Rk and Rm in each (CRkRm) unit can be the same or different, and one or both Rk and Rm in one unit can form a 5-membered, 6-membered or 7-membered alicyclic, heteroalicyclic, aromatic or heteroaromatic ring with one or both Rk and Rm of an adjacent unit.

According to some of any of the embodiments described herein, m3 is 0.

According to some of any of the embodiments described herein, Ri and Rj are each hydrogen.

According to some of any of the embodiments described herein, each of Y, Z and W is independently an arylene, preferably phenylene.

According to some of any of the embodiments described herein, the complex is represented by Formula II:

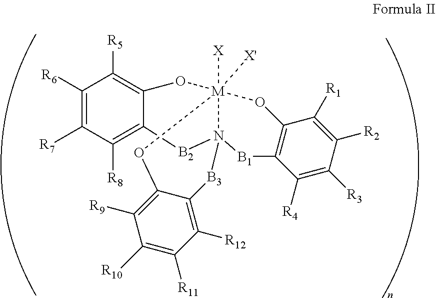

wherein:
n, X, X′, B₁, B₂ and B₃ are as defined in any one of claims 1-18; and
R₁-R₁₂ are each independently selected from hydrogen, alkyl, cycloalkyl, heteroalicyclic, aryl, heteroaryl, halo, alkoxy, and amino, or alternatively, two of R₁-R₄, and/or two of R₅-R₈, and/or two of R₉-R₁₂ independently form together a cyclic ring (fused to the phenolate ring), wherein at least one of R₁-R₁₂ is a substituted or unsubstituted aryl or heteroaryl.

According to some of any of the embodiments described herein, the complex is represented by Formula III:

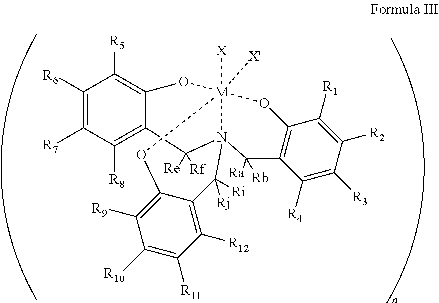

wherein:
n, X, X′, R₁-R₁₂, Ra, Rb, Re, Rf, Ri and Rj are each as defined in any one of claims 1-19.

According to some of any of the embodiments described herein, at least one of R₁, R₅ and R₉ is a substituted or unsubstituted aryl or heteroaryl.

According to some of any of the embodiments described herein, at least one of R₂-R₄, R₆-R₈ and R₁₀-R₁₂ is an alkyl.

According to some of any of the embodiments described herein, the alkyl is a bulky alkyl, preferably tert-butyl.

According to some of any of the embodiments described herein, the complex is represented by Formula IIa:

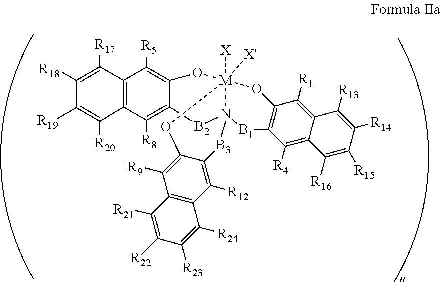

wherein:
n, X, X′, B₁, B₂ and B₃ are as defined herein; and
R₁, R₄, R₅, R₆, R₉, R₁₂, R₁₃-R₁₆, R₁₇-R₂₀ and R₂₁-R₂₄ are each independently selected from hydrogen, alkyl, cycloalkyl, heteroalicyclic, aryl, heteroaryl, halo, alkoxy, and amino, or alternatively, two or more of R₁, R₄, and R₁₃-R₁₆, and/or two or more of R₅, R₆, and R₁₇-R₂₀, and/or two or more of R₉, R₁₂ and R₂₁-R₂₄ independently form together one or more a cyclic ring(s) (fused to the phenolate ring), wherein at least one of R₁, R₄, R₅, R₆, R₉, R₁₂, R₁₃-R₁₆, R₁₇-R₂₀ and R₂₁-R₂₄ is a substituted or unsubstituted aryl or heteroaryl.

According to some of any of the embodiments described herein, the complex is represented by Formula IIIa:

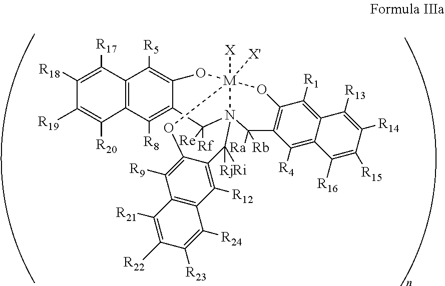

wherein:
n, X, X′, R₁, R₄, R₅, R₆, R₉, R₁₂, R₁₃-R₁₆, R₁₇-R₂₀ and R₂₁-R₂₄, Ra, Rb, Re, Rf, Ri and Rj are each as defined herein.

According to some of any of the embodiments described herein, at least one of R₁, R₅ and R₉ is the substituted or unsubstituted aryl or heteroaryl.

According to an aspect of some embodiments of the present invention there is provided a process of ring opening polymerization of a cyclic ester, the process comprising contacting the cyclic ester with a catalyst system comprising an organometallic complex as described herein in any of the respective embodiments and any combination thereof, to thereby obtain a polyester-containing polyester material.

According to some of any of the embodiments described herein, the catalyst system further comprises a co-catalyst.

According to some of any of the embodiments described herein, the co-catalyst is Rk(OH)p, wherein p is an integer of from 1 to 6, and Rk is alkyl, cycloalkyl, alkaryl or aryl, or is a polymeric moiety.

According to some of any of the embodiments described herein, the polymeric moiety is or comprises a poly(alkylene glycol).

According to some of any of the embodiments described herein, the cyclic ester is a lactide.

According to some of any of the embodiments described herein, the lactide is selected from homochiral lactide, racemic lactide and meso-lactide and any combination thereof.

According to some of any of the embodiments described herein, the lactide is a meso-lactide.

According to some of any of the embodiments described herein, the lactide comprises a mixture of a homochiral lactide and meso-lactide.

According to some of any of the embodiments described herein, a weight ratio of the homochiral lactide and meso-lactide in the mixture ranges from 99.5:0.5 to 50:50, or from 99.5:0.5 to 70:30, or from 99:1 to 75:25.

According to some of any of the embodiments described herein, a weight ratio of the homochiral lactide and meso-lactide in the mixture ranges from 0.5:99.5 to 50:50, or from 9.5:99.5 to 30:70, or from 1:99 to 25:75.

According to some of any of the embodiments described herein, a weight ratio of the homochiral lactide and meso-lactide in the mixture ranges from 20:80 to 10:90, or is about 15:85.

According to some of any of the embodiments described herein, the lactide comprises a mixture of a homochiral lactide and rac-lactide.

According to some of any of the embodiments described herein, the cyclic ester is a lactone.

According to some of any of the embodiments described herein, the organometallic complex is formed in situ such that the contacting is with a ligand precursor represented by Formula IV:

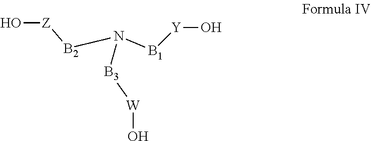

and MX₁X₂X₃X
wherein:
M and X are as defined herein for Formula I and X₁, X₂ and X₃ are each independently a monoanionic ligand; and
B1, B2, B3, X, Y and W are each independently as defined herein for Formula I.

According to some of any of the embodiments described herein, the ligand is represented by Formula V or by Formula VI:

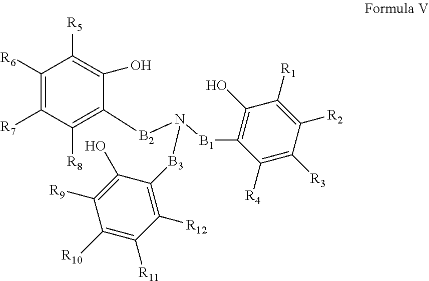

wherein B1, B2, B3 and R₁-R₁₂ being as defined herein for Formula II;

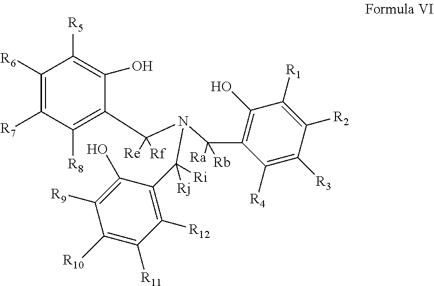

wherein Re, Rf, Ra, Rb, Ri, Rj and R1-R12 being as defined herein for Formula IIa.

According to some of any of the embodiments described herein, the contacting is at a temperature at which the polyester is in a molten state (e.g., higher than a melting temperature of the cyclic ester and/or the polyester).

According to some of any of the embodiments described herein, the temperature is about 180° C.

According to some of any of the embodiments described herein, a process as described herein in any of the respective embodiments is for preparing a stereoblock copolymer comprised of at least one unit of polymerized monomers of a cyclic ester featuring a first stereoconfiguration and at least one unit of polymerized monomers of a cyclic ester featuring a second stereoconfiguration, the first and the second stereoconfigurations being different from one another, the process comprising sequentially contacting a plurality of monomers of the cyclic ester featuring the first stereoconfiguration and a plurality of monomers of the cyclic ester featuring the second stereoconfiguration with the catalyst system. According to some of any of the embodiments described herein, the sequential contacting is at room temperature.

According to some of any of the embodiments described herein, the sequential contacting is in a solution (e.g., in an organic solvent).

According to some of any of the embodiments described herein, the sequential contacting comprises contacting the plurality of monomers featuring the first stereoconfiguration with the catalyst system for a first time period; and, subsequent to the first time period, contacting the plurality of monomers featuring the second stereoconfiguration for a second time period, and, optionally, subsequent to the second time period, contacting the plurality of monomers featuring the first stereoconfiguration with the catalyst system for a third time period; and, further optionally, subsequent to the third time period, contacting the plurality of monomers featuring the second stereoconfiguration for a fourth time period, and, further optionally, repeating each of the contacting for additional time periods, according to the number of units in the stereoblock copolymer.

According to some of any of the embodiments described herein, each of the time periods independently ranges from 1 minute to 6 hours, or from 1 minute to 3 hours, or from 1 minute to 2 hours, or from 1 minute to 1 hour, or from 1 minute to 30 minutes, or from 5 minutes to 30 minutes or from 5 minutes to 20 minutes.

According to some of any of the embodiments described herein, the process is a one-pot process (such that the sequential addition is performed by sequentially adding the plurality of monomers to a reaction vessel containing the catalyst system and optionally a solvent).

According to some of any of the embodiments described herein, the stereoblock copolymer comprises from 2 to 10 units of the polymerized monomers, wherein at least one pair of two adjacent units is comprised of the first unit of polymerized monomers featuring the first stereoconfiguration and the second unit of polymerized monomers featuring the second stereoconfiguration.

According to some of any of the embodiments described herein, the cyclic ester comprises at least one chiral center and wherein each of the stereoconfigurations is independently selected from an enantiomer, a diastereomer, and a racemic mixture of the enantiomer or the diastereomer.

According to some of any of the embodiments described herein, the cyclic ester is lactide.

According to some of any of the embodiments described herein, the monomers featuring the first stereoconfiguration comprise a lactide selected from a homochiral lactide selected from D-lactide and L-lactide, a racemic lactide and a meso-lactide.

According to some of any of the embodiments described herein, the monomers featuring the second stereoconfiguration comprise a lactide selected from a homochiral lactide selected from D-lactide and L-lactide, a racemic lactide and a meso-lactide.

According to some of any of the embodiments described herein, the process is for preparing a stereogradient polyester which comprises at least two segments of the polyester, each segment comprising a first plurality of backbone units of a first lactide featuring a first stereoconfiguration and a second plurality of backbone units of a second lactide featuring a second stereoconfiguration, the first and second stereoconfigurations being different from one another, wherein each segment comprises a different mol ratio of the first and second pluralities of backbone units, the process comprising contacting a mixture of the first and second lactides with the catalyst system.

According to some of any of the embodiments described herein, one of the first and second lactides is a meso-lactide.

According to some of any of the embodiments described herein, the catalyst system comprises a polymeric co-catalyst, and the process is being for preparing a block copolymer that comprises one block of the polymeric moiety derived from the co-catalyst and at least one block of the stereogradient polyester.

According to some of any of the embodiments described herein, the catalyst system comprises a polymeric co-catalyst, and the process is being for preparing a block copolymer that comprises one block of the polymeric moiety derived from the co-catalyst and at least one block of the polyester.

According to some of any of the embodiments described herein, the at least one block of the polyester comprises a syndiotactic polyester.

According to an aspect of some embodiments of the present invention, there is provided a polyester-containing polymeric material obtainable by any of the processes as described herein.

According to some of any of the embodiments described herein, the polyester-containing polymeric material is or comprises a syndiotactic polyester, e.g., a syndiotactic poly(lactic acid).

According to some of any of the embodiments described herein, the polyester-containing polymeric material is a stereogradient polyester which comprises at least two segments of the polyester, each segment comprising a first plurality of backbone units of a first lactide featuring a first stereoconfiguration and a second plurality of backbone units of a second lactide featuring a second stereoconfiguration, the first and second stereoconfigurations being different from one another, wherein each segment comprises a different mol ratio of the first and second pluralities of backbone units, the stereogradient polyester being prepared by contacting a mixture of the first and second lactide with the catalyst system.

According to some of any of the embodiments described herein, the polyester-containing polymeric material is a block copolymer that comprises one block of a poly(alkylene glycol) and at least one block of the polyester.

According to some of any of the embodiments described herein, the at least one block of the polyester comprises a syndiotactic polyester.

According to some of any of the embodiments described herein, the at least one block of the polyester comprises a stereogradient polyester.

Unless otherwise defined, all technical and/or scientific terms used herein have the same meaning as commonly understood by one of ordinary skill in the art to which the invention pertains.

Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

The patent or application file contains at least one drawing executed in color. Copies of this patent or patent application publication with color drawing(s) will be provided by the Office upon request and payment of the necessary fee.

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 (Background Art) describes the industrially employed process of preparing L-lactide and its ring opening polymerization in the presence of tin octanoate, which results in poly(L-lactic acid) featuring a substantial degree of stereoerrors.

FIGS. 2A-C present the chemical structures of exemplary tetradentate-trianionic {NO₃}—H₃ proligands featuring aryl substituents according to some embodiments of the present invention, and of an exemplary known ligand containing no aryl groups (Lig^{t-Bu}H₃) (FIG. 2A), of an exemplary synthetic pathway for preparing an exemplary ligand according to some of the present embodiments (FIG. 2B) and of organometallic complexes made of some of the prolignads presented in FIG. 2A (FIG. 2C).

FIGS. 3A-B present a molecular representation of the crystallographic structure of an exemplary ligand according to some embodiments of the present invention, Lig¹Zr(Oi-Pr)(i-PrOH) (FIG. 3A) and a molecular representation of the crystallographic structure of an exemplary complex according to some embodiments of the present invention, the dimeric (dinuclear) complex [Lig²Zr(Ot-Bu)]₂, wherein the para-tert-butyl group have been omitted for clarity (FIG. 3B).

FIGS. 3C-D present molecular representations of the crystallographic structure of exemplary complexes according to some embodiments of the present invention, the monomeric (mononuclear) complex Lig⁶Zr(Oi-Pr)(i-PrOH), (FIG. 3C), and the monomeric (mononuclear) complex Lig⁵Zr(Oi-Pr)(i-PrOH) (FIG. 3D).

FIG. 4 presents the cooling thermogram of selected PLLA samples prepared using exemplary catalysts according to the present embodiments.

FIG. 5 presents the second heating thermogram of selected PLLA samples prepared using exemplary catalysts according to the present embodiments.

FIG. 6 presents the melt stability at 190° C. of selected PLLA samples prepared using exemplary catalysts according to the present embodiments.

FIGS. 7A-C present the ring opening polymerization of meso-lactide and rac-lactide in the presence of an exemplary complex according to some of the present embodiments (Lig¹Zr(Oi-Pr)(i-Pr—OH), complex 2), and portions of respective ¹H-NMR spectra of the obtained polymers, demonstrating the high tacticities obtained in both processes (FIG. 7A); and a portion of the ¹H-NMR spectrum (FIG. 7B) and DSC thermogram (FIG. 7C) of a syndiotactic polymer obtained from meso-lactide in the presence of another exemplary complex according to some of the present embodiments (Lig⁵Zr(Oi-Pr)(i-Pr—OH), complex 3).

FIG. 8 is a schematic presentation of possible stereoconfigurations of poly(lactic acid).

FIGS. 9A-B present the preparation of an exemplary stereoblock-copolymer in the presence of an exemplary complex according to some of the present embodiments (Lig¹Zr(Oi-Pr)(i-Pr—OH), complex 2) (FIG. 9A), and portions of respective ¹H-NMR spectra of the obtained stereoblock-copolymer (FIG. 9B).

FIGS. 10A-C present the preparation of another exemplary stereoblock-copolymer in the presence of an exemplary complex according to some of the present embodiments (Lig¹Zr(Oi-Pr)(i-Pr—OH), complex 2) (FIG. 10A), portions of respective ¹H-NMR spectra of the obtained stereoblock-copolymer (FIG. 10B) and its DSC thermogram (FIG. 10C).

FIGS. 11A-B presents kinetic plots for the polymerization of meso-LA (400 mol equivalents, red squares; FIG. 11A) or racemic-LA (400 mol equivalents, red squares; FIG. 11B) and L-LA (400 mol equivalents, blue rhombuses) by 0.32 micromol of Complex Lig¹Zr(Oi-Pr)(i-Pr—OH) (complex 2) in toluene-d₈ (1 mL) at 25° C. relatively to 1,4-bis(trimethylsilyl)benzene standard (1 mg, 14.0 mol equivalents), demonstrating a strong bias towards meso-lactide and towards rac-lactide relative to the homochiral L-lactide.

FIG. 12A is a scheme depicting an exemplary stereocontrolled mechanism for producing stereogradient polyester from a mixture of homochiral lactide and meso-lactide while employing a metal catalyst that exhibits preference to ring opening of meso-lactide over a homochiral lactide.

FIG. 12B is a scheme depicting an exemplary stereocontrolled mechanism for producing stereogradient polyester from a non-racemic mixture of L-lactide and D-lactide employing a metal catalyst that exhibits a heterochiral selectivity, namely the tendency to insert an opposite enantiomer every consecutive insertion.

FIG. 12C is a scheme depicting polymerization of a meso-lactide/L-lactide mixture employing different catalysts and initiators: (a) employing a nonselective catalyst and a single-headed initiator giving a stereo-random copolymer; (b) employing a syndioselective catalyst and a single-headed initiator giving a stereogradient copolymer featuring a single segment depleted of stereo-errors; and (c) employing a syndioselective catalyst and a double-headed initiator giving a stereogradient copolymer featuring two segments depleted of stereo-errors.

FIGS. 13A-B present the ¹H-NMR spectrum in CDCl₃ of exemplary 10:90 meso-lactide/L-lactide polymerization mixtures and either complex Lig¹Zr(Oi-Pr)(i-Pr—OH) (complex 2; FIG. 13A) or tin octanoate (FIG. 13B) as catalyst, before monomer removal. In FIG. 13A, complex Lig¹Zr(Oi-Pr)(i-Pr—OH) was used as catalyst, conversion is 76% and meso-lactide cannot be detected in the monomer residue, showing full conversion of meso-lactide and partial conversion of L-lactide, and demonstrating the catalyst's preference to meso-lactide. In FIG. 13B, tin octanoate was used as catalyst, conversion is 74% and the remaining meso-lactide detected in the monomer residue is about 10%, similar to the ratio of meso-lactide in the original monomer mixture, supporting the conversion of meso-lactide and L-lactide in similar rates.

FIGS. 14A-B present the variation of second melting temperatures (FIG. 14A) and the heat of melting of the second heating run (FIG. 14B) of PLA samples obtained by catalyst Lig¹Zr(Oi-Pr)(i-Pr—OH) (complex 2) and by tin octanoate as a function of meso-lactide content in the stream, as measured by differential scanning calorimetry.

FIGS. 15A-B present an overlay of the second heating runs of the DSC thermograms of the PLA samples obtained from different meso-lactide/L-lactide mixtures with catalyst Lig¹Zr(Oi-Pr)(i-Pr—OH) (complex 2) (FIG. 15A) and with tin octanoate (FIG. 15B).

FIGS. 16A-B present the DSC thermograms of (stereogradient)PLA-b-PEG-b-(stereogradient)PLA triblock copolymers produced with HO-PEG₅₀₀₀-OH and a lactide monomer mixture composed of 10:90 meso-lactide:L-lactide and polymerized with complex Lig¹Zr(Oi-Pr)(i-Pr—OH) (complex 2). FIG. 16A corresponds to a low molecular weight copolymer, and FIG. 16B corresponds to a high molecular weight copolymer.

### DESCRIPTION OF SPECIFIC EMBODIMENTS OF THE INVENTION

The present invention, in some embodiments thereof, relates to chemistry and, more particularly, but not exclusively, to novel organometallic complexes, to uses thereof in catalytic ring opening polymerization of cyclic esters and to polyesters, and block copolymers, including, but not limited to, stereoblock polyester copolymers and stereogradient polyester copolymers, obtained thereby.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As discussed hereinabove, organometallic catalysts exhibiting very high activities under very low loadings at high temperatures for the ring opening polymerization (ROP) of lactones and in particular lactide are extensively sought after.

Beyond this high catalytic activity in temperatures wherein both monomer and polymer are in the melt state, the polymer produced should be of high molecular weight, and stable to melt treatment processing. It is also preferable that the metal would be non-toxic, that the complex would be colorless, and that the ligand would be synthetically accessible and amenable to structural changes.

In the framework of ring-opening polymerization catalysis for the production of aliphatic polyesters and in particular poly(lactic acid) (PLA), the industrially-employed tin octanoate suffers from several disadvantages including its toxicity and the instability of its produced-PLA during melt-processing, and therefore, alternative catalysts that would rely on innocuous metals, operate at the low ppm concentrations and lead to thermally-stable polymers are highly desired. Such alternative catalysts have not yet been uncovered.

The development of catalysts that present a viable alternative to the tin octanoate is extremely valuable and timely. Such catalysts need to outperform the activity of tin octanoate in all respects while being of considerably lower toxicity. They need to operate under industrially relevant conditions, namely in a solvent-less environment at a temperature wherein both monomer and polymer are in their melt state, namely at 180° C. and above. They need to be able to produce high molecular weight PLA suitable for various biomedical and commodity applications. During the polymerization process they should be involved in minimal epimerization processes, so that the integrity of the polymer will be high and the degree of stereoerrors would be minimal. The polymers produced with these catalysts should be stable to high temperature processing, namely, the removal of the catalyst or its deactivation by any means would be unnecessary. An important advantage of such potential alternative catalysts is their adaptability to existing production facilities, that would enable their application as a drop-in replacement for the currently-employed tin-based catalysts.

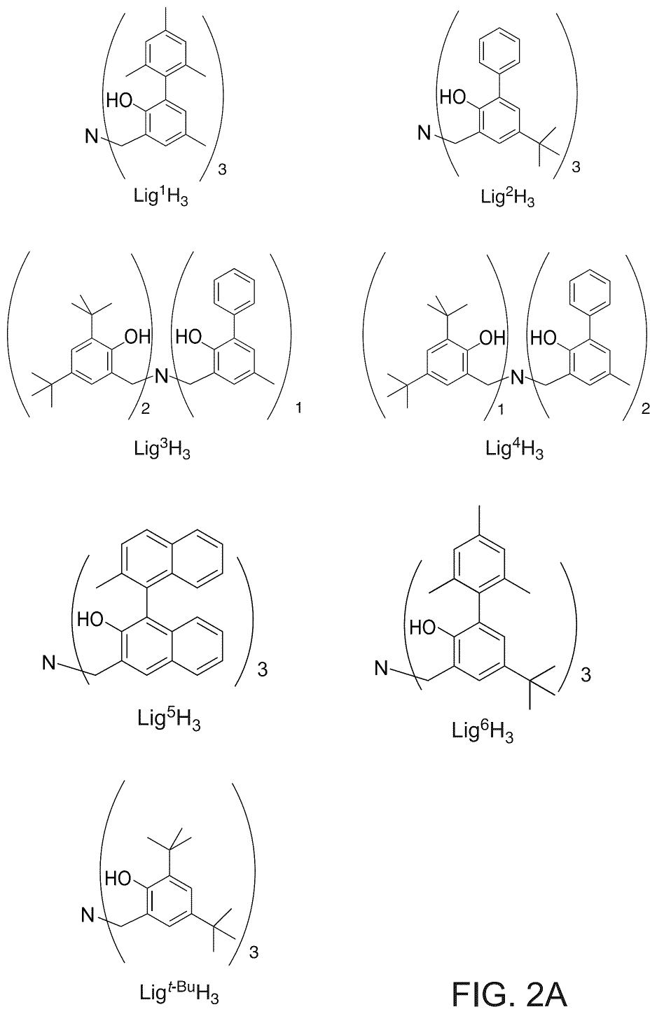

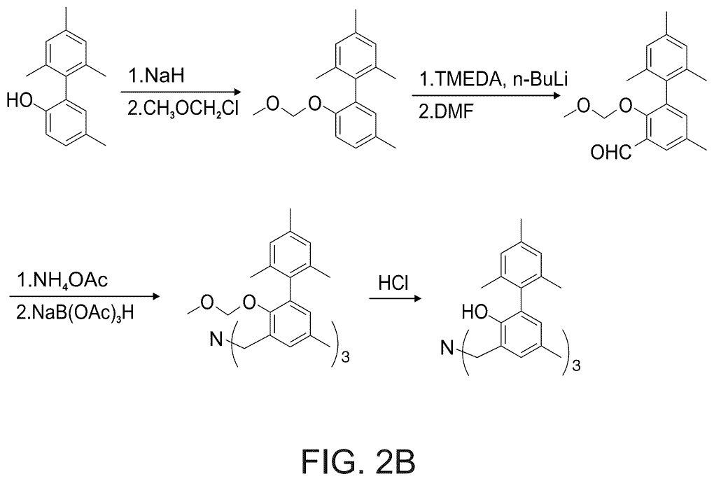

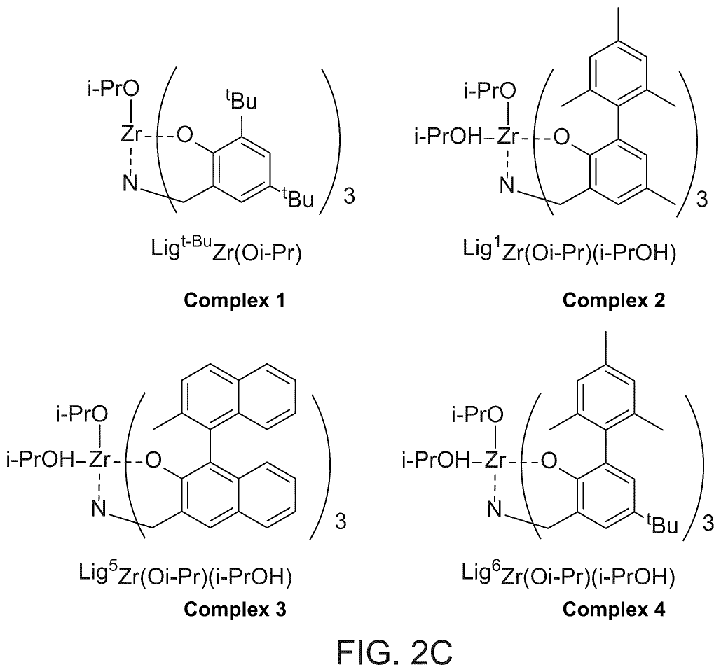

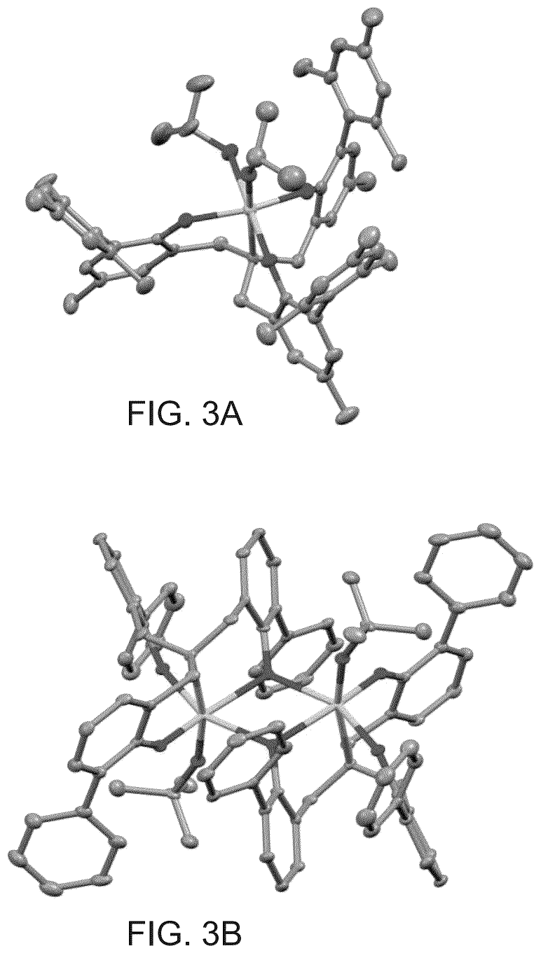

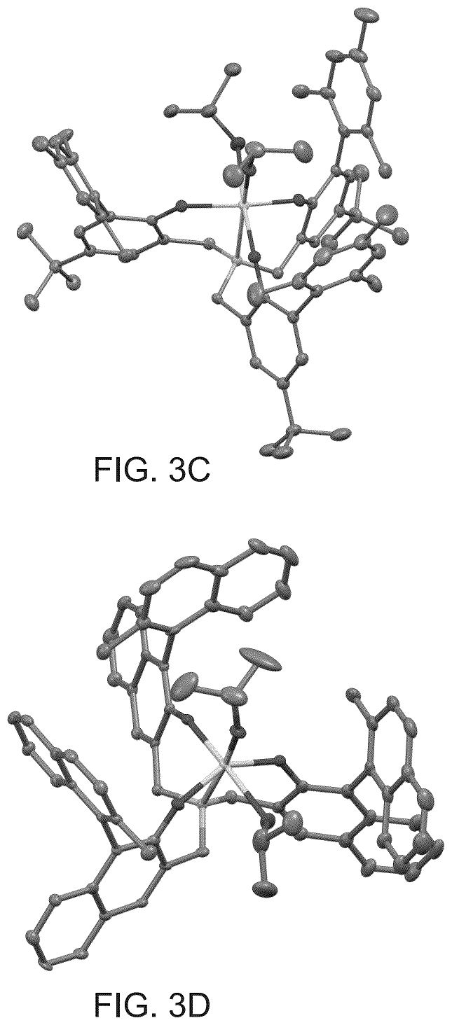

The present inventors have designed and successfully prepared and practiced a novel family of organometallic complexes based on tripodal tetradentate trianionic amine tris(phenolate) {NO₃}-type ligands wherein at least one of the phenolate groups bears an aryl substituent. See, FIGS. 2A-C and 3A-D. As demonstrated in the Examples section that follows, these complexes lead to highly active ring opening polymerization catalysts at various temperatures, and in particular under melt conditions, enabling the production of PLA under industrially-relevant conditions with very low catalyst loadings. See, for examples, Table 1 in the Examples section that follows.

The disclosed complexes exhibit an unexpectedly high reactivity in the ring-opening polymerization at high temperatures under melt conditions. They also exhibit high stability, and retain their activity under these conditions for at least several hours. These catalysts may be employed at very low loadings, typically below 20 ppm and even as low as 1 ppm, and attain very high conversions such as 95%. Their activities exceed that of tin octanoate, and in fact they exhibit the highest activities ever reported under monomer and polymer melt conditions. The PLLA produced by polymerization of L-LA has very high stereochemical integrity signifying minimal, if any, unwanted epimerization. The PLLA produced has exceptional thermal stability according to rheological testing. Moreover, the disclosed complexes were found to exhibit high stereoselectivity and have led to preparation of both highly syndiotactic PLLA and of highly heterotactic PLLA, by polymerization of meso-lactide and racemic-lactide, respectively. The high stereoselectivity allows using these catalysts for preparing stereoblock copolymers with precise control, and for preparing stereogradient polyester copolymers as described in further detail herein. Novel organometallic complexes bound to tripodal tetradentate trianionic {NO₃}-type ligands, and use of these complexes in the polymerization of cyclic esters such as lactides are disclosed herewith. The complexes as described herein are particularly useful in polymerization of lactide under industrially-employed conditions, because of their unusually high reactivities at high temperatures which enables their application on desirable low loadings. Employing these complexes under these conditions leads to useful polymers such as high molecular weight PLA, as well as useful block copolymers such as PEG-PLA block copolymers comprising highly tactic PLA block(s).

Novel tetradentate trianionic {NO₃}-type ligands usable for forming these complexes are also disclosed herewith.

### Complexes:

According to an aspect of some embodiments of the present invention there is provided an organometallic complex represented by Formula I:

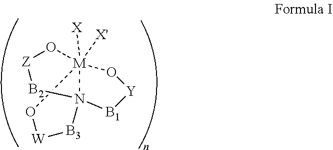

wherein:
n is 1, 2, 3 or 4, representing the nuclearity of the complex (e.g., when n is 1 the complex is a mononuclear complex and when n is 2 the complex is a dinuclear complex);
the dashed line represents a covalent or a coordinative bond, representing a bond between a donor atom and a metal;
M is a tetravalent (group 4) metal;
X is a monoanionic ligand;
X′ is a neutral ligand, such as an alcohol, or is absent;
W, Y and Z are each independently an aryl or a heteroaryl, at least one of W, Y and Z being a substituted aryl or heteroaryl, the substituted aryl or heteroaryl comprising at least one aromatic (aryl or heteroaryl) substituent; and
B1, B2 and B3 are each independently a bridging moiety linking between the respective aryl or heteroaryl and the nitrogen atom, or is absent.

By “tetravalent metal” it is meant a metal that has a valency of 4, that is, is capable of forming at least four covalent bonds with four monovalent atoms. A “tetravalent metal” encompasses also metals which feature higher valency. In some of any of the embodiments described herein, M is zirconium or hafnium. Other tetravalent metals are also contemplated.

In some preferred embodiments, M is zirconium.

In some preferred embodiments, M is hafnium.

Herein and in the art, a “monoanionic ligand” describes a ligand (which can be an atom or a chemical group) that is negatively charged, and has a net charge (before being complexed to the metal) of −1, as a monoanion.

The monoanionic ligand X can be, as non-limiting examples, alkyl (substituted or unsubstituted), cycloalkyl (substituted or unsubstituted), aryl (substituted or unsubstituted), amide, alkoxy, thioalkoxy, aryloxy, thioaryloxy, halo or amine (substituted or unsubstituted), as these terms are defined herein.

It is noted that when an amine is bound to a metal atom, the resulting moiety is also referred to herein and in the art as “amide”, that is, a M-NR′R″ moiety as described herein is also referred to herein and in the art as a metal amide.

Herein and in the art, a “neutral ligand” describes a ligand (a chemical group) that has a zero net charge (before being complexed to the metal).

The neutral ligand X′, if present, can be, as non-limiting examples, alkyl alcohol, aryl alcohol, amine, etc., or be absent. Alternatively X and X′ could form together a monoanionic bidentate ligand, such as acetyl-acetonato, methyl-lactate, 1,2-ethanediol monomethyl ether, or N,N′-dimethyl-1,2-ethanolamine.

In some of any of the embodiments described herein for Formula I, M is zirconium, and X is alkoxy or aryloxy. In some of these embodiments, X is alkoxy, and the alkyl portion of the alkoxy is preferably a lower alkyl, of 2 to 6, or of 3 to 6, carbon atoms, and is further preferably a branched lower alkyl, for example, tert-butyl or iso-propyl. Other branched alkyls, preferably lower alkyls, are contemplated.

In some of any of the embodiments described herein for Formula I, M is zirconium and X is O-isopropyl (also referred to herein as isopropoxy).

In some of any of the embodiments described herein for Formula I, M is zirconium and X is O-tert-butyl (also referred to herein as tert-butoxy).

In some of any of the embodiments described herein for Formula I, M is hafnium and X is alkoxy or aryloxy. In some of these embodiments, X is alkoxy, and the alkyl portion of the alkoxy is preferably a lower alkyl, of 2 to 6, or of 3 to 6, carbon atoms, and is further preferably a branched lower alkyl, for example, tert-butyl or iso-propyl. Other branched alkyls, preferably lower alkyls, are contemplated.

In some of any of the embodiments described herein, X′ is an alcohol, preferably a monoalcoholic aliphatic moiety such as a hydroxyalkyl. The alkyl portion of the alcohol is preferably a lower alkyl, of 2 to 6, or of 3 to 6, carbon atoms, and is further preferably a branched lower alkyl, for example, tert-butyl or iso-propyl. Other branched hydroxyalkyls, preferably lower hydroxyalkyls, are contemplated.

In exemplary embodiments, M is zirconium or hafnium, X is an alkoxy as described herein, and X′ is a hydroxyalkyl, as described herein.

In exemplary embodiments, M is zirconium, X is an alkoxy as described herein, and X′ is a hydroxyalkyl, as described herein.

In exemplary embodiments, M is zirconium or hafnium, X is an alkoxy in which the alkyl portion is preferably a lower alkyl, of 2 to 6, or of 3 to 6, carbon atoms, and is further preferably a branched lower alkyl, for example, tert-butyl or iso-propyl, and X′ is a hydroxyalkyl in which the alkyl portion is preferably a lower alkyl, of 2 to 6, or of 3 to 6, carbon atoms, and is further preferably a branched lower alkyl, for example, tert-butyl or iso-propyl.

According to some embodiments, the bond between one or more, or all of the three oxygen atoms and the metal atom M is a covalent bond.

According to some embodiments, the bond between the monoanionic ligand X and the metal atom M is a covalent bond.

According to some embodiments, the bond between one or more, or all of the three oxygen atoms and the metal atom M is a covalent bond, and the bond between the monoanionic ligand X and the metal atom M is a covalent bond.

According to some embodiments, the bond between the nitrogen (amine) moiety and the metal atom M is a coordinative bond.

According to some embodiments, the bond between the neutral ligand X′ and the metal atom M is a coordinative bond.

According to some embodiments, the bond between the nitrogen (amine) moiety and the metal atom M and the bond between the neutral ligand X′ and the metal atom M are each a coordinative bond.

According to some embodiments, the bond between one or more, or all of the three oxygen atoms and the metal atom M is a covalent bond, the bond between the monoanionic ligand X and the metal atom M is a covalent bond, the bond between the nitrogen (amine) moiety and the metal atom M is a coordinative bond, and the bond between the neutral ligand X′ and the metal atom M is a coordinative bond.

However, any other arrangement is also contemplated.

Any one of the bridging moieties, B1, B2 and B3, independently, can be a hydrocarbon chain, as defined herein.

Herein, the term “hydrocarbon” describes an organic moiety that includes, as its basic skeleton, a chain of carbon atoms, also referred to herein as a backbone chain, substituted mainly by hydrogen atoms. The hydrocarbon can be saturated or unsaturated, be comprised of aliphatic, alicyclic and/or aromatic moieties, and can optionally be substituted by one or more substituents (other than hydrogen). A substituted hydrocarbon may have one or more substituents, whereby each substituent group can independently be, for example, alkyl, cycloalkyl, alkenyl, alkynyl, alkaryl, aryl, heteroaryl, heteroalicyclic, amine, halo, sulfonate, sulfoxide, phosphonate, hydroxy, alkoxy, aryloxy, thiohydroxy, thioalkoxy, thioaryloxy, cyano, nitro, azo, azide, sulfonamide, carboxy, thiocarbamate, urea, thiourea, silyl, carbamate, amide, and hydrazine, and any other substituents as described herein.

The hydrocarbon moiety can optionally be interrupted by one or more heteroatoms, including, without limitation, one or more oxygen, nitrogen (substituted or unsubstituted, as defined herein for —NR′—) and/or sulfur atoms.

In some embodiments of any of the embodiments described herein the hydrocarbon is not interrupted by any heteroatom, nor does it comprise heteroatoms in its backbone chain, and can be an alkylene chain, or be comprised of alkyls, cycloalkyls, aryls, alkenes and/or alkynes, covalently attached to one another in any order.

In some of any of the embodiments described herein, the hydrocarbon is an alkylene chain, which can be unsubstituted or substituted, as described herein.

According to some of any of the embodiments described herein, each of the bridging moieties is independently a hydrocarbon of 1 to 6, or from 1 to 4, or from 1 to 2, carbon atoms in length, or is absent.

According to some embodiments, B1 is represented by the Formula:

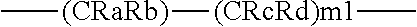

wherein:
m1 is 0 or is a positive integer of from 1 to 5, or from 1 to 3, or from 1 to 2;
Ra, Rb, Rc and Rd are each independently hydrogen, alkyl, cycloalkyl, aryl, heteroaryl, heteroalicyclic, hydroxyl, alkoxy, thiol, thioalkoxy, aryloxy, and amine, or, alternatively, Ra and Rb and/or Rc and Rd, if present, form together a 5-membered, 6-membered or 7-membered alicyclic, heteroalicyclic, aromatic or heteroaromatic ring, wherein when m is other than 1, Re and Rd in each (CRcRd) unit can be the same or different, and one or both Rc and Rd in one unit can form a 5-membered, 6-membered or 7-membered alicyclic, heteroalicyclic, aromatic or heteroaromatic ring with one or both Rc and Rd of an adjacent unit.

In exemplary embodiments, m1 is 0.

In exemplary embodiments, Ra and Rb are each hydrogen.

In exemplary embodiments, m1 is 0 and Ra and Rb are each hydrogen.

According to some embodiments, B2 is represented by the Formula:

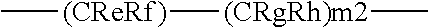

wherein:
m2 is 0 or is a positive integer of from 1 to 5, or from 1 to 3, or from 1 to 2;
Re, Rf, Rg and Rh are each independently hydrogen, alkyl, cycloalkyl, aryl, heteroaryl, heteroalicyclic, hydroxyl, alkoxy, thiol, thioalkoxy, aryloxy, and amine, or, alternatively, Re and Rf and/or Rg and Rh, if present, form together a 5-membered, 6-membered or 7-membered alicyclic, heteroalicyclic, aromatic or heteroaromatic ring, wherein when m is other than 1, Rg and Rh in each (CRgRh) unit can be the same or different, and one or both Rg and Rh in one unit can form a 5-membered, 6-membered or 7-membered alicyclic, heteroalicyclic, aromatic or heteroaromatic ring with one or both Rg and Rh of an adjacent unit.

In exemplary embodiments, m2 is 0.

In exemplary embodiments, Re and Rf are each hydrogen.

In exemplary embodiments, m2 is 0 and Re and Rf are each hydrogen.

According to some embodiments, B3 is represented by the Formula:

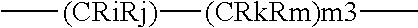

wherein:
m3 is 0 or is a positive an integer of from 1 to 5, or from 1 to 3, or from 1 to 2;
Ri, Rj, Rk and Rm are each independently hydrogen, alkyl, cycloalkyl, aryl, heteroaryl, heteroalicyclic, hydroxyl, alkoxy, thiol, thioalkoxy, aryloxy, and amine, or, alternatively, Ri and Rj and/or Rk and Rm, if present, form together a 5-membered, 6-membered or 7-membered alicyclic, heteroalicyclic, aromatic or heteroaromatic ring, wherein when m is other than 1, Rk and Rm in each (CRkRm) unit can be the same or different, and one or both Rk and Rm in one unit can form a 5-membered, 6-membered or 7-membered alicyclic, heteroalicyclic, aromatic or heteroaromatic ring with one or both Rk and Rm of an adjacent unit.

In exemplary embodiments, m3 is 0.

In exemplary embodiments, Ri and Rj are each hydrogen.

In exemplary embodiments, m3 is 0 and Ri and Rj are each hydrogen.

According to some of any of the embodiments described herein, each of Y, Z and W is independently an aromatic moiety or group, such that each can independently be an aryl or a heteroaryl, as these terms are defined herein. According to some of any of the embodiments described herein, each of Y, Z and W is independently an aryl (e.g., phenyl or naphthyl). W, Y and Z can be the same or different from one another, in any combination.

According to some of any of the embodiments described herein, W, Y and Z are each the same, for example, each is the same aryl (e.g., phenyl).

In exemplary embodiments, W, Y and Z are each phenyl.

According to some of these embodiments, the complexes can be collectively represented by Formula II:

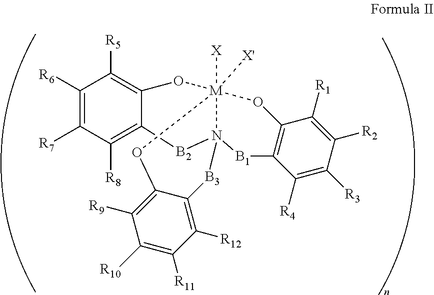

wherein:
n, X, X′, B₁, B₂ and B₃ are as defined herein in any of the respective embodiments and any combination thereof; and
R₁-R₁₂ are each independently selected from hydrogen, alkyl, cycloalkyl, heteroalicyclic, aryl, heteroaryl, halo, alkoxy, and amino, or alternatively, two of R₁-R₄, and/or two of R₅-R₈, and/or two of R₉-R₁₂ independently form together acyclic ring (fused to the phenolate ring),
provided that at least one of R₁-R₁₂ is a substituted or unsubstituted aryl or heteroaryl.

According to some of these embodiments, the complexes can be collectively represented by Formula III:

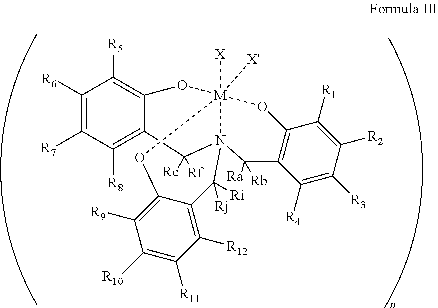

wherein:
n, X, X′, R₁-R₁₂, Ra, Rb, Re, Rf, Ri and Rj are each as defined in any of the respective embodiments, provided that at least one of R₁-R₁₂ is a substituted or unsubstituted aryl or heteroaryl.

In exemplary embodiments, at least one, or each, of W, Y and Z is a substituted or substituted naphthyl.

According to some of these embodiments, the complexes are collectively represented by Formula IIa:

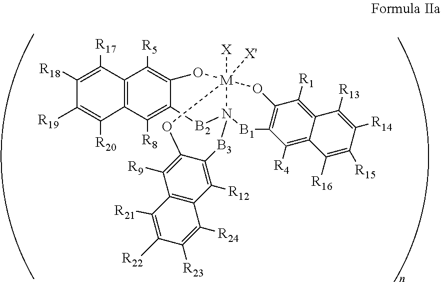

wherein:
n, X, X′, B₁, B₂ and B₃ are as defined herein in any of the respective embodiments and any combination thereof; and
R₁, R₄, R₅, R₆, R₉, R₁₂, R₁₃-R₁₆, R₁₇-R₂₀ and R₂₁-R₂₄ are each independently selected from hydrogen, alkyl, cycloalkyl, heteroalicyclic, aryl, heteroaryl, halo, alkoxy, and amino, or alternatively, two or more of R₁, R₄, and R₁₃-R₁₆, and/or two or more of R₅, R₆, and R₁₇-R₂₀, and/or two or more of R₉, R₁₂ and R₂₁-R₂₄ independently form together one or more acyclic ring (fused to the phenolate ring), provided that at least one of R₁, R₄, R₅, R₆, R₉, R₁₂, R₁₃-R₁₆, R₁₇-R₂₀ and R₂₁-R₂₄ is a substituted or unsubstituted aryl or heteroaryl.

According to some of these embodiments, the complexes can be collectively represented by Formula IIIa:

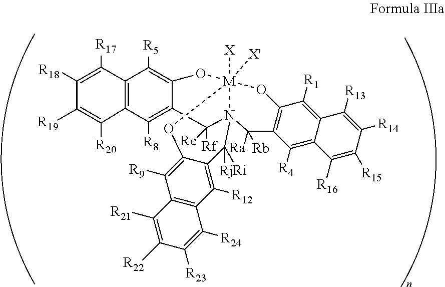

wherein:
n, X, X′, R₁, R₄, R₅, R₆, R₉, R₁₂, R₁₃-Ri6, R₁₇-R₂₀ and R₂₁-R₂₄, Ra, Rb, Re, Rf, Ri and Rj are each as defined in any of the respective embodiments, provided that at least one of R₁, R₄, R₅, R₆, R₉, R₁₂, R₁₃-Ri6, R₁₇-R₂₀ and R₂₁-R₂₄ is a substituted or unsubstituted aryl or heteroaryl.

According to some of any of the embodiments described herein, e.g., for Formula I, IIa, IIb, IIIa and/or IIIb, the aryl or heteroaryl substituting one or more of X, Y and W is a substituted aryl or heteroaryl, and in some of these embodiments, it is substituted by one or more of alkyl, cycloalkyl, halo, aryl, alkoxy, thioalkoxy, hydroxyl, thiol, amine, amide, or any other substituent as described herein. In some embodiments, at least one, or all of the aryl or heteroaryl substituting one or more of X, Y and W is not substituted by an aryl (e.g., is unsubstituted or is substituted by one or more substituents other than aryl). In some embodiments, at least one, or all of the aryl or heteroaryl substituting one or more of X, Y and W is substituted by one or more of an alkyl and a cycloalkyl.

According to some of the embodiments related to Formulas III and IIIa, when at least one of R₁, R₄, R₅, R₆, R₉, R₁₂, R₁₃-R₁₆, R₁₇-R₂₀ and R₂₁-R₂₄ is a substituted or unsubstituted aryl, for example, a substituted or unsubstituted naphthyl, the naphthyl is either unsubstituted or substituted by a substituent other than aryl. In some of these embodiments, the naphthyl is substituted by one or more alkyl(s).

According to some of any of the embodiments described herein, the aryl or heteroaryl substituting one or more of X, Y and W in Formula I, or one or more of the phenol moieties in Formula II or III, or one or more of the naphthyl moieties in Formula IIa or IIIa, is at the ortho position with respect to the phenolate (—O—) group.

For example, in Formula II or III, at least one of R₁, R₅ and R₉ is a substituted or unsubstituted aryl or heteroaryl, as described herein in any of the respective embodiments.

In exemplary embodiments of Formula II or III, at least one of R₁, R₅ and R₉ is a substituted or unsubstituted phenyl or a substituted or unsubstituted naphthyl, as described herein in any of the respective embodiments.

In exemplary embodiments of Formula II, at least one of R₁, R₅ and R₉ is a substituted or unsubstituted phenyl, as described herein in any of the respective embodiments.

In exemplary embodiments of Formula III, at least one of R₁, R₅ and R₉ is a substituted or unsubstituted naphthyl, as described herein in any of the respective embodiments.

For example, in Formula IIa or IIIa, at least one of R₁, R₅ and R₉ is a substituted or unsubstituted aryl or heteroaryl, as described herein in any of the respective embodiments.

In exemplary embodiments of Formula IIa or IIIa, at least one of R₁, R₅ and R₉ is a substituted or unsubstituted phenyl or a substituted or unsubstituted naphthyl, as described herein in any of the respective embodiments.

In exemplary embodiments of Formula IIa, at least one of R₁, R₅ and R₉ is a substituted or unsubstituted phenyl, as described herein in any of the respective embodiments.

In exemplary embodiments of Formula IIIa, at least one of R₁, R₅ and R₉ is a substituted or unsubstituted naphthyl, as described herein in any of the respective embodiments.

For any of the respective embodiments described herein, whenever two or more of R₁, R₅ and R₉ is a substituted or unsubstituted aryl or heteroaryl, the aryl or heteroaryl can be the same or different.

In some of any of these embodiments, the other substituents, (e.g., R₂-R₄, R₆-R₈ and R₁₀-R₁₂ in Formulae II and III; R₁, R₄, R₈, R₁₂, R₁₃-R₁₆, R₁₇-R₂₀ and R₂₁-R₂₄ in Formulae TTa and TITa) can each independently be hydrogen or an alkyl, and in some embodiments, one or more of these substituents is an alkyl, preferably a lower alkyl of e.g., 1 to 6, or 1 to 4, carbon atoms. In exemplary embodiments, one or more of these substituents is a bulky lower alkyl, namely, a branched lower alkyl such as, for example, isopropyl, isobutyl, tert-butyl, isopropyl, trityl, cumyl and tert-hexyl. In exemplary embodiments, the alkyl is at the ortho and/or para positions with respect to the phenolate anion, for example, one or more of R₁, R₃, R₈, R₇, R₉ and R₁₁ is an alkyl as described herein.

As used herein, the phrase “bulky”, in the context of a group or an alkyl in particular, describes a group that occupies a large volume. A bulkiness of a group or an alkyl is determined by the number and size of the atoms composing the group, by their arrangement, and by the interactions between the atoms (e.g., bond lengths, repulsive interactions). Typically, lower, linear alkyls are less bulky than branched alkyls; bicyclic molecules are more bulky than cycloalkyls, etc.

Exemplary bulky lower alkyls include, but are not limited to, branched alkyls such as tert-butyl, isobutyl, isopropyl, isopentyl, and tert-hexyl, as well as substituted alkyls such as triphenylmethane (trityl) and cumyl.

In some of any of the embodiments described herein for Formula I, II and IIa, the bridging moieties B1, B2 and B3 can be the same or different.

In some of any of the embodiments described herein for Formula I, X, Y and W can be the same or different.

In exemplary embodiments of Formula I, X, Y and W are the same.

In exemplary embodiments of Formula I, X, Y and W are the same, and B1, B2 and B3 are the same.

In exemplary embodiments of Formula II or IIa, B1, B2 and B3 are the same.

In exemplary embodiments of Formula II, R₁, R₅ and R₉ are the same and are preferably a substituted or unsubstituted aryl (e.g., phenyl); R₂, R₆ and R₁₀ are the same, R₃, R₇ and R₁₁ are the same; and/or R₄, R₈ and R₁₂ are the same. In some of these embodiments, B1, B2 and B3 are the same.

In exemplary embodiments of Formula III, Ri, R₅ and R₉ are the same and are preferably a substituted or unsubstituted aryl (e.g., phenyl); R₄, Rₛ and R₁₂ are the same; and/or each of the other substituents on the naphthyl rings are the same for each naphthyl. In some of these embodiments, B1, B2 and B3 are the same.

In exemplary embodiments, the complex is represented by Formula II or IIa, and R₁, R₅ and R₉ are the same and each is an unsubstituted phenyl. In some of these embodiments, at least one of R₂-R₄, R₆-R₈ and R₁₀-R₁₂ is an alkyl. In exemplary embodiments, at least one, or each, of R₃, R₇ and R₁₁ is an alkyl, preferably a lower alkyl, of, e.g., 1 to 6, or 1 to 4, carbon atoms. In exemplary embodiments, at least one, or each, of R₃, R₇ and R₁₁ is methyl. In exemplary embodiments, at least one, or each, of R₃, R₇ and R₁₁ is a bulky (e.g., branched) alkyl as defined herein, such as, for example, isopropyl or tert-butyl.

In exemplary embodiments, the complex is represented by Formula II or IIa, and R₁, R₅ and R₉ are the same and each is a substituted phenyl. In some of these embodiments, one, two or each of R₁, R₅ and R₉ is a phenyl substituted by one or more alkyl, preferably lower alkyl(s) such as methyl or ethyl. In some of these embodiments, each of R₁, R₅ and R₉ is mesityl. In some of any of these embodiments, at least one of R₂-R₄, R₆-R₈ and R₁₀-R₁₂ is an alkyl. In exemplary embodiments, at least one, or each, of R₃, R₇ and R₁₁ is an alkyl, preferably a lower alkyl, of, e.g., 1 to 6, or 1 to 4, carbon atoms. In exemplary embodiments, at least one, or each, of R₃, R₇ and R₁₁ is methyl. In exemplary embodiments, at least one, or each, of R₃, R₇ and R₁₁ is a bulky (e.g., branched) alkyl as defined herein such as, for example, isopropyl or tert-butyl.

In exemplary embodiments, the complex is represented by Formula III or IIIa, and R₁, R₅ and R₉ are the same and each is a substituted naphthyl. In some of these embodiments, one, two or each of R₁, R₅ and R₉ is a naphthyl substituted by one or more alkyl(s), preferably lower alkyl(s) such as methyl or ethyl. In some of these embodiments, the naphthyl at R₁, R₅ and/or R₉ is substituted by a lower alkyl (e.g., methyl) at the ortho position with respect to the attachment point to the naphthyl (representing X, Y or W). In some of any of these embodiments, R₄, R₈, R₁₂, R₁₃-R₁₆, R₁₇-R₂₀ and R₂₁-R₂₄ are each hydrogen. Alternatively, at least one of R₄, R₈, R₁₂, R₁₃-R₁₆, R₁₇-R₂₀ and R₂₁-R₂₄ is an alkyl, for example, a lower alkyl such as methyl.

In exemplary embodiments, the complex is represented by Formula II or IIa, R₁ is an unsubstituted phenyl, and R₅ and R₉ are each an alkyl, for example, a lower alkyl, preferably a lower bulky alkyl as described herein. In some of these embodiments, at least one of R₂-R₄, R₆-R₈ and R₁₀-R₁₂ is an alkyl. In exemplary embodiments, at least one, or each, of R₃, R₇ and R₁₁ is an alkyl, preferably each is a lower alkyl, of, e.g., 1 to 6, or 1 to 4, carbon atoms, which can be the same or different. In exemplary embodiments, at least one, or each, of R₃, R₇ and R₁₁ is methyl.

In exemplary embodiments, at least one, or each, of R₃, R₇ and R₁₁ is a bulky (e.g., branched) alkyl such as, for example, isopropyl or tert-butyl. In exemplary embodiments, R₃ is a lower alkyl such as methyl or ethyl and each of R₇ and R₁₁ is a bulky (e.g., branched) alkyl as defined herein, such as, for example, isopropyl or tert-butyl.

In exemplary embodiments, the complex is represented by Formula II or IIa, R₁ and R₅ are each an unsubstituted phenyl, and R₉ is an alkyl, for example, a lower alkyl, preferably a lower bulky alkyl as described herein. In some of these embodiments, at least one of R₂-R₄, R₆-R₈ and R₁₀-R₁₂ is an alkyl. In exemplary embodiments, at least one, or each, of R₃, R₇ and Rₙ is an alkyl, preferably each is a lower alkyl, of, e.g., 1 to 6, or 1 to 4, carbon atoms, which can be the same or different. In exemplary embodiments, at least one, or each, of R₃, R₇ and R₁ᵢ is methyl. In exemplary embodiments, at least one, or each, of R₃, R₇ and R₁ᵢ is a bulky (e.g., branched) alkyl as defined herein, such as, for example, isopropyl or tert-butyl. In exemplary embodiments, R₃ and R₇ are each independently a lower alkyl such as methyl or ethyl and Rₙ is a bulky (e.g., branched) alkyl as defined herein, such as, for example, isopropyl or tert-butyl.

In exemplary embodiments, the complex is represented by Formula II or IIa, R₁ is a substituted phenyl, and R₅ and R₉ are each an alkyl, for example, a lower alkyl, preferably a lower bulky alkyl as described herein. In some of these embodiments, R₁, is a phenyl substituted by one or more alkyl, preferably lower alkyl(s) such as methyl or ethyl. In some of these embodiments, R₁ is mesityl. In some of these embodiments, at least one of R₂-R₄, R₆-R₈ and R₁₀-R₁₂ is an alkyl.

In exemplary embodiments, at least one, or each, of R₃, R₇ and Rₙ is an alkyl, preferably each is a lower alkyl, of, e.g., 1 to 6, or 1 to 4, carbon atoms, which can be the same or different. In exemplary embodiments, at least one, or each, of R₃, R₇ and R₁₁ is methyl. In exemplary embodiments, at least one, or each, of R₃, R₇ and R₁₁ is a bulky (e.g., branched) alkyl such as, for example, isopropyl or tert-butyl. In exemplary embodiments, R₃ is a lower alkyl such as methyl or ethyl and each of R₇ and R₁₁ is a bulky (e.g., branched) alkyl such as, for example, isopropyl or tert-butyl.

In exemplary embodiments, the complex is represented by Formula II or IIa, R₁ and R₅ are each a substituted phenyl, which can be the same or different, and R₉ is an alkyl, for example, a lower alkyl, preferably a lower bulky alkyl as described herein. In some of these embodiments, R₁ and R₅ are each independently a phenyl substituted by one or more alkyl, preferably lower alkyl(s) such as methyl or ethyl. In some of these embodiments, each of Ri and R₅ is mesityl. In some of these embodiments, at least one of R₂-R₄, R₆-R₈ and R₁₀-R₁₂ is an alkyl. In exemplary embodiments, at least one, or each, of R₃, R₇ and R₁₁ is an alkyl, preferably each is a lower alkyl, of, e.g., 1 to 6, or 1 to 4, carbon atoms, which can be the same or different. In exemplary embodiments, at least one, or each, of R₃, R₇ and R₁₁ is methyl. In exemplary embodiments, at least one, or each, of R₃, R₇ and R₁₁ is a bulky (e.g., branched) alkyl such as, for example, isopropyl or tert-butyl. In exemplary embodiments, R₃ and R₇ are each independently a lower alkyl such as methyl or ethyl and Ri is a bulky (e.g., branched) alkyl such as, for example, isopropyl or tert-butyl.

The organometallic complex as described herein in any of the respective embodiments is usable as a catalyst, or as a part of a catalyst system, for the ring-opening polymerization of a cyclic ester as described herein, and can be formed by mixing of an amine tris(phenolate) proligand of the form {NO₃}H₃ (see, Formulae IV, V, VI, Va and VIa) and a metal reagent MX₁X₂X₃X, wherein X is as defined herein and each of X₁, X₂ and X₃ is independently a mono-anionic ligand as described herein, according to the following reaction.

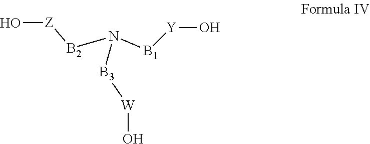

and MX₁X₂X₃X
wherein:
M and X are as defined herein and X₁, X₂ and X₃ are each independently a monoanionic ligand; and
B1, B2, B3, X, Y and W are each as defined herein in any of the respective embodiments and any combination thereof.

In some of any of the embodiments described herein, M is zirconium or hafnium. Other tetravalent metals are also contemplated.

In some preferred embodiments, M is zirconium.

In some preferred embodiments, M is hafnium.

The monoanionic ligands, X₁, X₂, X₃ can be, as non-limiting examples, alkoxy, amide, alkyl, cycloalkyl, aryl, thioalkoxy, aryloxy, thioaryloxy, halo or amine, as these terms are defined herein.

According to some of any of the embodiments described herein, once the contacting is performed, the obtained complex can be employed without isolation or purification.

### Uses (Processes and Products):

According to an aspect of some embodiments of the present invention, there is provided a process of ring opening polymerization of a cyclic ester, the process comprising contacting the cyclic ester with a catalyst system that comprises an organometallic complex as described herein in any of the respective embodiments.

According to another aspect of some embodiments of the present invention, there is provided a process of ring opening polymerization of a cyclic ester, the process comprising contacting the cyclic ester with a catalyst system that comprises an amine tris(phenolate) proligand of Formula IV, V, VI, Va or Via and optionally with a metallic reagent MX₁X₂X₃X as described herein in any of the respective embodiments.

The organometallic complex as described herein in any of the respective embodiments is also referred to herein as a “catalyst” or, in some embodiments, as a “pre-catalyst”, which is activated by a co-catalyst as described herein. In some of any of the embodiments described herein, the catalyst system further comprises a co-catalyst.

The “co-catalyst” described herein is also referred to herein and in the art as “initiator”.

In some embodiments the co-catalyst (initiator) is a hydroxy-containing compound.

In some of any of the embodiments described herein, the catalyst system further comprises a co-catalyst, for example, HO-Rk, wherein Rk is alkyl, cycloalkyl or aryl, or, for example, HO-Rx-OH, wherein Rx is an alkylene, cycloalkylene, or arylene.

Exemplary co-catalysts include, without limitation, benzyl alcohol, and alkyl alcohols such as ethyl alcohol, methyl alcohol, 2-propyl alcohol, 1-hexanol, 1,4-benzene-dimethanol, and poly(ethylene glycol).

The hydroxy-containing compound can feature two or more hydroxy groups, and such compounds are also referred to herein and in the art as polyhydroxy compounds.

In some of any of the embodiments described herein, the co-catalyst is represented by the formula Rk(OH)p, wherein p is an integer of from 1 to 6, and Rk is alkylene, cycloalkylene, alkarylene or arylene, or is a polymeric moiety.

Exemplary such compounds include, but are not limited to, alkylene glycols (featuring 2 hydroxy groups, for example, ethylene glycol, propylene glycol, etc., as glycerols (featuring 3 hydroxy groups), higher linear saccharides, and polyhydroxy compounds such poly(ethylene glycol) or pentaerythritol.

The type of initiator, namely, the number of the hydroxy groups in the initiator determines the number of the polymeric chains in a polymerized cyclic ester.

A mol ratio of the cyclic ester and the initiator determines the number of backbone units in each polymeric chain.

Thus, the polymer architecture (e.g., number and length of the polymeric chains) can be determined or controlled as desired by using an initiator that provides for the desirable properties. In some of any of the embodiments described herein, Rk is or comprises a polymeric moiety. Any polymeric moieties that are suitable for inclusion in the final polymeric product are contemplated.

In exemplary embodiments, the polymeric moiety is or comprises a poly(alkylene glycol), for example, a poly(ethylene glycol). The poly(alkylene glycol) can be a linear polymer that features one terminal —OH group (such that in the other terminus the —OH is masked, and is, for example, —OR, wherein R is alkyl, cycloalkyl or aryl), or one that features two terminal —OH groups.

Alternatively, the poly(alkylene glycol) can be a branched (e.g., starred) polymer, featuring 3 or more terminal —OH groups.

In some of any of the embodiments described herein, the contacting is at a high temperature, for example, higher than 100° C., e.g., between 100° C. and 200° C., or between 120° C. and 200° C., for example, at 120° C., 130° C., 140° C., 150° C., 160° C., 170° C. or 180° C.

In some of any of the embodiments described herein, the contacting is without any solvent.

In some of any of the embodiments described herein, the contacting is at a temperature at which the monomer and/or the formed polyester are in a molten state, namely, higher by at least 10, or at least 20° C. than the melting temperature of the cyclic ester and/or the formed polyester, for example, at about 180° C. In some of these embodiments, the contacting is without any solvent.

In some of any of the embodiments described herein, the contacting is in a solution (e.g., in an organic solvent). An exemplary organic solvent is toluene, although any other organic solvents are contemplated. In some embodiments, the organic solvent is devoid of heteroatoms that can coordinate the metal atom, such as oxygen and nitrogen. In some embodiments, the organic solvent is such that the monomer and/or the formed polyester are soluble therein.

Exemplary solvents include, but not limited to, dichloromethane (DCM), chlorobenzene, tetrahydrofuran (THF), diethylether, ethylene dichloride, toluene, pentane, and the like.

In some of any of the embodiments described herein, the contacting is in a melt, that is, is devoid of a solvent and is performed at a temperature at which the cyclic ester is liquid, for example, at a temperature which is at least the melting temperature of the cyclic ester, or is higher than the melting temperature of the cyclic ester by, for example, 5, 10, 15, 20 or more ° C.

In some embodiments, when the contacting is in a solution, the contacting is at a temperature lower than a temperature required for the monomer and/or the formed polyester to be in a molten state. The temperature can range from room temperature to about 200° C., or from room temperature to about 180° C., or from room temperature to about 150° C., or from room temperature to about 130° C., or from room temperature to about 120° C., or from 50° C. to about 180° C., or from 50° C. to about 150° C., or from 80° C. or about 180° C., or from 80° C. to about 120° C., including any intermediate values and subranges therebetween.

In some of any of the embodiments described herein, the contacting is effected under inert environment.

By “inert environment” it is meant an environment that is substantially free of oxygen, carbon dioxide, water and/or any other substances that may chemically react with the organometallic complex or otherwise interfere in the polymerization reaction. In some of any of the embodiments described herein, the contacting is for a time period that ranges from 5 minutes to 24 hours, or from 10 minutes to 24 hours, or from 10 minutes to 12 hours, or from 10 minutes to 6 hours, or from 10 minutes to 3 hours, or from 30 minutes to 3 hours.

In some of any of the embodiments described herein, a mol ratio of the cyclic ester and the organometallic complex ranges from 1000:1 to 2000000:1, or from 10000:1 to 1000000:1, or from 20000:1 to 200000:1.

In some of any of the embodiments described herein, a mol ratio of the organometallic complex and the co-catalyst (if present) ranges from 1000:1 to 1:1000, or from 100:1 to 1:100, or from 10:1 to 1:1000, or from 10:1 to 1:100, or from 10:1 to 1:50, or from 10:1 to 1:40 or from 10:1 to 1:30, or from 10:1 to 1:20 or from 10:1 to 1:10, or from 1:1 to 1:10, or from 1:1 to 1:8, or from 1:1 to 1:6, or from 1:1 to 1:5 or from 1:1 to 1:4, including any intermediate values and subranges therebetween.

In some of any of the embodiments described herein, the polymerization is a living polymerization.

By “living polymerization”, as used herein, it is meant a form of chain growth polymerization where chain termination is very low, the molecular weight of the polymer is proportional to the conversion, and the molecular weight distribution, PDI (polydispersity index), is very narrow.

In some of any of the embodiments described herein, the polymerization is an immortal polymerization.

Immortal polymerization, as used herein, is a form of living chain growth polymerization where the number of polymer chains is higher than the number of catalyst molecules and all polymer chains can grow by the catalyst. For example, by employing a ratio of a co-catalyst to living catalyst higher than 1, the number of polymer chains will be higher than the number of catalyst molecules and identical to the sum of number of co-catalyst molecules and number of the groups on the catalyst that can initiate chains, e.g., either X or X and X′ in Formula I. As a result, immortal polymerization can afford polymers with a controlled molecular weight, while the number of polymer molecules is higher than the number of the catalyst molecules.

In some of any of the embodiments described herein, the contacting is effected as a single batch, that is, a cyclic ester, or a mixture of two or more cyclic esters, are contacted with the catalyst system all together in a single batch, simultaneously (and not sequentially).

In some of any of the embodiments described herein a mixture of cyclic esters is polymerized to form a copolymer by any of the processes described above.

The term “cyclic ester” as used herein describes a —C(═O)—O—Rx in which Rx is an hydrocarbon chain (e.g., lower, medium or higher alkyl, optionally substituted), as defined herein, optionally interrupted by one or more heteroatoms or moieties as defined herein, and one carbon atom of the hydrocarbon chain (e.g., of an alkyl) is linked to the carbon atom of the carboxylate to form a ring.

In some embodiments, a cyclic ester can be represented by Formula X:

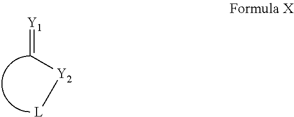

wherein:
Y₁ and Y₂ are each independently selected from oxygen and sulfur; and
L is a hydrocarbon chain, for example, a hydrocarbon chain which comprises one or more alkylene chains, each optionally being independently substituted or unsubstituted, and which can optionally be interrupted therebetween by one or more moieties such as oxygen atom, sulfur atom, amine, silyl, carbonyl, amide, carboxy (—C(═O)—O—), thiocarboxy, thiocarbonyl, and the like.

Each alkylene chain can be of from 1 to 30 carbon atoms, preferably from 1 to 20 carbon atoms, or from 1 to 15 carbon atoms, or from 1 to 10 carbon atoms.

In some of any of the embodiments described herein, the cyclic ester comprises two or more alkylene chains, which are interrupted therebetween, wherein at least two alkylene chains are interrupted therebetween by a carboxy group. Such cyclic esters are also referred to herein and in the art as “cyclic diesters”.

In some of any of the embodiments described herein, the one or more alkylene chain(s) is/are unsubstituted.

In some of any of the embodiments described herein, at least one of Y₁ and Y₂ is oxygen.

In some of any of the embodiments described herein, each of Y₁ and Y₂ is oxygen.

In some of any of the embodiments described herein, L is an alkylene chain, non-interrupted. Such cyclic esters are also referred to herein and in the art as “lactone”.

In some of any of the embodiments described herein, L comprises two alkylene chains, interrupted by a carboxy group, whereby the two alkylene chains are identical to one another. Such a cyclic diester can also be regarded as a di-lactone of two molecules of a 2-hydroxycarboxylic acid, and is also referred to in the art as lactide.

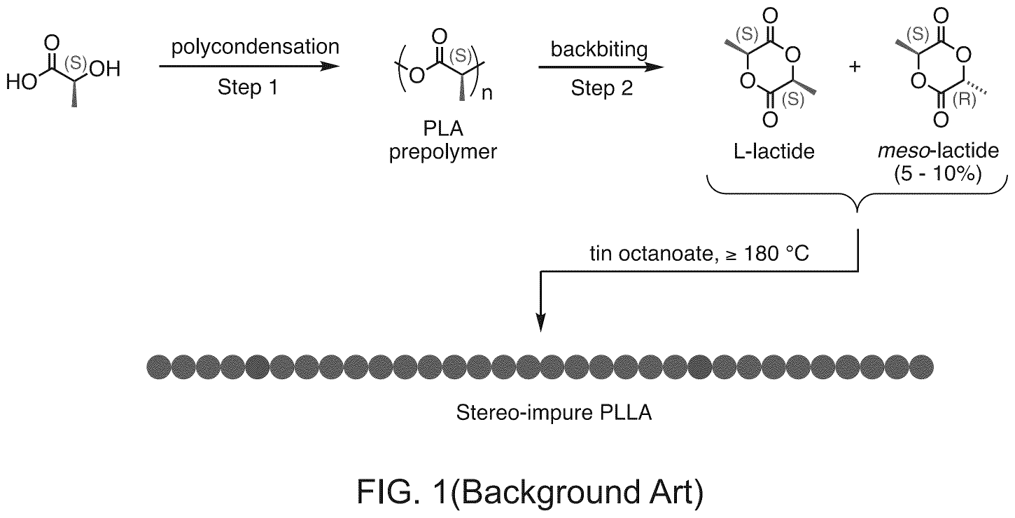

While the term “lactide” generally describes a dilactone of any 2-hydroxycarboxylic acid, herein and in the art, this term typically also refers to a cyclic di-ester (di-lactone) of lactic acid (2 hydroxypropionic acid), as shown, for example, in Scheme 1 hereinabove and in Background Art FIG. 1.

Cyclic esters usable in the context of the present embodiments include substituted and unsubstituted lactones such as, for example, caprolactones and lactides, although any other cyclic esters are contemplated, for example, glycolide, δ-valerolactone, γ-butyrolactone, ε-caprolactone, ω-pentadecalactone, cyclopentadecanone, 16-hexadecanolide, oxacyclotridecan-2-one.

In some of any of the embodiments described herein, the cyclic ester has a chiral center.

Herein a “chiral cyclic ester” or a “cyclic ester having a chiral center”, typically describes a cyclic ester or a cyclic diester as defined herein, in which one or more carbon atoms in one or more of the alkylene chains is substituted and thereby form a chiral center. Whenever these phrases are used, the cyclic ester can be one enantiomer, one diastereomer, a meso form, or a racemic mixture, unless otherwise indicated.

In some of any of the embodiments described herein, the polymerization is a heteroselective polymerization (e.g., in case the cyclic ester is chiral). By “heteroselective polymerization”, it is meant a stereo-controlled polymerization that provides at least one enchainment of an opposite enantiomer when a mixture of enantiomers is employed, or a head-to-tail enchainment when a meso diastereomer is employed.

In some of any of the embodiments described herein, the cyclic ester is lactide, that is, a di-lactone of lactic acid (2-hydroxypropionic acid).

In some of any of the embodiments described herein, the cyclic ester is a lactone, for example, a caprolactone such as 8-caprolactone.

In some of any of the embodiments described herein, the cyclic ester is lactide and the lactide is a homochiral lactide (L-lactide or D-lactide) or a racemic lactide (rac-lactide) or a meso-lactide, or any mixture thereof.

In some of any of the embodiments described herein, the lactide is a homochiral L-lactide. In some of these embodiments, the obtained polyester is an isotactic polyester.

In some of any of the embodiments described herein, the lactide is a racemic lactide (rac-lactide). In some of these embodiments, the obtained polyester is a heterotactic polyester.

In some of any of the embodiments described herein, the lactide is a meso-lactide. In some of these embodiments, the obtained polyester is a syndiotactic polyester.

In some of any of the embodiments described herein, the lactide comprises a mixture of two lactides, for example, a mixture of a homochiral lactide (L-lactide or D-lactide) and meso-lactide, and the contacting is of the lactide mixture with a catalyst system as described herein. In some of these embodiments, the obtained polyester is a stereogradient polyester, as described and defined in further detail hereinbelow.

In some of these embodiments, a weight ratio of the homochiral lactide and meso-lactide in the mixture ranges from 99.5:0.5 to 0.5:99.5, or from 99:1 to 1:99, or from 95:5 to 5:95, or from 90:10 to 10:90, or from 85:15 to 15:85, or from 80:20 to 20:80, or from 75:25 to 25:75, including any intermediate values and subranges therebetween.

In some of these embodiments, a weight ratio of the homochiral lactide and meso-lactide in the mixture ranges from 99.5:0.5 to 50:50, or from 99.5:0.5 to 70:30, or from 99:1 to 75:25, or from 99:1 to 75:25, or from 90:10 to 60:40, or from 90:10 to 70:30, or from 90:10 to 80:20, including any intermediate values and subranges therebetween.

In some of these embodiments, a weight ratio of the meso-lactide and the homochiral lactide in the mixture ranges from 99.5:0.5 to 50:50, or from 99.5:0.5 to 70:30, or from 99:1 to 75:25, or from 90:10 to 60:40, or from 90:10 to 70:30, or from 90:10 to 80:20, including any intermediate values and subranges therebetween, or is about 85:15.

In some of any of the embodiments described herein, the lactide comprises a mixture of a homochiral lactide (L-lactide or D-lactide) and rac-lactide, which can be regarded as a non-racemic mixture of L-lactide and D-lactide, and the contacting is of the lactide mixture with a catalyst system as described herein. In some of these embodiments, the obtained polyester is a stereogradient polyester, as described and defined in further detail hereinbelow.

In some of these embodiments, a weight ratio of the homochiral lactide and the rac-lactide in the mixture ranges from 99.5:0.5 to 0.5:99.5, or from 99:1 to 1:99, or from 95:5 to 5:95, or from 90:10 to 10:90, or from 85:15 to 15:85, or from 80:20 to 20:80, or from 75:25 to 25:75, including any intermediate values and subranges therebetween.

In some of these embodiments, a weight ratio of the homochiral lactide and the rac-lactide in the mixture ranges from 99.5:0.5 to 50:50, or from 99.5:0.5 to 70:30, or from 99:1 to 75:25, or from 99:1 to 75:25, or from 90:10 to 60:40, or from 90:10 to 70:30, or from 90:10 to 80:20, including any intermediate values and subranges therebetween.

In some of these embodiments, a weight ratio of the rac-lactide and the homochiral lactide in the mixture ranges from 99.5:0.5 to 50:50, or from 99.5:0.5 to 70:30, or from 99:1 to 75:25, or from 90:10 to 60:40, or from 90:10 to 70:30, or from 90:10 to 80:20, including any intermediate values and subranges therebetween, or is about 85:15.

According to some of any of the embodiments described herein, the process utilizing the catalyst system as described herein is for preparing a block copolymer of a cyclic ester.

Herein, the phrase “block copolymer of a cyclic ester” is also referred to herein interchangeably as “block polyester copolymer” and describes block copolymers comprised of two or more blocks, wherein at least two of these blocks comprise, each independently, a polyester homopolymer, wherein the polyester homopolymers in these at least two blocks differ from one another by their chemical composition and/or stereoconfiguration.

In some embodiments, each block that comprises a polyester homopolymer is comprised of polymerized monomers of a corresponding cyclic ester, and is also referred to herein as a unit in the block copolymer.

Each block is formed of a plurality of cyclic ester monomers which represent a plurality of repeating backbone units covalently attached to one another and forming the homopolymer block.

The term “block” is also referred to herein as “homopolymer block”, “homopolyester block”, “polyester block”, “polyester unit”, “unit” and “unit comprising polymerized monomers of a cyclic ester” (as indicated), and also as combinations of any of the foregoing, and is meant to encompass a unit in the block copolymer that is made of one type of polyester, that is, of polymerized monomers of one type of cyclic ester (all having the same chemical composition and stereoconfiguration).

A block polyester copolymer can comprise two, three, four, five or more blocks, and at least two of these blocks are homopolyester blocks which differ from one another by the type (stereoconfiguration and/or chemical composition) of the monomers of the cyclic esters that are polymerized within the block, as described herein.

A block polyester copolymer can comprise two types of blocks (units), each independently comprising (or composed of) a plurality of polymerized monomers of a cyclic ester, at least one of these units comprises a plurality of polymerized monomers of a first cyclic ester, and at least one another unit of these units comprises a plurality of polymerized monomers of a second cyclic ester, the second cyclic ester differing from the first cyclic ester by a stereoconfiguration and/or a chemical composition, as defined herein.

A block polyester copolymer which comprises two types of blocks can comprise 2, 3, 4, 5 or more blocks (units), in an alternating order, such that in any pair of adjacent blocks (units), the units are made of polymerized monomers of a different cyclic ester.

A block polyester copolymer can comprise three or more types of blocks (units), each independently comprising (or composed of) a plurality of polymerized monomers of a cyclic ester, at least one of these units comprises a plurality of polymerized monomers of a first cyclic ester, and at least one another unit of these units comprises a plurality of polymerized monomers of a second cyclic ester, the second cyclic ester differing from the first cyclic ester by a stereoconfiguration and/or a chemical composition, as defined herein. Such a block copolymer can comprise in addition to the above-mentioned units of the first and second cyclic ester, units which are not polymerized monomers of a cyclic ester (e.g., are rather made of repeating backbone units of monomers which are not a cyclic ester). Alternatively, such a block copolymer can comprise, in addition to the above-mentioned units of the first and second cyclic ester, one or more types of blocks (units), each independently comprising (or composed of) a plurality of polymerized monomers of a third cyclic ester, and optionally of a fourth cyclic ester, while the third cyclic ester is different from the first, second and, if present, the fourth cyclic esters, and the fourth cyclic ester is different from the first, second and third cyclic esters.

Whenever there are more than two types of blocks (units) in the block polyester copolymer, these different blocks can be arranged in any other.

Non-limiting examples of block copolymers include:
A-B
A-B-A
B-A-B-A-B
A-B-C
A-B-C-B-A
A-B-C-D
A-B-C-D-C-B-A
A-B-A-B-A-B-A-B-
A-B-C-A-B-C-A-B-C-
A-B-A-C-A-B-A-C-
A-B-C-B-A-C-B-C-
A-B-C-D-A-B-C-D-
A-C-D-A-B-C-A-D-C-,
wherein A, B, C and D are each independently a different block, for example, A is a first type of block (a first unit) made of polymerized monomers of a cyclic ester of a first type (a first cyclic ester); B is a second type of block (a second unit) made of polymerized monomers of a cyclic ester of a second type (a second cyclic ester); C is a third type of block (a third unit) made of polymerized monomers of a cyclic ester of a third type (a third cyclic ester), or, alternatively, is a block made of polymerized monomers which are not a cyclic ester; and D is a fourth type of block (a fourth unit) made of polymerized monomers of a cyclic ester of a fourth type (a fourth cyclic ester), or, alternatively, is a block made of polymerized monomers which are not a cyclic ester and which different from C.

In some embodiments, the block copolymer is comprised of two types of blocks, for example, is comprised of a polymer sequence of Block1-Block2, or Block1-Block2-Block1, or Block1-Block2-Block1-Block2, wherein Block1 is a polyester of first chemical composition and/or stereoconfiguration and Block2 is a polyester of a second chemical composition and/or stereoconfiguration which is different from the first chemical composition and/or stereoconfiguration.

The copolymer, according to these embodiments, can be a diblock, triblock, tetrablock, etc.

In some embodiments, the block copolymer is comprised of three or more types of blocks, which can be sequenced in the block copolymer in any order, based on the sequence of subjecting the plurality of cyclic ester monomers forming each block to ring opening polymerization. The copolymer, according to these embodiments, can be a triblock, tetrablock, etc.

By “diblock”, “triblock”, “tetrablock”, etc., the number of blocks is presented. These types of blocks in each of such block copolymers are at least two, regardless of the number of blocks.

When a block copolymer as described herein comprises two units, it is referred to as a diblock copolymer.

When a block copolymer as described herein comprises three units (two of which can the same or all three are different), it is referred to as tri-block copolymer.

When a block copolymer as described herein comprises four units (two or three of which can be the same or all four are different), it is referred to as tetra-block copolymer, and so forth.

According to some of any of the embodiments described herein, the block copolymer comprises 2, 3, 4, 5, 6, 7, 8, 9, 10 or even more units.

According to an aspect of some embodiments of the present invention there is provided a block copolymer comprising a plurality of units, at least two of the plurality of units independently comprise a plurality of polymerized monomers of a cyclic ester, at least one unit of these at least two units comprises a plurality of polymerized monomers of a first cyclic ester, and at least one another unit of these at least two units comprises a plurality of polymerized monomers of a second cyclic ester, as described herein, the second cyclic ester differing from the first cyclic ester by a stereoconfiguration and/or a chemical composition, as described herein.

According to an aspect of some embodiments of the present invention there is provided a block copolymer comprising a plurality of units, at least two adjacent units in said plurality of units independently comprise a plurality of polymerized monomers of a cyclic ester, at least one unit of said at least two adjacent units comprises a plurality of polymerized monomers of a first cyclic ester, and at least one another unit of said at least two adjacent units comprises a plurality of polymerized monomers of a second cyclic ester, said second cyclic ester differing from said first cyclic ester by a stereoconfiguration and/or a chemical composition.

In some of any of the embodiments described herein, the block copolymer further comprises at least one additional unit comprising a plurality of polymerized monomers of a third cyclic ester, the third cyclic ester differing from each of the first cyclic ester and the second cyclic ester by a stereoconfiguration and/or a chemical composition. In some embodiments, the additional unit is adjacent to one and/or both of the at least two adjacent units described hereinabove.

In some of any of the embodiments described herein, the block copolymer comprises from 2 to 10 units, and wherein at least one pair of adjacent units comprises one unit comprising a plurality of polymerized monomers of said first cyclic ester, and one unit comprising a plurality of polymerized monomers of said second cyclic ester, such that the block copolymer comprises at least two adjacent units differing from one another by a stereoconfiguration and/or a chemical composition.

According to some of any of the embodiments described herein, the polymerized monomers composing the units in the at least one pair of (e.g., adjacent) units differ from one another by a number of polymerized monomers (backbone units) (e.g., a length of the block). That is, for example, in a diblock copolymer, each block is comprised of a different number of polymerized monomers (backbone units) (a different number of polymerized monomers composing each of the units). In another, non-limiting example, in a triblock copolymer, first block is of N number of backbone units (polymerized monomers), second block is of M number of backbone units (polymerized monomers) and third block is of L number of backbone units (polymerized monomers), wherein either N≠M≠L, or at least N≠M, or M≠L, or N≠L.

In some of any of the embodiments described herein, at least 90%, or at least 95% or at least 96% or at least 98% or at least 99% of backbone units (polymerized monomers), or each of the backbone units (polymerized monomers), in each of the units (blocks) are identical to one another (feature the same chemical composition and/or stereoconfiguration).

Herein throughout, the term “chemical composition” refers to the chemical structure of the cyclic ester, that is, the type of atoms and their 2D arrangement.

Herein throughout, the term “stereoconfiguration” refers to the spatial arrangement of the atoms in the cyclic ester, and thus refers to cyclic ester monomers featuring one or more chiral centers. According to some embodiments, the polymerized monomers feature a stereoconfiguration according to the stereoconfiguration of the chiral center(s).

For example, the cyclic monomer can be an enantiomer, and the polymerized monomers feature an isotactic configuration of the enantiomer. Thus, if a first and a second cyclic ester differ from one another by being different enantiomers, a unit comprising polymerized monomers of the first cyclic ester exhibits an isotactic stereoconfiguration of this enantiomer, and a unit comprising polymerized monomers of the second cyclic ester exhibits an isotactic stereoconfiguration of this other enantiomer.

For example, the cyclic monomer can be a diastereoisomer, and the polymerized monomers feature an isotactic configuration of the diasteroisomer. Thus, if a first and a second cyclic ester differ from one another by being different diastereomers, a unit comprising polymerized monomers of the first cyclic ester exhibits an isotactic stereoconfiguration of this diastereomer, and a unit comprising polymerized monomers of the second cyclic ester exhibits an isotactic stereoconfiguration of this diastereomer.

In another example, a first cyclic ester is an enantiomer or a diastereomer and a second cyclic ester is a racemic mixture, a unit comprising polymerized monomers of the first cyclic ester exhibits an isotactic stereoconfiguration of the enantiomer or diastereomer, and a unit comprising polymerized monomers of the second cyclic ester exhibits a racemic mixture of the two isotactic stereoconfigurations of the enantiomer or diastereomer. A block comprised of such racemic cyclic ester can be heterotactic, isotactically-inclined, gradient isotactic or even atactic.

Block polyester copolymers featuring at least two units in which the first and second cyclic esters differ in their stereoconfiguration are also referred to herein as “stereoblocks”.

According to an aspect of some embodiments of the present invention there is provided a block polyester copolymer as described herein which is stereoblock copolymer, comprises a plurality (e.g., from 2 to 10) of units of polymerized monomers of a cyclic ester, wherein at least two units (e.g., at least one pair of two adjacent units) comprises one unit comprising a plurality of polymerized monomers of said first cyclic ester featuring a first stereoconfiguration and one unit comprising a plurality of polymerized monomers of said cyclic ester featuring a second stereoconfiguration, as described herein.

In some of any of the embodiments described herein, the polymerized monomers composing the units in at least two units in the copolymer (e.g., in at least one pair of (e.g., adjacent) units, differ from one another by a stereoconfiguration.

In some of the embodiments of a stereoblock copolymer as described herein, the chemical composition of the cyclic ester is the same, that is, the cyclic ester is the same and the first and second cyclic esters differ from one another only by their stereoconfiguration.

In some of any of the embodiments described herein for stereoblocks, at least 90%, or at least 95% or at least 96% or at least 98% or at least 99% of said polymerized monomers in each units comprising same feature the same stereoconfiguration.

In some of any of the embodiments described herein, the block copolymer is a stereoblock copolymer, as described herein, in which two units in the block copolymer differ from one another by stereoconfiguration.

In exemplary embodiments, one or more of the cyclic ester monomers is a lactide, as described herein.

In exemplary embodiments, one type of cyclic ester monomers (a first cyclic ester) is a lactide having one stereoconfiguration and another type of cyclic ester monomers (a second cyclic ester) is a lactide having another stereoconfiguration, and/or is another cyclic ester (e.g., a glycolide or a lactone).

In exemplary embodiments, the block copolymer is made of two or more types of lactides, which differ from one another in stereoconfiguration, and optionally, one type of monomers comprises glycolide.

In exemplary embodiments, the block copolymer is made of two or more types of lactides, which differ from one another in stereoconfiguration, and optionally, one type of monomers comprises a lactone.

Exemplary such block copolymers include, but are not limited to: PLLA-PDLA, PDLA-PLLA-PDLA, PDLA-PLLA-PDLA-PLLA, and so forth, PLLA-PDLA-glycolide; PLLA-glycolide-PLDA-glycolide; PLLA-PDLA-glycolide-PLLA-PDLA-glycolide; PLLA/PDLA-glycolide-PDLA/PLLA; PLLA/PDLA-glycolide-PDLA/PLLA-glycolide, PLLA-PDLA-PCL, PLLA-PDLA-PCL-PDLA-PLLA, PCL-PLLA-PDLA-glycolide and any other combinations of two or all of PLLA, PDLA, glycolide and polycaprolactone.

In some of any of the embodiments described herein, the block copolymers of a cyclic ester are obtainable by a process as described herein in any of the respective embodiments, by sequentially contacting monomers that compose the block copolymer with a catalyst system as described herein in any of the respective embodiments and any combination thereof.

According to some of any of the embodiments described herein, the sequential contacting comprises contacting a plurality of monomers of a first type (featuring a first stereoconfiguration and/or a first chemical composition; a first cyclic ester) with the catalyst system for a first time period; and, subsequent to the first time period, contacting a plurality of monomers of a second type (featuring a second stereoconfiguration and/or a second chemical composition; the second stereoconfiguration being different from the first stereoconfiguration and/or the second chemical composition being different from the first chemical composition; a second cyclic monomer), for a second time period, and, optionally, subsequent to the second time period, contacting an additional plurality of monomers, being either of the first type or of a third type (which differs from the first and second type by a chemical composition and/or stereoconfiguration), for a third time period; and, further optionally, subsequent to the third time period, contacting a plurality of monomers of a type different from the third type (e.g., either the second type or a fourth type), for a fourth time period, and, further optionally, repeating contacting plurality of monomers of the first, second, third, fourth or other type, for additional time periods, according to a desirable number of block types and a desirable number of units in the block copolymer.

According to some of any of the embodiments described herein, each of the time periods independently ranges from 1 minute to 6 hours, or from 1 minute to 3 hours, or from 1 minute to 2 hours, or from 1 minute to one hour, or from 1 minute to 30 minutes, or from 5 minutes to 30 minutes or from 5 minutes to 20 minutes, including any intermediate values and subranges therebetween.

According to some of any of the embodiments described herein, the sequential addition can be effected also within higher time intervals, in view of the living nature of the catalyst.

According to some of any of the embodiments described herein, the process is a one-pot process (such that the sequential subjecting comprises sequentially adding the plurality of monomers to a reaction vessel containing the conditions for effecting ROP (e.g., containing the catalyst system and optionally a solvent).

In exemplary embodiments, one type of cyclic ester monomers is a lactide, as described herein.

In exemplary embodiments, one type of cyclic ester monomers is a lactide having one stereoconfiguration (e.g., meso-lactide) and another type of cyclic ester monomers is a lactide having another stereoconfiguration (e.g., L-lactide or D-lactide), or a racemic mixture of lactide stereoisomers (e.g., rac-lactide).

In exemplary embodiments, one type of cyclic ester monomers is a lactide having one stereoconfiguration and another type of cyclic ester monomers is a lactide having another stereoconfiguration, and/or is another cyclic ester (e.g., a glycolide).

In exemplary embodiments, the block copolymer is made of two or more types of lactide, which differ from one another in stereoconfiguration, and optionally, one type of monomers comprises glycolide.

In some of any of the embodiments described herein, the block copolymer is a diblock copolymer.

In some of any of the embodiments described herein, the ring opening polymerization is effected by sequentially contacting a plurality of monomers of a first, second and so forth cyclic esters with a catalyst system as described herein in any of the respective embodiments and any combination thereof.

In some of any of the embodiments described herein, the sequential contacting is at room temperature.

In some of any of the embodiments described herein, the sequential contacting is in a solution (e.g., in an organic solvent). In some embodiments, the organic solvent is a polar solvent, for example, having a polarity index higher than 1, or higher than 2, or higher than 3, and in some embodiments, it is a polar aprotic solvent. In some embodiments, the organic solvent is devoid of heteroatoms that can coordinate the metal atom, such as oxygen and nitrogen.

Exemplary solvents include, but not limited to, dichloromethane (DCM), chlorobenzene, tetrahydrofuran (THF), diethylether, ethylene dichloride, toluene, pentane, and the like.

In some of any of the embodiments described herein, the sequential contacting is in a melt, that is, is devoid of a solvent and is performed at a temperature at which the cyclic esters are liquid, for example, at a temperature which is at least the melting temperature of the cyclic ester, or is higher than the melting temperature of the cyclic ester by, for example, 5, 10, 15, 20 or more ° C.

In some of any of the embodiments described herein, the sequential contacting is effected under inert environment, as described herein. According to some of any of the embodiments described herein, the sequential contacting comprises contacting a plurality of monomers featuring a first stereoconfiguration with a catalyst system as described herein for a first time period; and, subsequent to the first time period, contacting a plurality of monomers featuring a second stereoconfiguration for a second time period, and, optionally, subsequent to the second time period, contacting a plurality of monomers featuring the first stereoconfiguration with the catalyst system for a third time period; and, further optionally, subsequent to the third time period, contacting a plurality of monomers featuring a second stereoconfiguration for a fourth time period, and, further optionally, repeating each of the contacting for additional time periods, according to a desired or pre-determined number of units in said stereoblock copolymer.

In some of any of the embodiments described herein, each of the time periods independently ranges from 1 minute to 6 hours, or from 1 minute to 3 hours, or from 1 minute to 2 hours, or from 1 minute to 1 hour, or from 1 minute to 30 minutes, or from 5 minutes to 30 minutes or from 5 minutes to 20 minutes, including any intermediate values and subranges therebetween.

In some of any of the embodiments described herein, the process is a one-pot process (such that the sequential addition is performed by sequentially adding the plurality of monomers to a reaction vessel containing the catalyst system and optionally a solvent).

According to some of any of the embodiments described herein, the monomers featuring the first stereoconfiguration comprise a homochiral lactide (D-lactide or L-lactide), a racemic lactide or a meso-lactide.

According to some of any of the embodiments described herein, the monomers featuring the second stereoconfiguration comprise a homochiral lactide (D-lactide or L-lactide), a racemic lactide or a meso-lactide.

According to some of any of the embodiments described herein, one type of a cyclic ester that forms a block copolymer as described herein, namely of the first or the second configuration is meso-lactide, such that at least one block or unit in the block copolymer is a syndiotactic polyester block or unit. The other type of cyclic ester can be a homolactide (L-lactide or R-lactide), providing an isotactic polyester block or unit, or a racemic lactide, providing a heterotactic polyester block or unit.

According to some of any of the embodiments described herein, block copolymers can be obtained using a catalyst system as described herein, in which the co-catalyst is a polymeric co-catalyst. The obtained block copolymer comprises one block of a polymeric moiety derived from the co-catalyst, or more than one polymeric moieties derived from the co-catalyst, in cases where the co-catalyst is, for example, a branched polymeric co-catalyst, and one or more blocks of a polyester (e.g., isotactic, syndiotactic and/or heterotactic) according to the any of the respective embodiments as described herein. According to some of these embodiments, one or more of the polyester blocks or units comprises a syndiotactic polyester (formed of a plurality of meso-lactide monomers).

According to some of any of the embodiments described herein, the catalysts system as described herein is used, or is usable in, a process of preparing a stereogradient polyester, as described herein.

According to some of any of the embodiments described herein, the catalyst system comprises a polymeric co-catalyst, and the process is for preparing a block copolymer that comprises one block of a polymeric moiety derived from the co-catalyst and at least one block of a stereogradient polyester.

According to an aspect of some embodiments of the present invention there is provided a polyester-containing polymeric material obtainable by a process as described herein in any of the respective embodiments.

In some of any of the embodiments described herein, the polyester (e.g., isotactic) is formed of a cyclic ester which is lactide, as described herein, for example, L-lactide.

In some of any of the embodiments described herein, the polyester (e.g., isotactic) is formed of a cyclic ester which is lactide, as described herein, for example, D-lactide.

In some of any of the embodiments described herein, the polyester (e.g., heterotactic) is formed of a cyclic ester which is rac-lactide, as described herein.

In some of any of the embodiments described herein, the polyester (e.g., syndiotactic) is formed of a cyclic ester which is meso-lactide, as described herein.

In some of any of the embodiments described herein, the lactide comprises a mixture of two lactides, for example, a mixture of a homochiral lactide (L-lactide or D-lactide) and meso-lactide, and the contacting of each lactide with a catalyst system as described herein is sequential.

In some of these embodiments, the obtained polyester-containing material is a stereoblock copolymer, for example, Heterotactic-PLA-b-isotactic-PLA, or Heterotactic-PLA-b-syndiotactic-PLA, or isotactic-PLA-b-syndiotactic-PLA. Higher stereoblock copolymers which comprise 3, 4 or more polyester blocks of different stereotacticity are also contemplated.

In some of any of the embodiments described herein, a block copolymer is formed by employing a polymeric co-catalyst (Rk-(OH)p in which Rk is a polymeric moiety as described herein).

In some of these embodiments, the block copolymer is RO-PEG-Isotactic-PLA or Isotactic-PLA-b-PEG-b-Isotactic-PLA.

In some of these embodiments, the block copolymer is RO-PEG-Heterotactic-PLA or Heterotactic-PLA-b-PEG-b-Heterotactic-PLA.

In some of these embodiments, the block copolymer is RO-PEG-Syndiotactic-PLA or Syndiotactic-PLA-b-PEG-b-Syndiotactic-PLA.

In some of these embodiments, the block copolymer is RO-PEG-stereogradient-PLA or stereogradient-PLA-b-PEG-b-stereogradient-PLA.

In some of any of the embodiments described herein a process for forming a copolymer of two or more cyclic esters is provided by the sequential addition of cyclic esters to the active catalyst. In some embodiments, such a process is for preparing a stereoblock copolymer as described herein.

According to some embodiments, the polyester-containing polymeric material is or comprises a block copolymer that comprises one block of a poly(alkylene glycol) and at least one block of a polyester, for example, a syndiotactic polyester or a stereogradient polyester, as described herein in any of the respective embodiments and any combination thereof.

According to further aspects of some embodiments of the present invention there are provided polyester-containing polymeric materials as described herein in any of the respective embodiments and any combination thereof.

According to some embodiments, the polyester-containing polymeric material is or comprises a syndiotactic polyester, e.g., a syndiotactic poly(lactic acid), as described herein.

According to some embodiments, the polyester-containing polymeric material is or comprises a stereogradient polyester which comprises at least two polyester segments, each segment comprising a first plurality of backbone units of a first lactide featuring a first stereoconfiguration and a second plurality of backbone units of a second lactide featuring a second stereoconfiguration, said first and second stereoconfigurations being different from one another, wherein each segment comprises a different mol ratio of said first and second pluralities of backbone units, the stereogradient polyester being prepared by contacting a mixture of said first and second lactide with said catalyst system. In some of these embodiments, the first lactide is meso-lactide and the second lactide is a homochiral lactide, e.g., L-lactide. In some of these embodiments, the first lactide is rac-lactide and the second lactide is a homochiral lactide, e.g., L-lactide.

According to an aspect of some embodiments of the present invention there is provided a process of preparing a stereogradient polyester copolymer from a mixture of two or more cyclic esters which differ from one another at least by the stereoconfiguration thereof. The process in effected by contacting, under conditions that promote ring opening polymerization of the cyclic esters, a mixture that comprises the two or more cyclic esters with a catalyst system as described herein, such that the ring opening polymerization results in a polymer that comprises several segments and in each segment the mol ratio between backbone units derived from the first cyclic ester and backbone units derived from the second cyclic ester is different, thereby preparing the stereogradient polyester.

A stereogradient polyester copolymer, according to embodiments of the present invention, comprises at least two, and typically more than two, segments of a polyester copolymer, each segment comprising a first plurality of backbone units of (or derived from) a first cyclic ester featuring a first stereoconfiguration and a second plurality of backbone units of (derived from) a second cyclic ester featuring a second stereoconfiguration, the first and second stereoconfigurations being different from one another, wherein each of the at least two segments comprises a different mol ratio of the at least first and second pluralities of backbone units.

According to some of these embodiments of the present invention, a stereogradient polyester copolymer is such that the mol ratio between the first plurality of backbone units of (or derived from) a first cyclic ester and the second plurality of backbone units of (or derived from) a second cyclic ester continuously varies along the polymeric backbone in terms of its stereoconfiguration, and, more specifically, in some embodiments, the mol ratio varies from segment to segment gradually in the same direction. That is, as a non-limiting example, a first segment comprises a mol ratio of 90:10 of the first and second pluralities of backbone units, the next segment comprises a mol ratio of 80:20, the third segment comprises a mol ratio of 70:30, the next segment comprises a mol ratio of 60:40, the third segment comprises a mol ratio of 50:50, the next segment comprises a mol ratio of 40:60, the third segment comprises a mol ratio of 30:70, the next segment comprises a mol ratio of 20:80, the third segment comprises a mol ratio of 10:90, and final segments can have only the second plurality of backbone units.

Each segment can independently comprise from 4 to 1000, or from 4 to 100, or from 4 to 50, or from 4 to 100, backbone units.

The plurality of backbone units of an indicated cyclic ester describes the result of the ring opening polymerization of the indicated cyclic ester, and the number of backbone units corresponds to the number of cyclic ester monomers that underwent ring opening polymerization. The plurality of backbone units of an indicated cyclic ester can therefore be regarded as “deriving” from an indicated cyclic ester.

The stereogradient polyester can comprise 2, 3, 4, 5, 6, 7, 8, 9, 10, 20, 30, 40, 50 and more segments, each having a different mol ratio of the backbone units derived from the first cyclic ester to the backbone units derived from the second cyclic ester.

The stereogradient polyester can be composed of 3, 4 or more types of polyester copolymers, and thus be composed of a first, second, third and/or fourth pluralities of backbone units, respectively, in each segment.

The preparation of the stereogradient polyester copolymer is enabled by the kinetic preference of the catalyst system of the present embodiments, which was shown to exhibit a different kinetic towards ring opening polymerization of cyclic esters than differ in their stereoconfiguration.

According to exemplary embodiments, the first cyclic ester is a meso-lactide, and the catalyst exhibits its highest rate constant towards the meso-lactide.

According to some of any of the embodiments described herein, the process of preparing a stereogradient polymer as described herein comprises contacting a mixture of a first and second, and optionally a third and fourth, cyclic esters that differ from one another by stereoconfiguration, and in some of these embodiments, at least one of the cyclic esters is a meso-lactide.

According to some of any of the embodiments described herein, the cyclic esters mixture (the at least first and second cyclic esters) comprises L-lactide and meso-lactide, and optionally further comprises a D-lactide (in an amount lower than 1 mol %).

According to some of these embodiments a mol ratio between the L-lactide and the meso-lactide ranges from 2.5:1 to 1000:1, or from 4:1 to 500:1, or from 10:1 to 200:1, or from 20:1 to 100:1, or from 25:1 to 50:1, including any intermediate values and subranges therebetween. In some of these embodiments, the mol ratio is at least 5:1, or at least 6:1, or at least 8:1, or at least 9:1.

Alternatively, in some embodiments, a mol ratio between the L-lactide and the meso-lactide ranges from 1:2.5 to 1:1000, or from 1:4 to 1:500, or from 1:10 to 1:200, or from 1:20 to 1:100, or from 1:25 to 1:50, or from 1:1 to 1:50, or from 1:1 to 1:20, or from 1:1 to 1:10, or from 1:4 to 1:6, including any intermediate values and subranges therebetween.

According to some of any of the embodiments described herein, the cyclic esters mixture (the at least first and second cyclic esters) comprises L-lactide and D-lactide, and optionally further comprises meso-lactide (in an amount lower than 1 mol %).

According to some of these embodiments, a mol ratio between the L-lactide and the D-lactide ranges from 2.5:1 to 1000:1, or from 4:1 to 500:1, or from 10:1 to 200:1, or from 20:1 to 100:1, or from 25:1 to 50:1.

According to some of any of the embodiments described herein, the cyclic esters mixture (the at least first and second cyclic esters) comprises D-lactide and meso-lactide, and optionally further comprises L-lactide (e.g., in an amount lower than 1 mol %).

According to some of these embodiments, a mol ratio between the D-lactide and meso-lactide ranges from 2.5:1 to 1000:1, or from 4:1 to 500:1, or from 10:1 to 200:1, or from 20:1 to 100:1, or from 25:1 to 50:1.

According to some of any of the embodiments described herein, the cyclic esters mixture (the at least first and second cyclic esters) comprises D-lactide and L-lactide, and optionally further comprises meso-lactide (in an amount lower than 1 mol %).

According to some of these embodiments, a mol ratio between the D-lactide and the L-lactide ranges from 2.5:1 to 1000:1, or from 4:1 to 500:1, or from 10:1 to 200:1, or from 20:1 to 100:1, or from 25:1 to 50:1.

According to some of any of the embodiments described herein, the catalyst exhibits a reaction rate constant towards meso-lactide which is higher by at least 2-folds (as described herein) relative to its rate constant towards L-lactide and towards D-lactide.

In some of any of the embodiments described herein, a mixture of lactide stereoisomers composed of L-lactide as main stereoisomer, meso-lactide as secondary stereoisomer, and D-lactide in trace amounts is employed as the polymerization stream.

In some of any of the embodiments described herein, a mol ratio between the L-lactide and meso-lactide ranges from 2.5:1 to 1000:1, or from 4:1 to 500:1, or from 10:1 to 200:1, or from 20:1 to 100:1, or from 25:1 to 50:1.

In some of any of the embodiments described herein, a mixture of lactide stereoisomers composed of L-lactide as main stereoisomer, D-lactide as secondary stereoisomer, and meso-lactide in trace amounts is employed as polymerization stream.

In some of any of the embodiments described herein, a mol ratio between the L-lactide and D-lactide ranges from 2.5:1 to 1000:1, or from 4:1 to 500:1, or from 10:1 to 200:1, or from 20:1 to 100:1, or from 25:1 to 50:1.

In some of any of the embodiments described herein, a mixture of lactide stereoisomers composed of D-lactide as main stereoisomer, meso-lactide as secondary stereoisomer, and L-lactide in trace amounts is employed as polymerization stream.

In some of any of the embodiments described herein, a mol ratio between the D-lactide and meso-lactide ranges from 2.5:1 to 1000:1, or from 4:1 to 500:1, or from 10:1 to 200:1, or from 20:1 to 100:1, or from 25:1 to 50:1.

In some of any of the embodiments described herein, a mixture of lactide stereoisomers composed of D-lactide as main stereoisomer, L-lactide as secondary stereoisomer, and meso-lactide in trace amounts is employed as polymerization stream.

In some of any of the embodiments described herein, a mol ratio between the D-lactide and L-lactide ranges from 2.5:1 to 1000:1, or from 4:1 to 500:1, or from 10:1 to 200:1, or from 20:1 to 100:1, or from 25:1 to 50:1.

According to some of any of the embodiments described herein, the conditions (e.g., reaction time and temperature) for promoting ROP are selected such that the ring opening polymerization (ROP) is effected at a conversion of at least 60%, or at least 75%, or at least 80%, or at least 85%, or at least 90%, or at least 95%. Such conditions typically include a reaction temperature of at least 150° C., or at least 160° C., for example, from 150 to 180° C.

According to some of any of the embodiments described herein, the conditions (e.g., reaction time and temperature) are selected such that the ring opening polymerization is effected at a conversion lower than 50%, or lower than 35%, or lower than 25%, or lower than 15%, or lower than 10%.

Such conditions comprise, for example, a reaction temperature lower than 180° C., or lower than 165° C., or lower than 150° C., or lower than 135° C.

According to some of any of the embodiments described herein, the conditions (e.g., reaction time and temperature) are selected such that the ring opening polymerization is effected at a conversion lower than 50% for a first time period, and at a conversion higher than 60% for a second time period.

In some of any of the embodiments described herein, wherein the polymerization is carried out to a low conversion, the polymerization temperature may be lower than 180° C., or lower than 165° C., or lower than 150° C., or lower than 135° C., so as to increase the relative consumption of the minor lactide stereoisomer (e.g., meso-lactide).

In some of any of the embodiments described herein, wherein the polymerization is carried out to a low conversion, this step of the polymerization is carried out in a pre-reactor.

In some of any of the embodiments described herein, wherein the polymerization is carried out to a low conversion, the polymerization may be continued to a higher conversion, under different conditions, and such conditions include but are not limited to either/and: a continuous reactor, or a polymerization taking place at higher temperature, or a polymerization employing a different catalyst.

In some of any of the embodiments described herein, wherein the polymerization is carried out to a low conversion, the unreacted monomer may be removed, e.g., by vacuum distillation.

According to some of any of the embodiments described herein, a process as described herein can be utilized for producing highly pure PLLA or PDLA from a starting material that comprises a mixture of L-lactide or D-lactide, respectively, and meso-lactide, using the catalyst system as described herein. According to these embodiments, such a cyclic ester mixture (a first cyclic ester mixture) is reacted to form a stereogradient polyester copolymer as described herein, under conditions as described herein (for example, conditions for promoting ROP to a low conversion), to thereby obtain a reaction mixture that comprises the formed stereogradient polyester copolymer and a second cyclic ester mixture. The second cyclic ester mixture (of unreacted cyclic ester) comprises a substantially lower, and even nullified, content of the meso-lactide compared to the first cyclic ester mixture. The second cyclic ester mixture and the formed stereogradient polyester copolymer are then separated (e.g., by distilling the unreacted cyclic ester from the reaction mixture; by filtration of the formed polyester) and the separated second cyclic ester mixture is subjected to conditions that promote ROP of the cyclic ester (which can be the same or different from the conditions for the ROP of the first cyclic ester mixture as described herein). The polymer obtained from the ROP of the second cyclic mixture is a highly pure PLLA or PDLA, depleted from stereoerrors, due to the substantially reduced or nullified content of meso-lactide in the second cyclic ester mixture.

According to some embodiments, a stereogradient polyester as described herein features high crystallinity, relatively low solubility in THF, and other physical properties as exemplified in the Examples section that follows.

According to some of any of the embodiments described herein, the stereogradient polyester copolymer as described herein features properties as described herein, which are similar to the respective properties of a polyester formed of only one of the cyclic esters (e.g., L-lactide), and which are non-linearly proportional to the total content of the other cyclic ester (e.g., meso-lactide). That is, for example, the number of “stereoerrors” that result from the presence of backbone units derived from one of the cyclic esters (e.g., the meso-lactide) within the backbone units derived from the other one of the cyclic esters (e.g., the L-lactide), does not change the properties of the polyester copolymer in a linear manner.

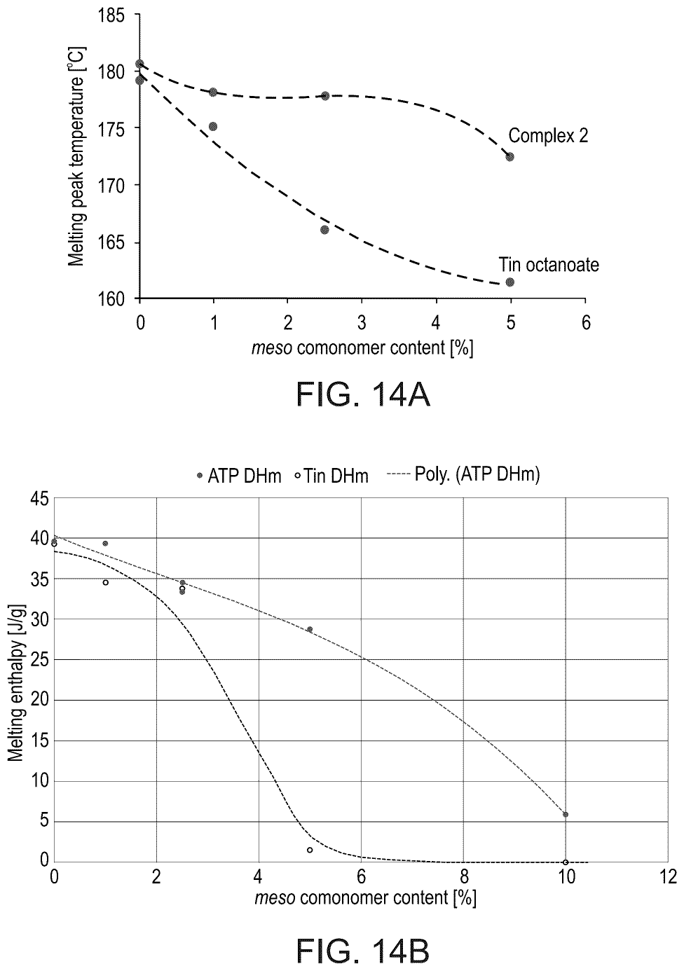

In this context, when the change in the properties is linear or substantially linear, a change in a property such as, for example crystallinity, which can be determined by the melting temperature Tm (e.g., as described herein) and the solubility in THF, or the deltaHm, relative to the same property of a polyester from of only the second cyclic ester, increases linearly as a function of the number of “stereoerrors” or the total content of the first cyclic ester in a polyester copolymer formed of a mixture of the first and the second cyclic esters is higher. This can be seen, for example, in FIG. 14A, for a reaction performed with tin octanoate. Thus, a Tm of the polyester copolymer decreases as the total content of the first cyclic ester in the copolymer increases.

When the change in such properties is non-linear, it means that the number of “stereoerrors” or the total content of the first cyclic ester in a polyester copolymer formed of a mixture of the first and the second cyclic esters, does not substantially change a respective property of the stereogradient polyester copolymer per se, and is substantially identical to the respective property of polyester formed only of the second cyclic ester. This can be seen, for example, in FIG. 14A, for a reaction performed with complex 2.

For example, a property such as Tm of the stereogradient polyester copolymer as described herein is substantially the same (e.g., is ±20% or ±10% or±5%) as the Tm of a polyester formed of the second cyclic ester alone, regardless of the number of stereoerrors that result from the total content of the first cyclic ester, or regardless of the total content of the first cyclic ester in the stereogradient polyester copolymer.

According to some of any of the embodiments described herein, the stereogradient polyester copolymer is such that features a property as described herein, for example, a melting temperature Tm, that is different from the respective property (e.g., Tm) of a polyester formed of only one of the first and second cyclic esters (e.g., L-lactide) by no more than 20%, or by no more than 10%, or by no more than 5%, when the total content of the other cyclic ester (e.g., meso-lactide) ranges from 1 to 20 mol % of the total amount of said first and second cyclic esters.

According to some of any of the embodiments described herein, the stereogradient polyester copolymer is such that features a property as described herein, for example, a melting temperature Tm, that is different from the respective property (e.g., Tm) of a polyester formed of only one of the second cyclic ester (e.g., L-lactide) by no more than 20%, or by no more than 10%, or by no more than 5%, when the total content of the first cyclic ester (e.g., meso-lactide) ranges from 1 to 20 mol % of the total amount of the first and second cyclic esters. In some of these embodiments, the first cyclic ester is meso-lactide and the second cyclic ester is a homolactide, for example, L-lactide.

The melting temperature Tm as used herein can be determined by methods known in the art, and as described herein in the Examples section that follows.

The melting temperature Tm as used herein refers to a first heating run and/or to a second heating run, as known in the art, and as described herein in the Examples section that follows.

The melting temperature Tm as used herein refers to either Celcius scale or F scale.

Herein throughout, a “stereogradient polyester copolymer” is also referred to herein interchangeably as a “stereogradient polyester” or simply as a “stereogradient polymer” or “stereogradient copolymer”.

According to an aspect of some embodiments of the present invention there is provided an article-of-manufacturing comprising a polyester for example, a poly(lactic acid) or a polyester-containing polymeric material as described herein, including, for example, a stereogradient polyester, a stereoblock co-polymer, and/or a block copolymer as described herein. Any articles commonly containing PLA or PLA-containing co-polymer are contemplated, as representative, non-limiting examples. Examples include, without limitation, commodity articles like food packaging, fibers, tubes, non-woven fabrics, etc. and articles employed in biomedical applications like resorbable coronary stents, matrices for controlled drug release, implants, sutures, etc.

### Ligands:

According to an aspect of some embodiments of the present invention, there is provided a proligand compound represented by Formula IV, as described herein.

According to some embodiments, the proligand compound is represented by Formula V or by Formula VI:

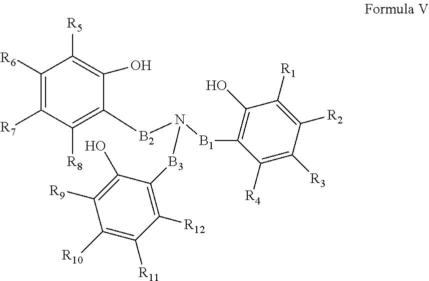

wherein B1, B2, B3 and R₁-R₁₂ being as defined herein;

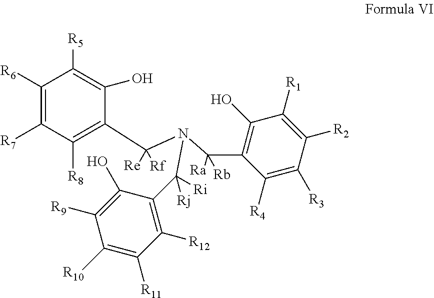

wherein Re, Rf, Ra, Rb, Ri, Rj and R1-R12 being as defined herein.

According to some embodiments, the proligand compound is represented by Formula Va or by Formula VIa:

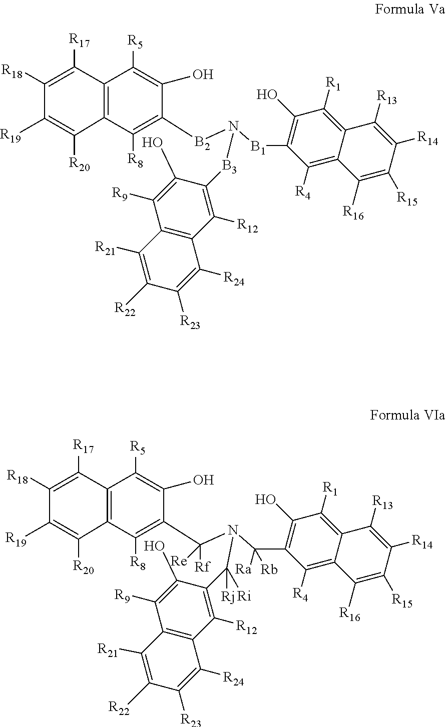

wherein all the variables are as defined herein in any of the respective embodiments and any combination thereof.

According to further aspects of the present invention there are provided processes of preparing the ligand precursor (proligand) compounds and complexes made therefrom, which are effected substantially in accordance with the processes described in the Examples section that follows, while selecting suitable starting materials and reactants.

As used herein the term “about” refers to ±10% or ±5%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

Herein throughout, the phrase “linking moiety” or “linking group” describes a group that connects two or more moieties or groups in a compound. A linking moiety is typically derived from a bi- or tri-functional compound, and can be regarded as a bi- or tri-radical moiety, which is connected to two or three other moieties, via two or three atoms thereof, respectively.

Exemplary linking moieties include a hydrocarbon moiety or chain, optionally interrupted by one or more heteroatoms, as defined herein, and/or any of the chemical groups listed below, when defined as linking groups.

When a chemical group is referred to herein as “end group” it is to be interpreted as a substituent, which is connected to another group via one atom thereof.

The term “alkyl”, as used herein, describes a saturated aliphatic hydrocarbon including straight chain and branched chain groups. In some embodiments, the alkyl group has 1 to 20 carbon atoms. Whenever a numerical range; e.g., “1-20”, is stated herein, it implies that the group, in this case the alkyl group, may contain 1 carbon atom, 2 carbon atoms, 3 carbon atoms, etc., up to and including 20 carbon atoms. In some embodiments, the alkyl is a lower alkyl having 1 to 4 carbon atoms. The alkyl group may be substituted or unsubstituted, as indicated herein.

The alkyl group can be an end group, as this phrase is defined hereinabove, wherein it is attached to a single adjacent atom, or a linking group, as this phrase is defined hereinabove, which connects two or more moieties via at least two carbons in its chain. When the alkyl is a linking group, it is also referred to herein as “alkylene” or “alkylene chain”.

The term “alkaryl” describes an alkyl, as defined herein, which is substituted by one or more aryl or heteroaryl groups. An example of alkaryl is benzyl.

Herein throughout, the term “alkyl” encompasses “alkaryl” unless specifically indicated otherwise.

The term alkenyl, as used herein, describes an alkyl, as defined herein, which contains a carbon-to-carbon double bond.

The term alkynyl, as used herein, describes an alkyl, as defined herein, which contains carbon-to-carbon triple bond.

The term “cycloalkyl” or “alicyclic” describes an all-carbon monocyclic or fused ring (i.e., rings which share an adjacent pair of carbon atoms) group where one or more of the rings does not have a completely conjugated pi-electron system. The cycloalkyl group may be substituted or unsubstituted, as indicated herein.

The term “aryl” describes an all-carbon monocyclic or fused-ring polycyclic (i.e., rings which share adjacent pairs of carbon atoms) groups having a completely conjugated pi-electron system. The aryl group may be substituted or unsubstituted, as indicated herein.

The aryl group can be an end group, as this phrase is defined hereinabove, wherein it is attached to a single adjacent atom, or a linking group, as this phrase is defined hereinabove, which connects two or more moieties via at least two carbons in its chain. When the alkyl is a linking group, it is also referred to herein as “arylene”, for example, phenylene.

The term “alkoxy” describes both an —O-alkyl and an —O-cycloalkyl group, as defined herein.

The term “aryloxy” describes an —O-aryl, as defined herein.

Each of the alkyl, cycloalkyl and aryl groups, including alkylene and arylene groups, in the general formulas herein, may be substituted by one or more substituents, whereby each substituent group can independently be, for example, halogen, alkyl, alkoxy, cycloalkyl, alkoxy, nitro, amine, hydroxyl, thiol, thioalkoxy, thiohydroxy, carboxy, amide, aryl and aryloxy, depending on the substituted group and its position in the molecule. Additional substituents are also contemplated.

The term “halide”, “halogen” or “halo” describes fluorine, chlorine, bromine or iodine.

The term “haloalkyl” describes an alkyl group as defined herein, further substituted by one or more halide(s).

The term “hydroxyl” or “hydroxy” describes a —OH group.

The term “thiohydroxy” or “thiol” describes a —SH group.

The term “thioalkoxy” describes both an —S-alkyl group, and a —S-cycloalkyl group, as defined herein.

The term “thioaryloxy” describes both an —S-aryl and a —S-heteroaryl group, as defined herein.

The term “amine” describes a —NR′R″ group, with R′ and R″ as described herein.

The term “heteroaryl” describes a monocyclic or fused ring (i.e., rings which share an adjacent pair of atoms) group having in the ring(s) one or more atoms, such as, for example, nitrogen, oxygen and sulfur and, in addition, having a completely conjugated pi-electron system.

Examples, without limitation, of heteroaryl groups include pyrrole, furan, thiophene, imidazole, oxazole, thiazole, carbazole, pyrazole, pyridine, pyrimidine, quinoline, isoquinoline and purine.

The term “heteroalicyclic” or “heterocyclyl” describes a monocyclic or fused ring group having in the ring(s) one or more atoms such as nitrogen, oxygen and sulfur. The rings may also have one or more double bonds. However, the rings do not have a completely conjugated pi-electron system. Representative examples are piperidine, piperazine, tetrahydrofuran, tetrahydropyrane, morpholino and the like.

The term “carboxy” or “carboxylate” describes a —C(═O)—OR′ group, where R′ is hydrogen, alkyl, cycloalkyl, alkenyl, aryl, heteroaryl (bonded through a ring carbon) or heteroalicyclic (bonded through a ring carbon) as defined herein.

The term “carbonyl” describes a —C(═O)—R′ group, where R′ is as defined hereinabove.

The above-terms also encompass thio-derivatives thereof (thiocarboxy and thiocarbonyl).

The term “thiocarbonyl” describes a —C(═S)—R′ group, where R′ is as defined hereinabove.

A “thiocarboxy” group describes a —C(═S)—OR′ group, where R′ is as defined herein.

A “sulfinyl” group describes an —S(═O)—R′ group, where R′ is as defined herein.

A “sulfonyl” group describes an —S(═O)₂—R′ group, where Rx is as defined herein.

A “carbamyl” group describes an —OC(═O)—NR′R″ group, where R′ is as defined herein and R″ is as defined for R′.

A “nitro” group refers to a —NO₂ group.

A “cyano” or “nitrile” group refers to a —C═N group.

Representative examples of nitrogen-containing heteroaryls include, but are not limited to thiadiazole, pyridine, pyrrole, oxazole, indole, purine and the like. Other moieties are also contemplated.

Representative examples of nitrogen-containing heteroalicyclic include, but are not limited to, morpholine, thiomorpholine, piperidine, piperazine, hexahydroazepine and tetrahydropyrane. Other moieties are also contemplated.

The term “piperazine” refers to a

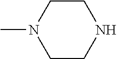

group or a

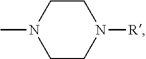

or a

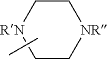

group, where R′ and R″ are as defined hereinabove.

The term “piperidine” refers to a

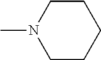

group or a

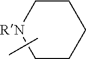

group, with R′ as defined herein.

The term “pyrrolidine” refers to a

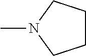

group or a

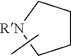

group, with R′ as defined herein.

The term “pyridine” refers to a

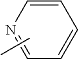

group.

The term pyrrole refers to a

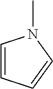

group or a

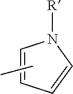

group, with R′ as defined herein.

The term “morpholine” refers to a

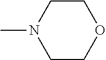

group, and encompasses also thiomorpholine.

The term “thiomorpholine” refers to a

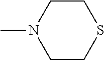

group.

The term “hexahydroazepine” refers to a

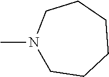

group.

As used herein, the term “alkylene glycol” describes a —O—[(CR′R″)_{z}—O]_{y}—R″′ end group or a —O—[(CR′R″)_{z}—O]_{y}— linking group, with R′, R″ and R″′ being as defined herein, and with z being an integer of from 1 to 10, preferably, from 2 to 6, more preferably 2 or 3, and y being an integer of 1 or more. Preferably R′ and R″ are both hydrogen. When z is 2 and y is 1, this group is ethylene glycol. When z is 3 and y is 1, this group is propylene glycol. When y is 2-4, the alkylene glycol is referred to herein as oligo(alkylene glycol).

When y is greater than 4, the alkylene glycol is referred to herein as poly(alkylene glycol). In some embodiments of the present invention, a poly(alkylene glycol) group or moiety can have from 10 to 200 repeating alkylene glycol units, such that z is 10 to 200, preferably 10-100, more preferably 10-50.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

### Materials and Methods

Reactions with air and/or water sensitive compounds were carried out using standard Schlenk or glovebox techniques under dry argon or nitrogen atmosphere.

THF and diethyl ether were refluxed over Na/benzophenone solution under argon atmosphere and then distilled. Toluene was refluxed over Na under argon atmosphere and then distilled. Pentane was washed with HNO₃/H₂SO₄, refluxed over Na/benzophenone/tetraglyme solution under argon atmosphere and then distilled.

Sodium triacetoxyborohydride was purchased from Alfa Aesar and used as received.

Hexamethylenetetramine and paraformaldehyde were purchased from Merck and used as received.

Formaldehyde 35% was purchased from Bio-Lab and used as received.

Phenylboronic acid and 2-bromo-4-methylphenol were purchased from Chem-Impex and used as received. 2-bromo-4-tert-butylphenol was purchased from Combi-Blocks and used as received.

Diisopropylamine, sodium hydride 60% dispersion in mineral oil, mesitylmagnesium bromide 1M solution in THF, chloromethyl methyl ether, N1,N1,N2,N2-tetramethylethane-1,2-diamine, n-butyllithium solution 2.5M in hexanes, ammonium acetate and zirconium (IV) isopropoxy isopropanol complex were purchased from Sigma-Aldrich and used as received.

Palladium (II) acetate 98%, zirconium (IV) tert-butoxide 98% and hafnium (IV) isopropoxy isopropanol complex were purchased from Strem and used as received.

Dry dimethylformamide was purchased from Acros and used as received.

L-lactide was purchased from Musashino Chemical Laboratory, Ltd. meso-Lactide (about 85%) was purchased from NatureWorks and purified by repeated crystallizations from 2-propanol to >99% purity (GC) and sublimed prior to use.

D-lactide and L-lactide were purchased from Musashino Chemical Laboratory, Ltd.

rac-Lactide was prepared by mixing equal amounts of D-lactide and L-lactide, crystallization from toluene and sublimation prior to use.

(R)-2-(methoxymethoxy)-2′-methyl-1,1′-binaphthalene was synthesized according to Zhu et. al., Synth. 2014, 46, 212-224. 6,6′-Azanediylbis(methylene)bis(2,4-di-tert-butylphenol) was synthesized according to Wang et. al., Inorg. Chim. Acta 2014, 421, 559-567. 2-(bromomethyl)-4,6-di-tert-butylphenol was synthesized according to Li et. al., RSC Adv. 2019, 9, 41824-41831.

Lig²H₃ was synthesized according to Groysman et. al., Adv. Synth. Catal. 2005, 347, 409-415. Lig^{t-Bu}H₃ was synthesized according to Kol et. al., Inorg. Chem. Commun. 2001, 4, 177-179. [Lig^{t Bu}Zr(O-iPr)] was synthesized according to Chmura et. al., Chem. Commun. 2008, 1, 1293-1295.

High pressure liquid chromatography (HPLC) on a Waters 2695 separation module equipped with a Waters 2996 photodiode array detector and agilent C18, 5 μm, 4.6x150 mm column was employed for determination of the purity of the ligands.

Preparative HPLC on a Waters 2545 quaternary module equipped with a Waters 2489 UV/visible detector and a SunFire C18, 5 μm, 30x150 mm column was employed for purification of ligands.

Gas chromatography (GC) on a Hewlett packard HP-5890 equipped with a Restek RtbDEXm 30 m chiral column was employed for analysis of the constitution and purity of the meso-lactide prior to polymerization.

NMR measurements were performed on a Bruker Avance-400 and Avance-500 spectrometers. CDCl₃ was used as NMR solvent for the starting materials, building blocks, proligands and PLA, with the ¹H chemical shift of TMS at δ 0.00, and ¹³C chemical shift of chloroform at δ 77.16. C₆D₆ was used as NMR solvent for the metal complexes, with chemical shifts of benzene at δ 7.16 (for ¹H NMR) and δ 128.06 (for ¹³C NMR) as references. Toluene-d₈ was used as VT ¹H NMR solvent for metal complexes, with chemical shifts at δ 2.08, 6.97, 7.01, 7.09.

Mass-spectrometric data were obtained on Waters XEVO-TQD MS spectrometer with the ESI ionization method (positive or negative).

PLA molecular weights were measured by gel permeation chromatography (GPC) using TSKgel GMHHR-M and TSKgel G 3000 HHR columns set on a Jasco instrument equipped with a refractive index detector. The molecular weights were determined relative to polystyrene standards using THF (HPLC grade) as the eluting solvent.

Differential Scanning Calorimetry (DSC) measurements were performed on a DSC8000 instrument (Perkin Elmer), equipped with a liquid nitrogen cooling accessory, according to the following procedure: 5 minutes temperature equilibration at 30° C.; temperature ramp at 10° C./min heating rate up to 200° C.; 5 minutes isothermal step at 200° C.; temperature ramp at 10° C./minute cooling rate down to 30° C.; 5 minutes isothermal step at 30° C.; temperature ramp at 10° C./minute heating rate up to 200° C. During all the steps the sample and reference chambers were under dry nitrogen purge at a flow rate of 50 mL/minute. The instrument was calibrated for temperature and enthalpy by a high purity indium (156.60° C., 28.45 J g⁻¹) standard. DSC characterization was carried out on “as received” polymer samples, namely, the first heating characterized the melting behavior of PLLA crystallized from solution. Accordingly, the cooling runs characterized crystallization from the melt, and the second heating runs characterized melting behavior of the polymers crystallized from the melt. The first heating runs were not comparatively analyzed and served as preparatory steps only, erasing the thermal history and introducing equal initial melt conditions for all samples.

The rheological behavior of the PLLA melts was characterized using an ARES G2 (TA Instruments) oscillatory rheometer equipped with a forced convection oven and a parallel plates sample geometry (25 mm; 1 mm gap). Time sweep tests were performed at 190° C. for 15 minutes at the oscillation frequency of 10 rad/sec and 10% strain.

The solubility of the polymer samples in THF was estimated by the following procedure: 100 mg of polymer was stirred in 1.0 mL of THF at room temperature for 1 hour. The liquid was removed by pipet and the remaining solid polymer was washed twice with cold THF, and after drying in air, the residue was dried under vacuum at 30° C. for 1 hour, and the polymer was weighed again. ¹H NMR analysis revealed that the soluble and insoluble polymer fractions were identical in all cases, namely, no fractionation took place.

### Example 1

### Synthesis of building blocks usable for the ligands' syntheses Example 1a: 2′,4′,5,6′-tetramethyl-[1,1′-biphenyl]-2-ol

In a pressure flask, sodium hydride 60% dispersion in mineral oil (0.648 gram, 16.2 mmol) was suspended in THF (20 mL) and the flask was cooled to 0° C. 2-Bromo-4-methylphenol (2.330 gram, 12.5 mmol) was slowly added and the flask was heated to room temperature. After stirring for 10 minutes, mesitylmagnesium bromide 1M solution in THF (18.00 mL, 18.0 mmol) was added followed by palladium (II) acetate 98% (0.126 gram, 0.56 mmol) and the flask was heated to 70° C. After stirring overnight, the flask was cooled to 0° C. and the reaction was quenched by adding aqueous HCl solution (2M, 30 mL). The resulting mixture was filtered through celite that was washed with ethyl acetate (3×20 mL). The phases were separated and the aqueous phase was extracted with ethyl acetate (3×20 mL). The combined organic phase was washed with brine, dried over sodium sulfate, filtered and the solvent was removed under vacuum. The crude product was purified by column chromatography over silica gel eluted with 5% ethyl acetate in hexane yielding the desired product with a little amount of impurities. The obtained product was purified by recrystallization from pentane to yield the clean product as a white powder (1.38 gram, 49%).

¹H NMR (CDCl₃, 400 MHz): δ=7.09 (dd, 1H, J=1.8 Hz, J=8.2 Hz, ArH), 7.00 (s, 2H, MsH), 6.91 (d, 1H, J=8.2 Hz, ArH), 6.83 (d, 1H, J=1.8 Hz, ArH), 4.50 (s, 1H, ArOH), 2.35 (s, 3H, ArCH₃), 2.32 (s, 3H, MsCH₃), 2.04 (s, 6H, MsCH₃).

### Example 1b: 2′-(methoxymethoxy)-2,4,5,6-tetramethyl-1,1′-biphenyl

Sodium hydride 60% dispersion in mineral oil (0.400 gram, 10.0 mmol) was suspended in dry THF (50 mL) and the flask was cooled to 0° C. under argon flow. Then, 2′,4′,5,6′-tetramethyl-[1,1′-biphenyl]-2-ol (1.888 gram, 8.3 mmol) was slowly added and the flask was heated to room temperature. After stirring for 1 hour, the flask was cooled again to 0° C. and chloromethyl methyl ether (1.25 mL, 16.7 mmol) was added. After the addition, the flask was heated to room temperature and the mixture was allowed to stir for 6 hours. To quench the reaction, water was carefully added until bubbles were not observed. The obtained mixture was extracted with ethyl acetate (3×30 mL) and the combined organic phase was washed with brine. The organic phase was dried over sodium sulfate, filtered, and the solvent was removed under vacuum to obtain the desired product as a light-yellow oil in quantitative yield.

¹H NMR (CDCl₃, 400 MHz): δ=7.11 (s, 2H, ArH), 6.94 (s, 2H, MsH), 6.85 (s, 1H, ArH), 5.01 (s, 2H, OCH₂O), 3.31 (s, 3H, OCH₃), 2.33 (s, 3H, ArCH₃), 2.32 (s, 3H, MsCH₃), 2.02 (s, 6H, MsCH₃). ¹³C NMR (CDCl₃, 100 MHz), δ 152.2 (C), 136.3 (3C), 135.4 (C), 131.5 (CH), 131.3 (C), 130.4 (C), 128.6 (CH), 127.8 (2CH), 115.2 (C), (12 aromatic carbons), 94.7 (ArOCH₂), 55.6 (OCH₃), 21.1 (ArCH₃), 20.5 (MsCH₃), 20.4 (2C, MsCH₃).

### Example 1c: 2-(methoxymethoxy)-2′,4′,5,6′-tetramethyl-[1,1′-biphenyl]-3-carbaldehyde

2′-(methoxymethoxy)-2,4,5′,6-tetramethyl-1,1′-biphenyl (2.25 grams, 8.3 mmol) and N1,N1,N2,N2-tetramethylethane-1,2-diamine (2.5 mL, 16.7 mmol) were dissolved in dry diethyl ether (50 mL) and the flask was cooled to 0° C. under argon flow. Then, n-butyllithium solution 2.5M in hexanes (5.7 mL, 14.2 mmol) was slowly added and the mixture was allowed to stir for 3 hours. Then, dry DMF (1.3 mL, 16.7 mmol) was added and the mixture was allowed to stir for another 1 hour. The reaction was quenched by adding a saturated solution of ammonium chloride and the phases were separated. The aqueous phase was extracted with diethyl ether (3×30 mL) and the combined organic phase was washed with brine. Then, the organic phase was dried over sodium sulfate, filtered and the solvent was removed under vacuum. The crude product was purified by column chromatography over silica gel eluted with 5% ethyl acetate in hexane to yield the desired product as a yellowish solid (1.28 gram, 51%).

¹H NMR (CDCl₃, 400 MHz): δ=10.44 (s, 1H, CHO), 7.67 (d, 1H, J=1.8 Hz, ArH), 7.17 (d, 1H, J=2.0 Hz, ArH), 6.94 (s, 2H, MsH), 4.61 (s, 2H, OCH₂O), 3.16 (s, 3H, OCH₃), 2.38 (s, 3H, ArCH₃), 2.33 (s, 3H, MsCH₃), 2.06 (s, 6H, MsCH₃). ¹³C NMR (CDCl₃, 100 MHz): δ=190.8 (CO), 155.4 (C), 138.5 (CH), 137.2 (C), 136.3 (2C), 134.7 (C), 134.1 (C), 133.8 (C), 129.6 (C), 128.2 (2CH), 127.6 (CH), (12 aromatic carbons), 99.5 (ArOCH₂), 57.1 (OCH₃), 20.9 (ArCH₃), 20.5 (MsCH₃), 20.4 (2C, MsCH₃).

### Example 1d: 3-(bromomethyl)-5-methylbiphenyl-2-ol

In pressure flask, 5-methylbiphenyl-2-ol (2.000 grams, 10.9 mmol) was dissolved in acetic acid (20 mL) and paraformaldehyde (0.544 gram, 18.1 mmol) was added. After stirring for 2 hours at room temperature hydrobromic acid 33% in acetic acid (4 mL, 21.7 mmol) was added and the flask was heated to 80° C. for additional 2 hours. Water (30 mL) was added to quench the reaction and the flask was cooled to 4° C. for 1 h to obtain an orange gel as a precipitate. The liquid was removed from the flask and the sticky gel was washed with water twice. The gel was dissolved in dichloromethane and the organic phase was washed with brine, dried over sodium sulfate and the solvent was removed under vacuum to yield the desired product in quantitative yield in 75% purity as an orange gel which was used without further purification.

¹H NMR (CDCl₃, 400 MHz): δ=7.52-7.39 (m, 5H, ArH), 7.14 (d, 1H, J=1.6 Hz, ArH), 7.02 (d, 1H, J=1.7 Hz, ArH), 5.40 (s, 1H, ArOH), 4.62 (s, 2H, ArCH₂Br), 2.31 (s, 3H, ArCH₃).

### Example 1e: (R)-2-(methoxymethoxy)-2′-methyl-[1,1′-binaphthalene]-3-carbaldehyde

(R)-2-(methoxymethoxy)-2′-methyl-1,1′-binaphthalene (1.54 gram, 4.7 mmol), and N1,N1,N2,N2-tetramethylethane-1,2-diamine (1.40 mL, 9.4 mmol) were dissolved in dry diethyl ether (22 mL) and the flask was cooled to 0° C. under an argon flow. n-Butyllithium (2.5M in hexanes, 3.18 mL, 7.9 mmol) was slowly added and the mixture was allowed to stir for 3 hours. Dry DMF (0.72 mL, 9.4 mmol) was added and the mixture was allowed to stir for another 1 hour. The reaction was quenched by adding a saturated solution of ammonium chloride and the phases were separated. The aqueous phase was extracted with diethyl ether (3×20 mL) and the combined organic phase was washed with brine, dried over sodium sulfate, and the solvent was removed under vacuum. The crude product was purified by column chromatography over silica gel eluted with 7% ethyl acetate in hexane to yield the desired product as a light-yellow oil (1.30 gram, 78% yield).

¹H NMR (CDCl₃, 400 MHz): δ=10.58 (s, 1H, CHO), 8.57 (s, 1H, ArH), 8.06 (d, 1H, J=8.3 Hz, ArH), 7.91 (dd, 2H, J=6.1 Hz, J=8.2 Hz, ArH), 7.53 (d, 1H, J=8.5 Hz, ArH), 7.48 (ddd, 1H, J=1.2 Hz, J=6.8 Hz, J=8.3 Hz, ArH), 7.42 (ddd, 1H, J=1.2 Hz, J=6.7 Hz, J=8.5 Hz, ArH), 7.36 (ddd, 1H, J=1.4 Hz, J=6.8 Hz, J=8.5 Hz, ArH), 7.27 (ddd, 1H, J=1.4 Hz, J=6.7 Hz, J=8.6 Hz, ArH), 7.16 (d, 1H, J=8.6 Hz, ArH), 7.12 (dd, J=0.8 Hz, J=8.5 Hz, 1H, ArH), 4.63 (d, 1H, J=5.9 Hz, OCH₂O), 4.58 (d, 1H, J=5.9 Hz, OCH₂O), 2.91 (s, 3H, OCH₃), 2.17 (s, 3H, ArCH₃).

¹³C NMR (CDCl₃, 100 MHz): δ=191.1 (CO), 153.1 (C), 136.6 (C), 135.8 (C), 133.2 (C), 132.1 (C), 131.7 (CH), 131.0 (C), 130.34 (CH), 130.27 (C), 129.5 (CH+C), 129.1 (C), 128.8 (CH), 128.4 (CH), 128.1 (CH), 126.5 (CH), 126.1 (CH), 126.0 (CH), 125.8 (CH), 125.2 (CH), (20 aromatic carbons), 99.9 (ArOCH₂), 57.1 (OCH₃), 20.6 (ArCH₃).

### Example 2

### Synthesis of the Ligands

### Example 2a: Synthesis of Lig¹H₃ (see, FIG. 2A)

2-(Methoxymethoxy-2′4′,5,6′-tetramethyl-[1,1′-biphenyl]-3-carbaldehyde (0.6 gram, 2.0 mmol) was dissolved in dry THF (13.5 mL) under an argon flow. Then, lyophilized ammonium acetate (0.052 gram, 0.67 mmol) was added followed by sodium triacetoxyborohydride (0.639 gram, 3.0 mmol) and the mixture was allowed to stir for 30 hours. The solvent was removed under vacuum and the residue was dissolved in ethyl acetate (30 mL). The organic solution was washed with aqueous solution of 5% potassium hydroxide (2×15 mL) and brine. The combined aqueous phase was extracted with ethyl acetate (30 mL) and the combined organic phase was dried over sodium sulfate, filtered, and the solvent was removed under vacuum. The crude product was purified by column chromatography over silica gel eluted with 7% ethyl acetate in hexane to yield the desired product in 85% purity (with 15% of the reactant) as a light-yellow oil.

¹H NMR (CDCl₃, 400 MHz): δ=7.55 (d, 3H, J=1.9 Hz, ArH), 6.97 (s, 6H, MsH), 6.85 (d, 3H, J=1.9 Hz, ArH), 4.68 (s, 6H, OCH₂O), 3.81 (s, 6H, ArCH₂) 3.01 (s, 9H, OCH₃), 2.43 (s, 9H, ArCH₃), 2.36 (s, 9H, MsCH₃), 2.13 (s, 18H, MsCH₃).

MS (ESI): Calc. for C₅₇H₆₉O₆N: 863.5, found: 865.0 (MH+).

This protected ligand was used without further purification and was dissolved in dichloromethane (3 mL). Hydrochloric acid 32% was added (3 mL) and the mixture was stirred vigorously. After 4 hours, the HCl salt of the ligand was separated by vacuum filtration. This salt was shaken with a mixture of DCM (100 mL) and saturated solution of sodium bicarbonate. The phases were separated and the aqueous phase was extracted with DCM (3×30 mL). The combined organic phase was washed with brine, dried over sodium sulfate, filtered and the solvent was removed under vacuum to yield the desired ligand as a white powder (0.230 gram, 47%).

¹H NMR (CDCl₃, 400 MHz): δ=6.97 (d, 3H, J=1.9 Hz, ArH), 6.92 (s, 6H, MsH), 6.70 (d, 3H, J=1.4 Hz, ArH), 3.74 (s, 6H, ArCH₂), 2.31 (s, 9H, ArCH₃), 2.24 (s, 9H, MsCH₃), 1.96 (s, 18H, MsCH₃).

¹³C NMR (CDCl₃, 100 MHz): δ=150.3 (3C), 137.4 (6C), 137.3 (3C), 133.4 (3C), 130.7 (3CH), 130.0 (3CH), 128.8 (3C), 128.5 (6CH), 127.1 (3C), 122.9 (3C), (36 aromatic carbons), 54.8 (3C, ArCH₂), 21.2 (3C, ArCH₃), 20.7 (3C, MsCH₃), 20.4 (6C, MsCH₃).

MS (ESI): Calc for C₅₁H₅₇O₃N: 731.4, found: 732.9 (MH+), 730.8 (M−).

### Example 2b: Synthesis of Lig³H₃ (see, FIG. 2A)

6,6′-azanediylbis(methylene)bis(2,4-di-tert-butylphenol) (0.427 gram, 0.94 mmol) and triethylamine (0.65 mL, 3.8 mmol) were dissolved in THF (20 mL). 3-(bromomethyl)-5-methylbiphenyl-2-ol 75% (0.392 gram, 1.4 mmol) was dissolved in THF (5 mL) and added slowly to the solution of the secondary amine while stirring. After 4 hours, the ammonium bromide salt was filtered out and the solvent was removed under vacuum. The crude ligand was purified by column chromatography over silica gel eluted with 20% ethyl acetate in hexane to yield the desired product with a little amount of impurities. Further purification by preparative HPLC gave the ligand as a white solid (0.174 gram, 28%).

¹H NMR (CDCl₃, 400 MHz): δ=7.52-7.42 (m, 4H, ArH), 7.42-7.39 (m, 1H, ArH), 7.21 (d, 1H, J=2.5 Hz, ArH), 6.97-6.96 (m, 3H, ArH), 6.88 (d, 1H, J=2.0 Hz, ArH), 6.71 (br s, 3H, ArOH), 3.75 (s, 4H, ArCH₂), 3.71 (s, 2H, ArCH₂), 2.25 (s, 3H, ArCH₃), 1.39 (s, 18H, ArC(CH₃)₃), 1.29 (s, 18H, ArC(CH₃)₃).

¹³C NMR (CDCl₃, 100 MHz): δ 152.5 (2C), 149.0 (C), 141.5 (2C), 137.2 (C), 136.1 (2C), 131.8 (CH), 130.6 (CH), 129.9 (C), 129.4 (2CH), 129.3 (2CH), 128.6 (C), 128.0 (CH), 125.2 (2CH), 123.9 (C), 123.6 (2CH), 122.2 (2C), (24 aromatic carbons), 58.1 (2C, ArCH₂), 55.1 (ArCH₂), 35.0 (ArCH₃), 34.3 (2C, ArC(CH₃)₃) 31.8 (6C, ArC(CH₃)₃), 29.8 (6C, ArC(CH₃)₃), 20.5 (2C, ArC(CH₃)₃).

MS (ESI): Calc for C₄₄H₅₉O₃N: 649.9, found: 650.9 (MH+), 648.8 (M−).

### Example 2c: Synthesis of Lig⁴H₃ (see, FIG. 2A)

2-(Aminomethyl)-4,6-di-tert-butylphenol (0.237 gram, 1.0 mmol) and triethylamine (1.55 mL, 10 mmol) were dissolved in THF (20 mL). 3-(bromomethyl)-5-methylbiphenyl-2-ol 75% (0.838 gram, 3.0 mmol) was dissolved in THF (5 mL) and was added slowly to the secondary amine solution while stirring. After 4 hours, the ammonium bromide salt was filtered out and the solvent was removed under vacuum. The crude ligand was purified by column chromatography over silica gel eluted with 7% ethyl acetate in hexane to yield the desired product with a little amount of impurities. Further purification by preparative HPLC gave the proligand as a white solid (0.223 gram, 35%).

¹H NMR (CDCl₃, 400 MHz): δ=7.52-7.45 (m, 8H, ArH), 7.39 (tt, 2H, J=2.0 Hz, J=7.0 Hz, ArH), 7.25 (d, 1H, J=2.4 Hz, ArH), 7.00-6.97 (m, 5H, ArH), 5.36 (br s, 3H, ArOH), 3.85 (s, 6H, ArCH₂), 2.30 (s, 6H, ArCH₃), 1.44 (s, 9H, ArC(CH₃)₃), 1.35 (s, 9H, ArC(CH₃)₃).

¹³C NMR (CDCl₃, 100 MHz): δ=153.1 (C), 149.7 (2C), 141.0 (C), 137.8 (2C), 135.8 (C), 131.4 (2CH), 130.6 (2CH), 129.4 (4CH), 129.2 (2C), 128.9 (4CH), 128.7 (2C), 127.5 (2CH), 124.7 (CH), 123.8 (2C), 123.3 (CH), 122.3 (C), (30 aromatic carbons), 58.5 (ArCH₂), 56.2 (2C, ArCH₂), 34.9 (ArC(CH₃)₃), 34.2 (ArC(CH₃)₃), 31.8 (3C, ArC(CH₃)₃), 29.7 (3C, ArC(CH₃)₃), 20.5 (2C, ArCH₃).

MS (ESI): Calc for C₄₃H₄₉O₃N: 627.4, found: 628.4 (MH+), 626.4 (M−).

### Example 2d: Synthesis of Lig⁵H₃ (see, FIG. 2A)

(R)-2-(Methoxymethoxy)-2′-methyl-[1,1′-binaphthalene]-3-carbaldehyde (0.525 gram, 1.47 mmol) was dissolved in dry THF (10 mL) under an argon flow. Lyophilized ammonium acetate (0.038 gram, 0.49 mmol) was added followed by sodium triacetoxyborohydride (0.470 gram, 2.21 mmol) and the mixture was allowed to stir for 30 hours. The solvent was thereafter removed under vacuum and the residue was dissolved in ethyl acetate (30 mL). The organic solution was washed with aqueous solution of 5% potassium hydroxide (2×15 mL) and brine. The combined aqueous phase was extracted with ethyl acetate (30 mL) and the combined organic phase was dried over sodium sulfate, filtered and the solvent was removed under vacuum. The crude product was purified by column chromatography over silica gel eluted with 20% ethyl acetate in hexane to yield the desired product as white solid.

¹H NMR (CDCl₃, 400 MHz): δ=8.56 (s, 3H, ArH), 7.96 (d, 3H, J=8.1 Hz, ArH), 7.87 (d, 6H, J=8.3 Hz, ArH), 7.50 (d, 3H, J=8.6 Hz, ArH), 7.42-7.36 (m, 6H, ArH), 7.24-7.18 (m, 9H, ArH), 7.07 (d, 3H, J=8.4 Hz, ArH), 4.51 (d, 3H, J=5.5 Hz, OCH₂O), 4.40 (d, 3H, J=5.4 Hz, OCH₂O), 4.26 (s, 6H, ArCH₂), 2.69 (s, 9H, OCH₃), 2.16 (s, 9H, ArCH₃).

¹³C NMR (CDCl₃, 100 MHz): δ=152.2 (3C), 153.8 (3C), 133.6 (3C), 133.2 (3C), 132.9 (3C), 132.5 (3C), 132.1 (3C), 131.3 (3C), 129.3 (3CH), 128.8 (3CH), 128.2 (3CH), 128.0 (6CH), 126.4 (6CH), 126.1 (3CH), 125.8 (3CH), 125.1 (3CH), 125.0 (3CH), 98.7 (3OCH₂O), 56.6 (3OCH₃), 53.8 (3ArCH₂), 20.8 (3ArCH₃). MS (ESI): Calc for C₇₂H₆₃06N: 1037.5, found: 1038.9 (MH+).

The protected proligand was dissolved in dichloromethane (3 mL), hydrochloric acid (32%, 3 mL) was added and the mixture was stirred vigorously. After 4 hours, a saturated solution of sodium bicarbonate (50 mL) and dichloromethane (50 mL) were added, the phases were separated and the aqueous phase was extracted with dichloromethane (3×30 mL). The combined organic phase was washed with brine, dried over sodium sulfate, filtered and the solvent was removed under vacuum. Purification by precipitation from a mixture of DCM (1 mL) and methanol (3 mL) gave the desired proligand as a white powder (0.177 gram, 40%).

¹H NMR (CDCl₃, 400 MHz): δ=7.87-7.83 (m, 9H, ArH), 7.75 (d, 3H, J=8.1 Hz, ArH), 7.42 (d, 3H, J=8.4 Hz, ArH), 7.32-7.24 (m, 6H, ArH), 7.16 (ddd, 3H, J=1.3 Hz, J=6.7 Hz, J=8.7 Hz, ArH), 7.11 (d, 3H, J=8.5 Hz, ArH), 6.96-6.89 (m, 6H, ArH), 5.25-3.40 (br s, 3H, OH), 4.20 (d, 3H, J=13.0 Hz, ArCH₂), 4.13 (d, 3H, J=13.2 Hz, ArCH₂), 1.92 (s, 9H, ArCH₃).

¹³C NMR (CDCl₃, 100 MHz): δ=151.1 (3C), 136.6 (3C), 133.4 (3C), 133.2 (3C), 132.4 (3C), 130.5 (3CH), 130.1 (3C), 129.0 (3CH), 128.6 (3C), 128.5 (3CH), 128.0 (3CH), 127.9 (3CH), 126.5 (3CH), 126.4 (3CH), 125.7 (3CH), 125.5 (3C), 125.2 (3CH), 124.5 (3CH), 123.4 (3CH), 118.7 (3C), (60 aromatic carbons), 55.5 (3ArCH₂), 20.2 (3ArCH₃).

MS (ESI): Calc for C₆₆H₅₁O₃N: 905.4, found: 906.8 (MH+), 904.8 (M−).

### Example 2e: Synthesis of Lig⁶H₃ (see, FIG. 2A)

In a pressure flask, sodium hydride 60% dispersion in mineral oil (1.3 gram, 32.5 mmol) was suspended in THF (40 mL) and the flask was cooled to 0° C. 2-Bromo-4-(tert-butyl)phenol (5.73 grams, 25 mmol) was slowly added and the flask was heated to room temperature. After stirring for 10 minutes, mesitylmagnesium bromide 1M solution in THF (36.0 mL, 36 mmol) was added followed by palladium (II) acetate 98% (0.253 gram, 1.13 mmol) and the flask was heated to 70° C. After stirring overnight, the flask was cooled to 0° C. and the reaction was quenched by adding aqueous HCl solution (2M, 50 mL). The resulting mixture was filtered through celite that was washed with ethyl acetate (3×50 mL). The phases were separated and the aqueous phase was extracted with ethyl acetate (3×50 mL). The combined organic phase was washed with brine, dried over sodium sulfate, filtered and the solvent was removed under vacuum. The crude product was purified by column chromatography over silica gel eluted with 5% ethyl acetate in hexane yielding the desired product, 5-(tert-butyl)-2′,4′,6′-trimethyl-1[1,1′-biphenyl]-2-ol, with traces of impurities (95% purity) as a pale yellow solid (5.62 grams, 84%).

¹H NMR (CDCl₃, 400 MHz): δ=7.29 (dd, 1H, J=2.5 Hz, J=8.5 Hz, ArH), 7.03 (d, 1H, J=2.5 Hz, ArH), 7.01 (s, 2H, MsH), 6.92 (d, 1H, J=8.5 Hz, ArH), 4.49 (s, 1H, ArOH), 2.35 (s, 3H, MsCH₃), 2.03 (s, 6H, MsCH₃), 1.31 (s, 9H, ArC(CH₃)₃).

A pressure flask was charged with 5-(tert-butyl)-2′,4′,6′-trimethyl-[1,1′-biphenyl]-2-ol (1.77 gram, 6.6 mmol), hexamethylenetetramine (0.076 gram, 0.54 mmol), 35% aqueous solution of formaldehyde (0.75 mL, 9.5 mmol) and magnetic stir-bar. The flask was sealed and heated to 130° C. for 48 hours to yield a yellow solid. The crude yellow solid was treated with methanol to obtain a mixture of a white solid and a yellow solution. Separation of the white solid from the yellow solution and methanol washes (3×30 mL) afforded Lig⁶H₃ as a white powder (0.662 gram, 35%).

¹H NMR (CDCl₃, 400 MHz), δ=7.17 (d, 3H, J=2.5 Hz, ArH), 6.952 (d, 3H, J=2.7 Hz, ArH), 6.945 (s, 6H, MsH), 6.58 (br s, 3H, ArOH), 3.81 (s, 6H, ArCH₂), 2.33 (s, 9H, MsCH₃), 1.97 (s, 18H, MsCH₃), 1.29 (s, 27H, ArC(CH₃)₃).

¹³C NMR (CDCl₃, 100 MHz), δ=150.3 (C), 142.5 (C), 137.5 (C), 137.3 (C), 134.0 (CH), 128.5 (CH), 126.9 (CH), 126.8 (CH+C), 122.0 (C), 55.1 (ArCH₂), 34.2 (ArC(CH₃)₃), 31.8 (ArC(CH₃)₃), 21.2 (MsCH₃), 20.5 (MsCH₃).

MS (ESI): Calc for C₆₀H₇₅O₃N: 857.6, found: 858.7 (MH+), 856.7(M−).

It is to be noted that the synthetic pathway for preparing Lig⁶H₃ is simpler compared to the other ligands described herein.

### Example 3

### Synthesis of the Metal Complexes

### Example 3a: Synthesis of Lig¹Zr(Oi-Pr)(i-PrOH) (Complex 2; see, FIG. 2B)

In a glove box, zirconium (IV) isopropoxy isopropanol complex (0.053 gram, 0.14 mmol) was dissolved in toluene (1 mL). In another vial, Lig¹H₃ (0.1 gram, 0.14 mmol) was suspended in toluene (1 mL) and was added to the metal solution slowly during stirring. After a clear solution was obtained (2 hours), the solvent was removed under vacuum and the residue was washed with cold pentane (3×1 mL) and dried under vacuum to yield the desired complex Lig¹Zr(Oi-Pr)(i-PrOH) (complex 2) as a white powder (0.088 gram, 73%).

¹H NMR (CDCl₃, 400 MHz): δ=6.88-6.87 (m, 9H, MsH+ArH), 6.77 (d, 3H, J=2.0 Hz, ArH), 3.97-3.19 (m, 8H, ZrOCH(CH₃)₂+(CH₃)₂CHOH+ArCH₂), 2.25 (s, 9H, ArCH₃), 2.20 (s, 18H, MsCH₃), 2.14 (s, 9H, J=13.3 Hz, MsCH₃), 0.70 (d, 12H, J=6.2 Hz, ZrOCH(CH₃)₂+(CH₃)₂CHOH).

¹³C NMR (CDCl₃, 100 MHz): δ=155.9 (3C), 136.3 (3C), 136.0 (3C), 135.7 (3C), 131.6 (3CH), 129.9 (3CH), 128.8 (3C), 128.1 (6CH), 127.0 (3C), 124.6 (6C), (36 aromatic carbons), 70.0 (2C, ZrOC+ZrOHC), 59.7 (3C, ArCH₂), 24.6 (4C, ZrOCH(CH₃)₂+ZrOHCH(CH₃)₂), 20.8 (3C, ArCH₃), 20.7 (6C, MsCH₃), 20.5 (3C, MsCH₃).

MS (APPI): Calc for C₅₇H₆₉O₅NZr: 937.4, found: 877.4 (M−(iPrOH)-+).

### Example 3b: Synthesis of [Lig²Zr(Ot-Bu)]2

In a glove box, zirconium (IV) tert-butoxide (0.052 gram, 0.14 mmol) and Lig²H₃(0.1 gram, 0.14 mmol) were dissolved separately in diethyl ether (1 mL). The ligand solution was added slowly to the metal solution and the resulting mixture was allowed to stir for 2 hours to yield a white precipitate from a yellow solution. The solvent was partially removed under vacuum, and pentane (5 mL) was added. The yellow liquid was removed and the remaining solid was washed with pentane (3×3 mL) to yield the dinuclear complex as a white powder (0.076 gram, 62%).

¹H NMR (CDCl₃, 400 MHz): δ=7.52 (dd, 4H, J=1.4 Hz, J=7.6 Hz, ArH), 7.35 (d, 2H, J=2.5 Hz, ArH), 7.28 (t, 4H, J=7.4 Hz, ArH), 7.20 (tt, 4H, J=1.3 Hz, J=7.4 Hz, ArH), 7.14-7.01 (m, 8H, ArH), 7.03-7.00 (m, 6H, ArH), 6.91 (t, 2H, J=6.8 Hz, ArH), 6.80 (d, 2H, J=2.5 Hz, ArH), 6.72-6.70 (m, 6H, ArH), 6.55 (d, 2H, J=2.4 Hz, ArH), 6.51 (t, 2H, J=2.6 Hz, ArH), 5.46 (d, 2H, J=13.3 Hz, ArCH₂), 3.95 (d, 2H, J=12.7 Hz, ArCH₂), 3.92 (d, 2H, J=12.6 Hz, ArCH₂), 2.66 (d, 2H, J=13.3 Hz, ArCH₂), 2.54 (d, 2H, J=14.2 Hz, ArCH₂), 2.43 (d, 2H, J=13.4 Hz, ArCH₂), 1.40 (s, 18H, ArC(CH₃)₃), 1.28 (s, 18H, ArC(CH₃)₃), 1.12 (s, 36H, ArC(CH₃)₃+ZrOC(CH₃)₃).

¹³C NMR (CDCl₃, 100 MHz): =δ 156.8 (2C), 154.6 (2C), 151.8 (2C), 143.3 (2C), 141.2 (2C), 140.74 (2C), 140.71 (2C), 139.7 (2C), 139.0 (2C), 131.7 (2C), 130.6 (2CH), 130.0 (4CH), 129.9 (4CH), 129.2 (2C), 128.6 (2C), 128.3 (4CH), 127.9 (4CH), 127.83 (4CH), 127.77 (2CH), 127.5 (4CH), 127.4 (2CH), 127.3 (2CH), 126.8 (2C), 126.5 (2CH), 126.3 (2C), 125.7 (2CH), 125.62 (2CH), 125.56 (2C), 124.7 (2CH), 123.6 (2CH), (72 aromatic carbons), 78.0 (2C, ZrOC), 64.5 (4C, ArCH₂), 63.7 (4C, ArCH₂), 61.8 (4C, ArCH₂), 33.6 (2C, ArC(CH₃)₃), 33.4 (4C, ArC(CH₃)₃), 31.8 (6C, ArC(CH₃)₃), 31.5 (12C, ArC(CH₃)₃+ZrOC(CH₃)₃), 31.2 (6C, ArC(CH₃)₃).

MS (APPI): Calc for C₁₁₀H₁₂₆O₈N₂Zr₂: 1782.8, found: 1708.6 [(M−(O-tBu)+].

### Example 3c: Synthesis of Lig³Zr(Oi-Pr)(i-PrOH)

In a glove box, zirconium (IV) isopropoxy isopropanol complex (0.060 gram, 0.15 mmol) and Lig³H₃(0.100 gram, 0.15 mmol) were dissolved separately in toluene (1 mL). Then, the proligand solution was added slowly to the metal solution and the resulting mixture was allowed to stir for 2 hours. The solvent was removed under vacuum to yield sticky oil that dissolved again in pentane (3 mL). Removal of the solvent afforded the desired complex as a light-yellow solid.

¹H NMR (CDCl₃, 400 MHz): δ=7.86 (dd, 2H, J=1.2 Hz, J=8.2 Hz, ArH), 7.52 (d, 2H, J=2.4 Hz, ArH), 7.32 (t, 2H, J=7.7 Hz, ArH), 7.20 (d, 1H, J=1.8 Hz, ArH), 7.16 (tt, 1H, J=1.2 Hz, J=7.4 Hz, ArH), 6.96 (d, 2H, J=2.2 Hz, ArH), 6.64 (d, 1H, J=2.1 Hz, ArH), 4.69 (sep, 1H, J=6.1 Hz, ZrOCH(CH₃)₂), 3.87 (sep, 1H, J=6.1 Hz, (CH₃)₂CHOH), 3.49 (br s, 6H, ArCH₂), 2.22 (s, 3H, ArCH₃), 1.69 (s, 18H, ArC(CH₃)₃), 1.45 (d, 6H, J=6.0 Hz, ZrOCH(CH₃)₂), 1.40 (s, 18H, ArC(CH₃)₃), 0.48 (d, 6H, J=5.9 Hz, (CH₃)₂CHOH).

¹³C NMR (CDCl₃, 100 MHz): δ=157.3 (2C), 155.7 (C), 140.1 (2C), 138.6 (C), 136.3 (2C), 130.7 (CH), 130.4 (CH), 129.7 (2CH), 128.1 (C), 127.9 (2CH), 127.8 (CH), 126.4 (CH), 125.6 (C), 124.7 (2CH), 124.4 (2C), 123.4 (2CH), (24 aromatic carbons), 72.0 (ZrOHC), 69.0 (ZrOC), 60.5 (2C, ArCH2), 59.5 (ArCH₂), 35.0 (2C, ArC(CH₃)₃), 34.0 (2C, ArC(CH₃)₃), 31.6 (6C, ArC(CH₃)₃), 29.6 (6C, ArC(CH₃)₃), 27.0 (ZrOHCH(CH₃)₂), 23.3 (ZrOCH(CH₃)₂), 20.2 (ArCH₃).

### Example 3d: Synthesis of Lig⁴Zr(Ot-Bu)(t-BuOH)

In a glove box, zirconium (IV) tert-butoxide (0.018 gram, 0.05 mmol) and Lig⁴H₃(0.030 gram, 0.05 mmol) were dissolved separately in diethyl ether (0.5 mL). Then, the proligand solution was added slowly to the metal solution and the resulting mixture was allowed to stir for 2 hours. The solvent was removed under vacuum to yield an off-white solid that washed with cold pentane (2×1 mL) and dried under vacuum to yield the desired complex as a white powder (0.017 gram, 41%).

¹H NMR (CDCl₃, 500 MHz): δ=7.81 (dd, 4H, J=1.1 Hz, J=8.5 Hz, ArH), 7.54 (d, 1H, J=2.4 Hz, ArH), 7.35 (t, 4H, J=7.7 Hz, ArH), 7.20-7.17 (m, 4H, ArH), 7.00 (d, 1H, J=2.4 Hz, ArH), 6.62 (d, 2H, J=1.6 Hz, ArH), 3.46-3.31 (m, 6H, ArCH₂), 2.22 (s, 6H, ArCH₃), 1.67 (s, 9H, ArC(CH₃)₃), 1.43 (s, 9H, ArC(CH₃)₃), 1.39 (s, 9H, ZrOC(CH₃)₃), 0.83 (s, 9H, (CH₃)₃COH).

¹³C NMR (CDCl₃, 125 MHz): δ=157.8 (C), 155.7 (2C), 140.6 (C), 139.3 (2C), 136.6 (C), 131.0 (2CH), 130.4 (2CH), 130.0 (4CH), 129.1 (2C), 128.2 (2C), 128.1 (4CH), 126.4 (2CH), 125.5 (2C), 125.0 (CH), 124.8 (C), 123.7 (CH), (30 aromatic carbons), 61.2 (ArCH2), 60.1 (2C, ArCH₂), 35.3 (ArC(CH₃)₃), 34.2 (ArC(CH₃)₃), 32.7 (ZrOHC(CH₃)₃), 31.9 (ArC(CH₃)₃), 30.3 (ZrOC(CH₃)₃), 30.1 (ArC(CH₃)₃), 22.5 (ZrOHC(CH₃)₃), 20.5 (2C, ArCH₃), 14.0 (ZrOC(CH₃)₃).

### Example 3e: Synthesis of Lig⁵Zr(Oi-Pr)(i-PrOH) (Complex 3; see, FIG. 2B)

In a glove box, zirconium (IV) isopropoxy isopropanol (0.021 gram, 0.06 mmol) and (R)-Lig⁵H₃(0.05 gram, 0.06 mmol) were dissolved separately in toluene (1 mL). The ligand solution was added slowly to the zirconium complex solution and the resulting mixture was allowed to stir for 2 hours at room temperature. The solvent was partially removed under vacuum and pentane (5 mL) was added to yield a white precipitate. The liquid was removed and the remaining solid was washed with pentane (3×3 mL) to yield the desired complex as a white solid (0.051 gram, 87%).

¹H NMR (C₆D₆, 400 MHz): δ=7.87 (d, 3H, J=8.3 Hz, ArH), 7.66 (d, 3H, J=7.7 Hz, ArH), 7.65 (s, 3H, ArH), 7.59 (d, 3H, J=8.4 Hz, ArH), 7.29 (d, 3H, J=8.5 Hz, ArH), 7.25-7.21 (m, 9H, ArH), 7.13 (t, 3H, J=7.3 Hz, ArH), 7.05 (ddd, 3H, J=1.4 Hz, J=6.6 Hz, J=8.8 Hz, 6.89 (t, 3H, J=7.6 Hz, ArH), 4.07-2.92 (br m, 8H, ArCH₂+ZrOCH(CH₃)₂+(CH₃)₂CHOH), 2.02 (s, 9H, ArCH₃), 0.21-0.02 (br m, 12H, ZrOCH(CH₃)₂+(CH₃)₂CHOH).

### Example 3f: Synthesis of Lig⁶Zr(Oi-Pr)(i-PrOH) (Complex 4; see, FIG. 2B)

In a glove box, zirconium (IV) isopropoxy isopropanol (0.045 gram, 0.12 mmol) and Lig⁶H₃(0.1 gram, 0.12 mmol) were dissolved separately in toluene (1 mL). Then, the proligand solution was added slowly to the metal solution and the resulting mixture was allowed to stir for 2 hours. The solvent was removed under vacuum to yield an off-white solid that was recrystallized from cold pentane (3×1 mL) and dried under vacuum to yield the desired complex as a white powder (0.087 gram, 70%).

¹H NMR (CDCl₃, 500 MHz): δ=7.20 (d, 3H, J=2.6 Hz, ArH), 7.10 (d, 3H, J=2.5 Hz, ArH), 6.90 (s, 6H, MsH), 3.76-3.27 (br m, 8H, ZrOCH(CH₃)₂+(CH₃)₂CHOH+ArCH₂), 2.21 (s, 18H, MsCH₃), 2.18 (s, 9H, MsCH₃), 1.33 (s, 27H, ArC(CH₃)₃), 0.71 (d, 12H, J=6.2 Hz, ZrOCH(CH₃)₂+(CH₃)₂CHOH).

¹³C NMR (CDCl₃, 125 MHz): δ=156.1 (C), 140.8 (C), 136.8 (C), 136.6 (C), 136.0 (C), 128.6 (CH), 128.4 (CH), 125.9 (CH), 124.4 (C), 70.9-69.5 (broad absorption), 60.5, (ArCH₂), 34.2 (ArCCH₃)₃), 32.0 (ArCCH₃)₃), 25.0-24.6 (broad absorption), 21.1 (MsCH₃).

### Example 4

### Polymerizations of L-lactide

### Example 4a: Polymerization of non-purified L-lactide with Lig¹Zr(Oi-Pr)(i-PrOH) (Complex 2)

In a glove box, the complex Lig¹Zr(Oi-Pr)(i-PrOH) (1.1 mg, 1.17 μmol) was dissolved in pentane, transferred to a heavy wall pressure vessel and the solvent was removed under vacuum. “As received” non-purified L-lactide was added (9.91 grams, 59000 mol equivalents) followed by benzyl alcohol (7.5 mg, 59 mol equivalents). A stir-bar was inserted, the flask was stoppered with a threaded Teflon stopper and heated to 180° C. to obtain melt conditions, and the mixture was allowed to stir. The viscosity of the polymerization mixture gradually increased until the stir bar ceased to rotate and the heating was continued for a total time of 30 minutes. The flask was cooled and opened to air to quench the polymerization. The flask content was dissolved in a hot mixture of toluene and chloroform to yield a homogenous solution and the conversion was determined by ¹H NMR, and was found to be 80%. The volatiles were removed under vacuum and the remaining monomer was extracted with methanol. The methanol was removed by vacuum filtration and the solid PLLA was dried under vacuum. Filtration and drying under vacuum afforded the solid polymer. The degree of enantiopurity of the obtained PLLA was determined from the relative intensities of the methine peaks in the ¹H NMR spectrum of a sample dissolved in CDCl₃, and was found to exceed 99%. The number averaged molecular weight (Mₙ) and molecular weight distribution (Poly Dispersity Index, PDI) of the obtained PLLA were determined by Gel Permeation Chromatography in THF relative to polystyrene standards, and following multiplication by a correction factor of 0.58 were found to be Mₙ=55700 and PDI=1.15. This example is presented in Table 1, entry 1. Additional examples of polymerization employing the same catalyst and different quantities of benzyl alcohol and L-lactide which were pursued at the same temperature for different periods of time, and which resulted in different conversions giving PLLA of the same very high degree of enantiopurity and different molecular weights and molecular weight distributions are presented in Table 1, entries 2-8.

### Example 4b: Polymerization of non-purified L-lactide with Lig¹Zr(Ot-Bu)

This polymerization was pursued as described in Example 4a hereinabove, except for using the complex Lig¹Zr(Ot-Bu) (1.1 mg, 1.23 μmol) as catalyst, “as received” non-purified L-lactide (9.76 grams, 55000 mol equivalents) and benzyl alcohol (7.0 μL, 55 mol equivalents). The polymerization was pursued at 180° C. for a total time of 30 minutes giving a conversion of 87%. The degree of enantiopurity of the obtained PLLA was found to exceed 99%, and the number averaged molecular weight and molecular weight distribution were found to be Mₙ=50600 and PDI=1.31. This example is presented in Table 1, entry 9.

### Example 4c: Polymerization of non-purified L-lactide employing a mixture of the proligand Lig¹H₃ and Zr(Oi-Pr)₄(i-PrOH)

In a glove box, in a heavy wall pressure vessel the proligand Lig¹H₃ (0.9 mg, 1.25 μmol) and Zr(Oi-Pr)₄(HOi-Pr) (0.5 mg, 1.25 μmol) were suspended in pentane and the solvent was removed under vacuum. “As received” non-purified L-lactide was added (9.91 grams, 55000 mol equivalents) followed by benzyl alcohol (7.1 μL, 55 mol equivalents). The polymerization was pursued as described in Example 4a for 30 minutes, followed by the same work-up procedure. The conversion was determined by ¹H NMR, and was found to be 78%. The degree of enantiopurity of the obtained PLLA was found to exceed 99%, and the number averaged molecular weight and molecular weight distribution were found to be Mₙ=51000 and PDI=1.15. This example is presented in Table 1, entry 10.

### Example 4d: Polymerization of non-purified L-lactide employing a mixture of the proligand Lig¹H₃ and Hf(Oi-Pr)₄(i-PrOH)

This polymerization was pursued according to the procedure described in Example 4c hereinabove, employing the proligand Lig¹H₃(0.9 mg, 1.25 μmol), Hf(Oi-Pr)₄(HOi-Pr) (0.5 mg, 1.21 μmol), “as received” non-purified L-lactide (9.75 grams, 55000 mol equivalents) and benzyl alcohol (7.1 μL, 55 mol equivalents). The polymerization was pursued for 100 minutes, followed by the same work-up procedure, and the conversion was found to be 71%. The degree of enantiopurity of the obtained PLLA was found to exceed 99%, and the number averaged molecular weight and molecular weight distribution were found to be Mₙ=52700 and PDI=1.13.

This example is presented in Table 1, entry 11.

### Example 4e: Polymerization of purified L-lactide with Lig¹Zr(Oi-Pr)(i-PrOH) (Complex 2)

“As received” L-lactide was purified by crystallization from hot toluene followed by sublimation. The polymerization was pursued according to the procedure described in Example 4a hereinabove, employing Lig¹Zr(Oi-Pr)(i-PrOH) (1.1 mg, 1.17 μmol), purified L-lactide (9.91 grams, 59000 mol equivalents) and benzyl alcohol (7.1 μL, 59 mol equivalents). The polymerization was pursued at 180° C. for 7 minutes giving a conversion of 92%. The degree of enantiopurity of the obtained PLLA was found to exceed 99%, and the number averaged molecular weight and molecular weight distribution were found to be Mₙ=96700 and PDI=1.17. This example is presented in Table 1, entry 12.

Additional examples of polymerization employing the same catalyst and different quantities of benzyl alcohol and purified L-lactide which were pursued at the same temperature for different periods of time and resulted in different conversions, giving PLLA of the same very high degree of enantiopurity and different molecular weights and molecular weight distributions are presented in Table 1, entries 13,14.

### Example 4f: Polymerization of non-purified L-lactide with the dimeric complex [Lig²-Zr(Ot-Bu)]2

This polymerization was pursued as described in Example 4a hereinabove, except for using the complex [Lig²-Zr(Ot-Bu)]₂ (1.1 mg, 1.23 μmol) as catalyst and toluene as solvent, “as received” non-purified L-lactide (9.76 grams, 55000 mol equivalents) and benzyl alcohol (7.0 μL, 55 mol equivalents). The polymerization was pursued at 180° C. for a total of 30 minutes giving a conversion of 64%. The degree of enantiopurity of the obtained PLLA was found to exceed 99%, and the number averaged molecular weight and molecular weight distribution were found to be Mₙ=44800 and PDI=1.14. This example is presented in Table 1, entry 15.

### Example 4g: Polymerization of non-purified L-lactide with Lig³Zr(Oi-Pr)(i-PrOH)

This polymerization was pursued as described in Example 4a hereinabove, except for using the complex Lig³Zr(Oi-Pr)(i-PrOH) (1.1 mg, 1.28 μmol) as catalyst, “as received” non-purified L-lactide (10.17 grams, 55000 mol equivalents) and benzyl alcohol (7.3 μL, 55 mol equivalents). The polymerization was pursued at 180° C. for a total of 300 minutes giving a conversion of 54%. The degree of enantiopurity of the obtained PLLA was found to exceed 99%, and the number averaged molecular weight and molecular weight distribution were found to be Mₙ=32300 and PDI=1.28. This example is presented in Table 1, entry 16.

### Example 4h: Polymerization of non-purified L-lactide with Lig⁴Zr(Ot-Bu)(t-BuOH)

This polymerization was pursued as described in Example 4a hereinabove, except for using the complex Lig⁴Zr(Ot-Bu)(t-BuOH) (1.1 mg, 1.27 μmol) as catalyst, “as received” non-purified L-lactide (10.10 grams, 55000 mol equivalents) and benzyl alcohol (7.3 μL, 55 mol equivalents). The polymerization was pursued at 180° C. for a total of 200 minutes giving a conversion of 55%. The degree of enantiopurity of the obtained PLLA was found to exceed 99%, and the number averaged molecular weight and molecular weight distribution were found to be Mₙ=33300 and PDI=1.11. This example is presented in Table 1, entry 17.

### Example 4i: Polymerization of non-purified L-lactide with complex Lig⁵Zr(Ot-Bu)(t-BuOH)

This polymerization was pursued as described in Example 4a hereinabove, except for using the complex Lig⁵Zr(Ot-Bu)(t-BuOH) (1.3 mg, 1.17 μmol) as catalyst, “as received” non-purified L-lactide (9.78 grams, 58000 mol equivalents) and benzyl alcohol (7.0 μL, 58 mol equivalents).

The polymerization was pursued at 180° C. for a total time of 30 minutes giving a conversion of 83%. The degree of enantiopurity of the obtained PLLA was found to exceed 99%, and the number averaged molecular weight and molecular weight distribution were found to be Mₙ=69600 and PDI=1.06. This example is presented in Table 1, entry 18.

### Example 4j: Polymerization of purified L-lactide with complex Lig⁵Zr(Ot-Bu)(t-BuOH)

This polymerization was pursued as described in Example 4e hereinabove, except for using the complex Lig⁵Zr(Ot-Bu)(t-BuOH) (0.5 mg, 0.45 μmol) as catalyst, purified L-lactide (68.41 grams, 1055000 mol equivalents) and benzyl alcohol (49 μL, 1055 mol equivalents). The polymerization was pursued at 180° C. for a total time of 300 minutes giving a conversion of 62%. The degree of enantiopurity of the obtained PLLA was found to exceed 99%, and the number averaged molecular weight and molecular weight distribution were found to be Mₙ=33600 and PDI=1.11. This example is presented in Table 1, entry 19.

### Comparative Example 4k: Polymerization of non-purified L-lactide with Lig^{5-Bu}Zr(Oi-Pr)

This polymerization was pursued as described in Example 4a hereinabove, except for using the known complex Lig^{t-Bu}Zr(Oi-Pr) (1.0 mg, 1.22 μmol) as catalyst, “as received” non-purified L-lactide (9.91 grams, 55000 mol equivalents) and benzyl alcohol (7.1 μL, 55 mol equivalents). The polymerization was pursued at 180° C. for a total time of 30 minutes giving a conversion of only 2%, and yielding a low molecular weight oligomer having Mₙ=2600 and PDI=1.27. This example is presented in Table 1, entry 20.

TABLE 1
Polymerizations of L-LA at 180° C.

| | | [Cat/BnOH/LA] | Time | Conv. | Mn | |
|---|---|---|---|---|---|---|
| Sample | Cat. | ratio | [min] | [%] | [g/mol]^{a} | PDI^{a} |
| 1 | Lig¹Zr(Oi-Pr)(i-PrOH) | 1/59/59000 | 30 | 80 | 55700 | 1.15 |
| 2 | Lig¹Zr(Oi-Pr)(i-PrOH) | 1/53/107500 | 100 | 84 | 84500 | 1.26 |
| 3 | Lig¹Zr(Oi-Pr)(i-PrOH) | 1/107/107500 | 100 | 92 | 61500 | 1.27 |
| 4 | Lig¹Zr(Oi-Pr)(i-PrOH) | 1/214/214000 | 120 | 71 | 47800 | 1.18 |
| 5 | Lig¹Zr(Oi-Pr)(i-PrOH) | 1/214/214000 | 240 | 84 | 52200 | 1.25 |
| 6 | Lig¹Zr(Oi-Pr)(i-PrOH) | 1/0/58600 | 100 | 80 | 84400 | 1.38 |
| 7 | Lig¹Zr(Oi-Pr)(i-PrOH) | 1/590/59000 | 15 | 95 | 7400 | 1.09 |
| 8 | Lig¹Zr(Oi-Pr)(i-PrOH) | 1/1070/107000 | 15 | 90 | 8700 | 1.08 |
| 9 | Lig¹Zr(Ot-Bu) | 1/55/55000 | 30 | 87 | 50600 | 1.31 |
| ^{b}10 | Lig¹Zr(Oi-Pr)(i-PrOH) | 1/55/55000 | 30 | 78 | 51000 | 1.15 |
| ^{b}11 | Lig¹Hf(Oi-Pr)(i-PrOH) | 1/55/55000 | 100 | 71 | 52700 | 1.13 |
| ^{c}12 | Lig¹Zr(Oi-Pr)(i-PrOH) | 1/59/59000 | 7 | 92 | 96700 | 1.17 |
| ^{c}13 | Lig¹Zr(Oi-Pr)(i-PrOH) | 1/214/214000 | 13 | 74 | 72400 | 1.12 |
| ^{c}14 | Lig¹Zr(Oi-Pr)(i-PrOH) | 1/1070/1070000 | 300 | 85 | 50700 | 1.23 |
| 15 | [Lig²-Zr(Ot-Bu)]² | 1/55/55000 | 30 | 64 | 44800 | 1.14 |
| 16 | Lig³Zr(Oi-Pr)(i-PrOH) | 1/55/55000 | 300 | 54 | 32300 | 1.28 |
| 17 | Lig⁴Zr(Ot-Bu)(t-BuOH) | 1/55/55000 | 200 | 55 | 33300 | 1.11 |
| 18 | Lig⁵Zr(Ot-Bu)(t-BuOH) | 1/58/58000 | 30 | 83 | 69600 | 1.06 |
| ^{c}19 | Lig⁵Zr(Ot-Bu)(t-BuOH) | 1/1055/1055000 | 300 | 62 | 33600 | 1.11 |
| 20 | Lig^{t-Bu}Zr(Oi-Pr) | 1/55/55000 | 30 | 2 | 2600 | 1.27 |

^{a}The molecular weights (Mn) and the PDI values of the polymers were determined by GPC relative to polystyrene standards and multiplied by a correction factor of 0.58.
^{b}The polymerization was performed with an in-situ formed catalyst.
^{c}The polymerization was performed with purified L-LA (recrystallization followed by
sublimation).

### Example 5

### Differential Scanning Calorimetry and Rheological Characterization of Selected Samples

### Example 5a: Differential Scanning Calorimetry

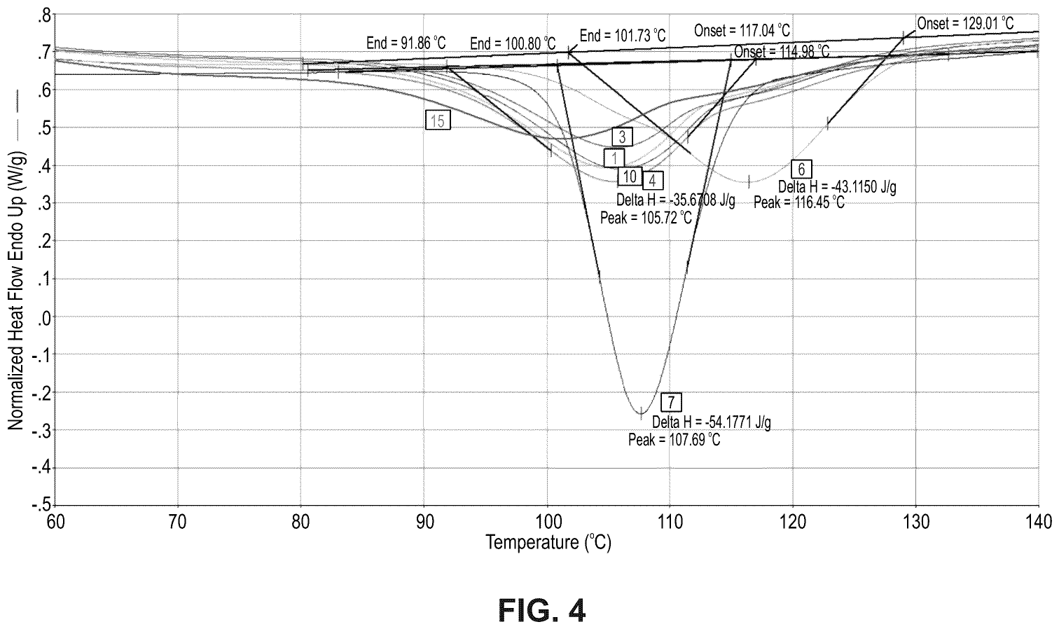

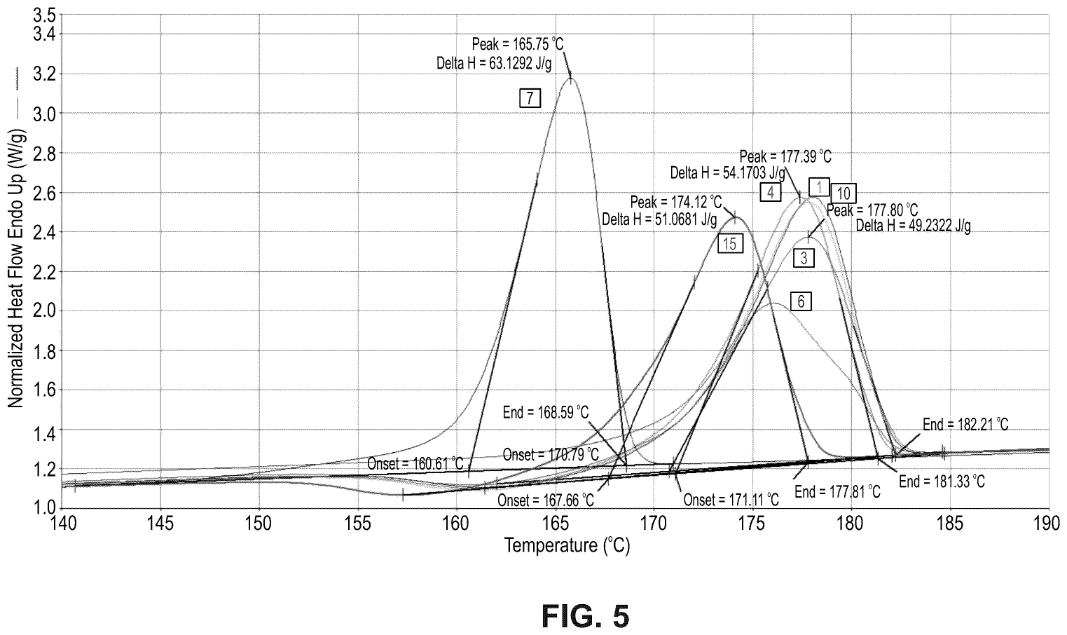

The thermal behavior of selected PLLA samples—Samples 1, 3, 4, 6, 7, 10, 15 from Table 1—was characterized using Differential Scanning Calorimetry (DSC), and the results are presented in Table 2 below and some are presented in FIG. 4. As shown in FIG. 4, all samples were capable of crystallizing from melt at a cooling rate of 10° C./minute, as evident by the presence of distinct exothermic peaks on the cooling thermograms. The crystallization peak temperatures ranged from 100 to 120° C., and the crystallization enthalpies were in the range of 25 to 55 J/g. As shown in FIG. 5, The melting behavior of the samples with endothermic peaks within the temperature range of from 165 to 178.C is characteristic of highly isotactic PLA, as noted in Dorgan et. al. in Journal of Rheology, 2005, 49, 607-619. The differences between the samples are attributed to their molecular weights. Whereas broad crystallization peaks and high melting transitions are observed for the samples having the higher molecular weights, the low molecular weight sample shows a narrow crystallization peak and narrow and relatively low melting transition.

TABLE 2
Melting-crystallization behavior of the PLLA samples

| Sample | 1 | 3 | 4 | 6 | 7 | 10 | 15 |
|---|---|---|---|---|---|---|---|
| Mn | 55700 | 61500 | 47800 | 84400 | 7400 | 51000 | 48100 |
| Mw = Mn*PDI | 64100 | 78100 | 56400 | 116500 | 8100 | 58700 | 56300 |
| PDI | 1.15 | 1.27 | 1.18 | 1.38 | 1.09 | 1.15 | 1.17 |

Cooling

| | | | | | | | |
|---|---|---|---|---|---|---|---|
| Tc onset (° C.) | 116.2 | 118 | 117 | 129 | 115 | 117.6 | 116.5 |
| Tc peak (° C.) | 104.9 | 105.9 | 105.7 | 116.45 | 107.7 | 106 | 101.1 |
| Tc end (° C.) | 91.2 | 91.3 | 91.9 | 101.7 | 100.8 | 92.3 | 86.1 |
| ΔH cryst (J/g) | 32.9 | 31.8 | 36.7 | 43.1 | 54.2 | 36.9 | 26.6 |

2-nd heating

| | | | | | | | |
|---|---|---|---|---|---|---|---|
| Tm onset (° C.) | 171.3 | 170.8 | 171.1 | 170 | 160.6 | 171.5 | 167.7 |
| Tm peak (° C.) | 177.8 | 177.8 | 177.4 | 176.05 | 165.75 | 178 | 174.1 |
| Tm end (° C.) | 181.9 | 182.2 | 181.3 | 182.1 | 168.6 | 181.9 | 177.8 |
| ΔH melt (J/g) | 54.35 | 49.2 | 54.2 | 40.7 | 63.1 | 54 | 51.1 |

[a] Sample numbers correspond to entries in Table 1.

### Example 5b: Rheological Characterization

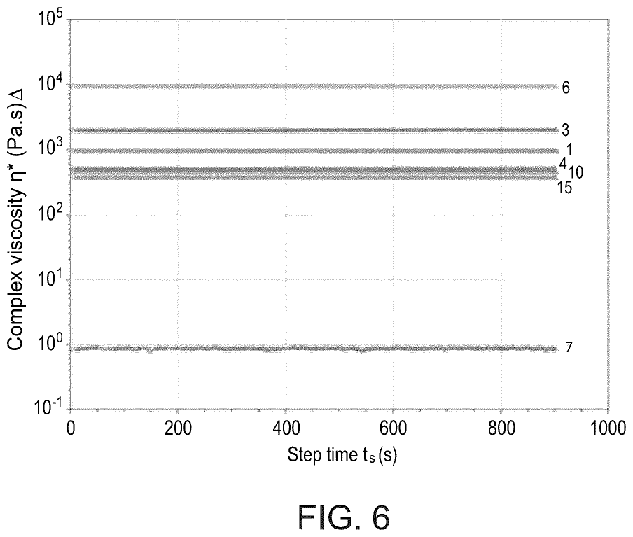

As shown in the data presented in Table 3 below, the polymers differ significantly in their melt viscosity at 190° C. Higher complex viscosity was measured for the higher molecular weight samples. As shown in FIG. 6, all the polymers demonstrated exceptional thermal stability. Unlike PLA homopolymers, synthesized using tin octanoate catalyst, which show significant reduction of viscosity during rheological tests performed at temperatures of 180° C. and above, as described for example in Dorgan et. al. in Journal of Rheology, 2005, 49, 607-619, and in WO 2009/121830, the polymers synthesized using exemplary catalysts as described herein showed a viscosity decline after 15 minutes at 190° C. not exceeding 2%. Negligible viscosity gain experimentally observed for some of the samples can be associated with removal of residual solvent.

TABLE 3
Rheological behavior of the PLLA samples at 190° C.

| Sample^{[a]} | 1 | 3 | 4 | 6 | 7 | 10 | 15 |
|---|---|---|---|---|---|---|---|
| Mn | 55700 | 61500 | 47800 | 84400 | 7400 | 51000 | 48100 |
| Mw = Mn*PDI | 64100 | 78100 | 56400 | 116500 | 8100 | 8700 | 56300 |
| PDI | 1.15 | 1.27 | 1.18 | 1.38 | 1.09 | 1.15 | 1.17 |

Complex viscosity at 190° C.

| | | | | | | | |
|---|---|---|---|---|---|---|---|
| Immediate (Pa*s) | 948 | 1967 | 511 | 9476 | 0.84 | 462 | 375 |
| after 5 minutes | 953 | 975 | 512 | 9423 | 0.85 | 462 | 374 |
| (Pa*s) | | | | | | | |
| after 10 minutes | 956 | 1987 | 514 | 9383 | 0.87 | 462 | 373 |
| (Pa*s) | | | | | | | |
| after 15 minutes | 960 | 1999 | 516 | 9349 | 0.85 | 462 | 372 |
| (Pa*s) | | | | | | | |

^{[a]}Sample numbers correspond to entries in Table 1.

### Example 6

### Stereoselectivity

As shown hereinabove, the complexes disclosed herein are active and enable high turnover numbers, are living and even immortal when used in solution at room temperature, and are highly stereoselective.

As demonstrated hereinbelow, the complexes as disclosed herein are capable of providing highly syndiotactic poly(lactic acid) (PLA) in ring opening polymerization of meso-lactide.

Polymerization in Solution at Room Temperature with 2-Propanol as Initiator:

In 2 mL of dichloromethane at room-temperature were dissolved 2.2 mg of complex Lig¹Zr(Oi-Pr)(i-PrOH) (complex 2) as catalyst, 1.5 mg of 2-propanol as initiator, and either 360 mg of meso-lactide or 360 mg of rac-lactide, providing molar ratios of 1:10.7:1070. The polymerizations were pursued for 15 minutes, and were thereafter quenched by opening the reactions to air.

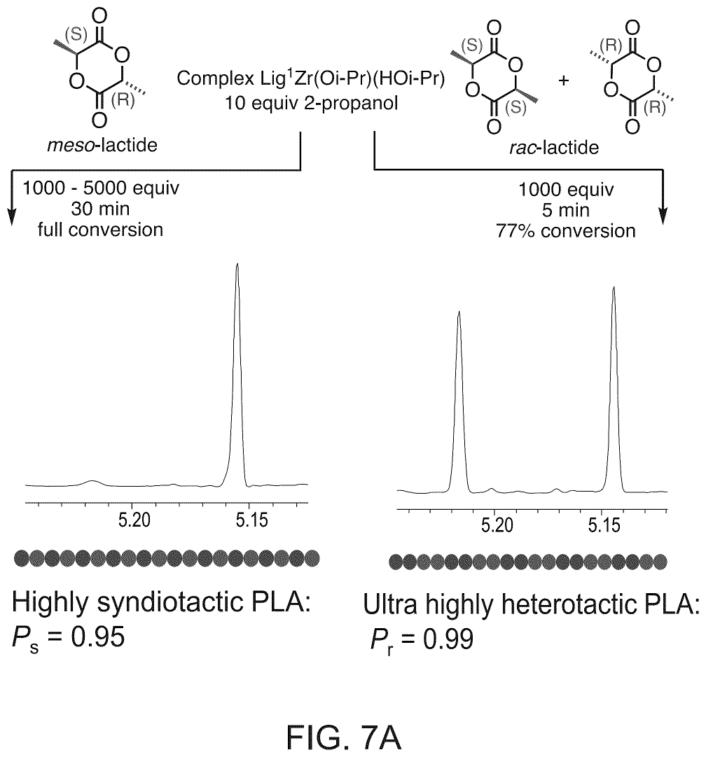

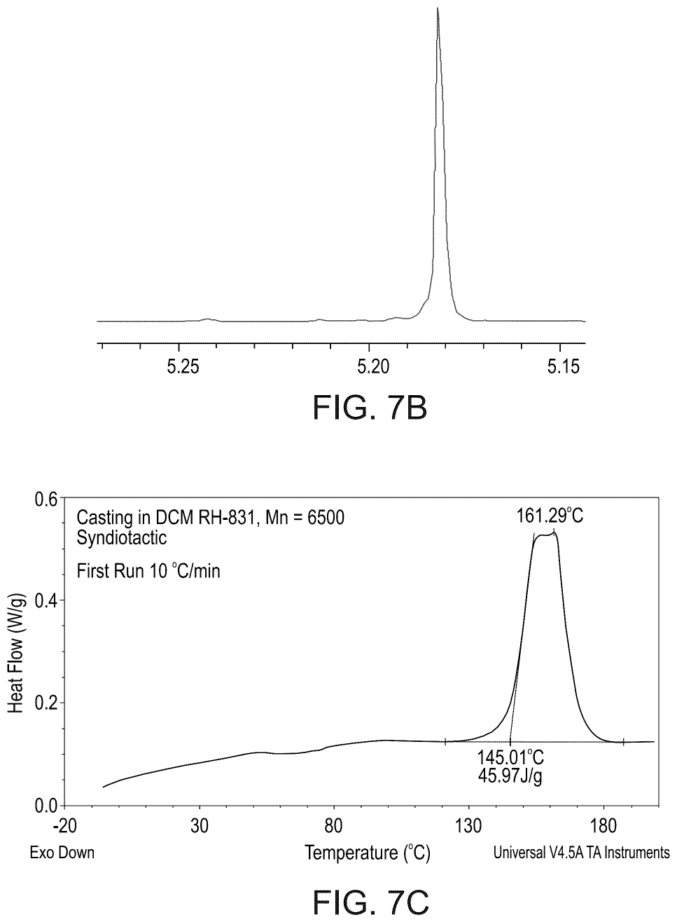

As shown in FIG. 7A, polymerization of meso-lactide in the presence of Lig¹Zr(Oi-Pr)(i-PrOH) (complex 2; 1,000-5000 mol equivalents of the monomer relative to the catalyst; typically 30 minutes reaction time) in solution, in the presence of 2-propanol as an initiator (10 mol equivalents per catalyst), led to highly syndiotactic PLA with one of the most high degrees of syndiotacticity ever recorded. The high degree of syndiotacticity can be seen in the homo-decoupled ¹H-NMR spectrum of the methine peak, which shows a dominant rrr-tetrad and very little errors.

As further shown in FIG. 7A, polymerization of rac-lactide in the presence of the complex Lig¹Zr(Oi-Pr)(i-Pr—OH) (1,000 mol quivalents of the monomer relative to the catalyst; typically 5-30 minutes reaction time) in solution, in the presence of 2-propanol as an initiator (10 molequivalents per catalyst), led to highly heterotactic PLA with one of the most high degrees of heterotacticity ever recorded. The high degree of heterotacticity can be seen in the homo-decoupled ¹H-NMR spectrum of the methine peak, which shows a dominant rmr and mrm tetrads in an essentially 1:1 ratio and very little errors.

The ¹H-NMR spectra further showed that the meso-lactide monomer reacted fully to give poly(lactic acid), whereby the the conversion of the rac-lactide monomer to poly(lactic acid) was 77%.

GPC analysis for the meso-lactide polymerization (not shown) showed that the polymer had a number average molecular weight of 14,000 and molecular weight distribution of PDI=1.08, supporting a living/immortal polymerization. The polymer featured a very high degree of syndiotacticity—Pₛ=0.95, approaching the record values attained with the sluggish aluminum-based catalysts. Differential scanning calorimetry showed multiple first heating melting transitions, the highest of which at 131.1° C., with ΔH_{melting} of 21.9 J/g.

GPC analysis for the rac-lactide polymerization (not shown) showed that the polymer had a number average molecular weight of 12,700 and molecular weight distribution of PDI=1.10, supporting a living/immortal polymerization. The polymer featured a very high degree of heterotacticity—Pᵣ=0.99, matching the highest values ever attained.

In another experiment, in 2 mL of dichloromethane at room-temperature were dissolved 2.6 mg of Lig⁵Zr(Oi-Pr)(i-Pr—OH) (complex 3) as catalyst, 1.5 mg of 2-propanol as initiator and 360 mg of meso-lactide—molar ratios of 1:10.7:1070. The polymerization was pursued for 15 minutes at 0° C., and was thereafter quenched by opening the reaction to air.

As shown in FIG. 7B, complex 3 afforded syndiotactic PLA from meso-lactide featuring a record degree of syndiotacticity (98-99%), as demonstrated by the very low degree of stereoerrors in the presented ¹H-NMR spectrum. This is the highest degree of syndiotacticity obtained to date in the polymerization of meso-lactide.

¹H-NMR further showed that that conversion of the monomer to poly(lactic acid) was 43%. GPC analysis revealed that the polymer had a number average molecular weight of 6,500 and molecular weight distribution of PDI=1.13. supporting a living/immortal polymerization. The polymer featured a very high degree of syndiotacticity—Pₛ=0.98, setting a record value for PLA syndiotacticity.

As shown in FIG. 7C, DSC measurements after casting showed a clear melting temperature of 161.3° C. with ΔH_{melting} of 46.0 J/g, which is the highest melting temperature ever reported for syndiotactic PLA, further supporting the high syndiotacticity achieved by the complexes of the present embodiments.

It is to be noted that up to date, a single catalyst that enables both high syndio-selectivity and high hetero-selectivity has not been reported.

In comparison, complex Lig^{t-Bu}Zr(Oi-Pr) (see, FIG. 2B) was reported to fully polymerize 100 mol equivalents of meso-lactide within 48 hours, to give syndiotactic PLA with Pₘ=0.85. That is, complexes 2 and 3 (Lig¹Zr(Oi-Pr)(i-PrOH) and Lig⁵Zr(Oi-Pr)(i-PrOH), respectively) are estimated to be three orders of magnitude more active than complex Lig^{t-Bu}Zr(Oi-Pr) towards meso-lactide while exhibiting significantly higher syndioselectivities.

### Polymerization of Meso-Lactide at 180° C.:

1.1 mg of Lig¹Zr(Oi-Pr)(i-PrOH) (complex 2) as catalyst, 1.2 microliter of benzyl alcohol as initiator and 1.69 grams of meso-lactide (98% pure)—molar ratios of 1:10:10000—were loaded into a heavy-walled glass reactor. A magnetic stir bar was introduced and the reactor was sealed with a Teflon stopper. The reactor was heated to 180° C. by means of preheated wax-bath placed on a magnetic stir-plate. After 5 minutes the polymerization was stopped by removing the reactor from the heating bath, and opening the reactor to air.

¹H-NMR analysis (data not shown) showed that the conversion of monomer mixture to polymer was 93%. GPC analysis (data not shown) showed that the polymer had a number average molecular weight of 65500 and molecular weight distribution of PDI=1.35. A syndiotacticity degree of Pₛ=0.78 was determined, indicating that the catalyst retains its syndioselectivity also under harsh conditions.

A parallel polymerization with tin octanoate resulted in 84% monomer conversion giving a polymer of a substantially lower degree of syndiotacticity of Pₛ '₂ 0.64 (data not shown). Along with the living character, these features enable using the complexes disclosed herein for producing stereoblock-copolymers of various microstructures.

### Example 7

### Stereoblock Copolymers

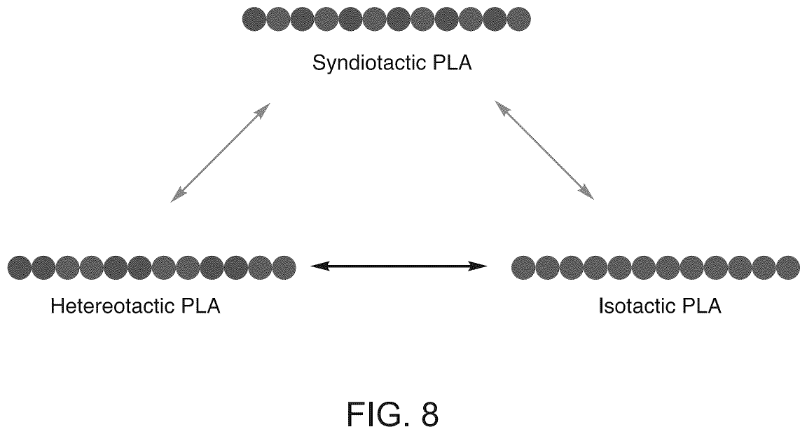

As shown in FIG. 8, there are three forms of stereoregular poly(lactic acid) (stereoconfigurations): isotactic, heterotactic and syndiotactic, which can lead to three combinations of stereoblock copolymers: isotactic-b-heterotactic; isotactic-b-syndiotactic; and syndiotactic-b-heterotactic. The latter two have never been reported.

In view of the properties of the complexes disclosed herein, sequential addition of meso-lactide and one or more of rac-lactide or L-lactide or D-lactide, respective stereoblocks can be obtained. Depending on the type of initiator used, di-blocks, tri-blocks, and higher stereoblocks, as well as symmetrical triblocks (in case of a difunctional initiator) such as syndiotactic-b-heterotactic-b-syndiotactic; heterotactic-b-syndiotactic-b-heterotactic; syndiotactic-b-isotactic-b-syndiotactic; or isotactic-b-syndiotactic-b-isotactic, can be obtained.

Accordingly, exemplary stereoblock copolymers were prepared as follows.

### Preparation of a Syndiotactic-Heterotactic Stereodiblock PLA:

In 2 mL of dichloromethane at room-temperature were dissolved 2.2 mg of Lig¹Zr(Oi-Pr)(i-Pr—OH) (complex 2) as catalyst, 1.5 mg of 2-propanol as initiator and 360 mg of meso-lactide—molar ratios of 1:10.7:1070. The polymerization was pursued for 15 minutes at room temperature. Solid rac-lactide (360 mg) was then added and the polymerization was continued for another 30 minutes, and was thereafter quenched by opening the reaction to air.

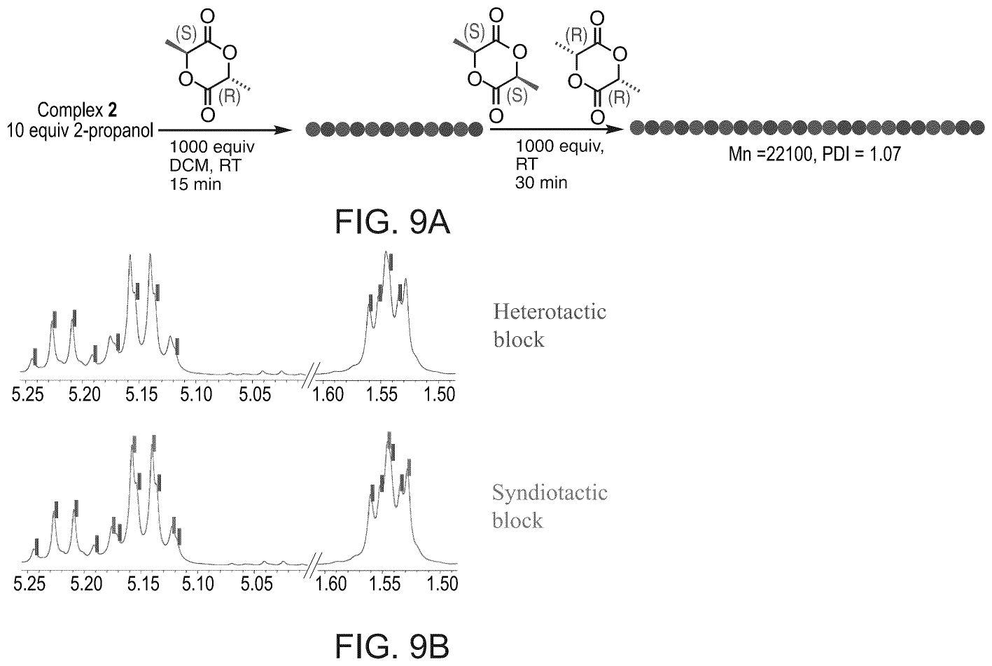

As shown in FIGS. 9A-B, Lig¹Zr(Oi-Pr)(i-PrOH) (complex 2), in the presence of 10 mol equivalents of isopropanol was able to polymerize 1,000 mol equivalents of meso-lactide in 15 minutes in dichloromethane solution at room temperature, in a very high conversion (>98%). Addition of rac-lactide to the polymerization mixture (1,000 mol equivalents; 30 minutes; room temperature) afforded the stereoblock copolymer syndiotactic-b-heterotactic PLA. The homodecoupled ¹H-NMR spectrum (FIG. 9B) confirmed the formation of a well-defined blocky-microstructure of a syndiotactic-heterotactic stereodiblock PLA, consistent with the high conversions of both monomers and demonstrating nullified scrambling events such as trans-esterification.

GPC analysis showed that the polymer had a number average molecular weight of 22100 and molecular weight distribution of PDI=1.07, supporting a living/immortal polymerization.

### Preparation of an Isotactic-Syndiotactic Stereodiblock PIA:

In 2 mL of dichloromethane at room-temperature were dissolved 2.2 mg of Lig¹Zr(Oi-Pr)(i-PrOH) (complex 2) as catalyst, 1.5 mg of 2-propanol as initiator and 360 mg of L-lactide-molar ratios of 1:10.7:1070 in a pressure glass vessel. The polymerization was pursued for 60 minutes at 70° C., and was cooled to room-temperature. 1 mL of dichloromethane followed by solid meso-lactide (360 mg) were then added and the polymerization was continued for another 30 minutes, and was thereafter quenched by opening the reaction to air.

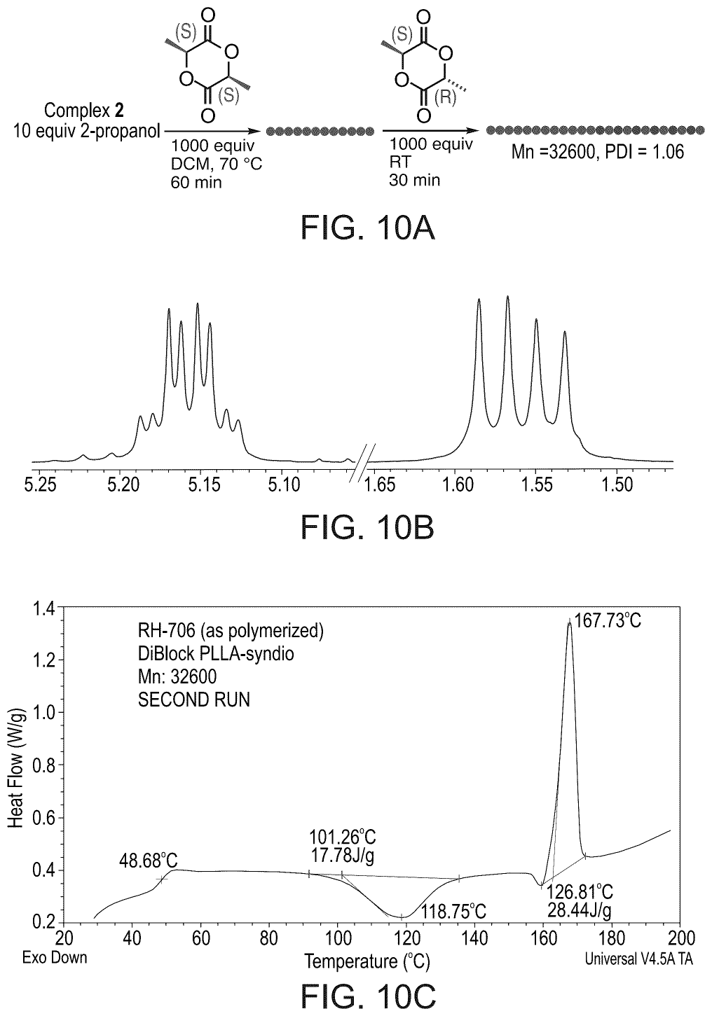

As shown in FIGS. 10A-C, catalyst Lig¹Zr(Oi-Pr)(i-PrOH) (complex 2), in the presence of 10 mol equivalents of isopropanol was able to polymerize 1,000 mol equivalents of L-lactide in 60 minutes in dichloromethane solution at 70° C., in a very high conversion. Addition of meso-lactide to the polymerization mixture (1,000 mol equivalents; 30 minutes; room temperature) afforded the stereoblock copolymer isotactic-b-syndiotactic PLA. The homo decoupled ¹H-NMR spectrum (FIG. 10B) confirmed the formation of a well-defined blocky-microstructure of an isotactic-syndiotactic stereodiblock PLA, and showed conversion of monomer to poly(lactic acid) of >98%, consistent with the high conversions of both monomers and demonstrating nullified scrambling events such as trans-esterification.

GPC analysis showed that the polymer had a number average molecular weight of 32600 and molecular weight distribution of PDI=1.07, supporting a living/immortal polymerization.

Measuring the DSC of the stereoblock copolymer (FIG. 10C) showed a clear melting at 167° C., which is typical to highly isotactic PLA, further supporting the integrity of the blocks and microphase separation thereof.

### Example 8

### Stereogradient Polymers

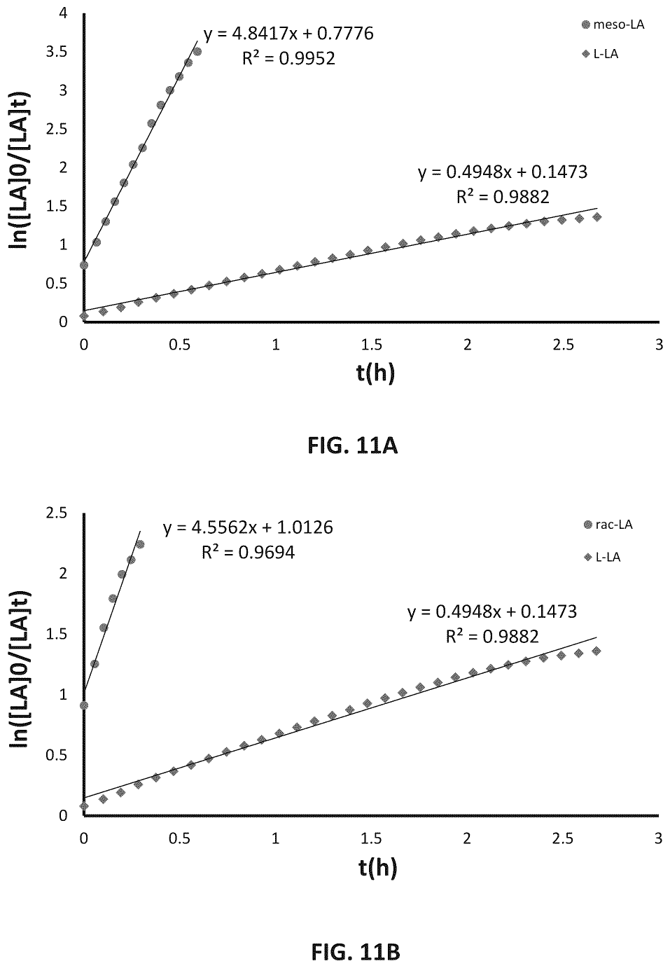

To find whether the syndioselective catalysts would exhibit a higher tendency to polymerize meso-lactide over L-lactide, the individual rates of meso-lactide consumption, rac-lactide consumption and L-lactide consumption were measured by NMR. The polymerizations were conducted in ds-toluene solutions at room temperature with 1,4-bis(trimethylsilyl)benzene as internal standard. The catalyst employed for both polymerizations was Lig¹Zr(Oi-Pr)(i-PrOH) (complex 2), without the addition of any initiator. The obtained data is shown in FIGS. 11A-B.

As can be seen in FIG. 11A, in the meso-lactide experiment, the concentration of complex Lig¹Zr(Oi-Pr)(i-PrOH) (complex 2) was 0.32 mM and the concentration of meso-lactide was 128 mM. First order kinetics was found and the apparent rate constant was kₐₚₚ=4.8 h⁻¹. In the L-lactide experiment, the concentration of Lig¹Zr(Oi-Pr)(i-PrOH) (complex 2) was also 0.32 mM and the concentration of L-lactide was also 128 mM and the apparent rate constant was kₐₚₚ=0.49 h⁻¹. This signifies that, under these conditions of temperature and solvent, a ratio of rate constants of 9.8:1 is calculated, signifying a strong bias towards meso-lactide over L-lactide by Lig¹Zr(Oi-Pr)(i-PrOH) (complex 2).

As can be seen in FIG. 11B, first order kinetics with kₐₚₚ=4.5 h⁻¹ was observed for rac-lactide (0.32 mM Lig¹Zr(Oi-Pr)(i-PrOH) (complex 2); 128 mM rac-lactide) and kₐₚₚ=0.49 h⁻¹ for L-lactide (0.32 mM complex Lig¹Zr(Oi-Pr)(i-PrOH); 128 mM L-lactide). This signifies that, under these conditions of temperature and solvent, a ratio of rate constants of 9.2:1 is calculated, indicating a strong bias towards rac-lactide over L-lactide.

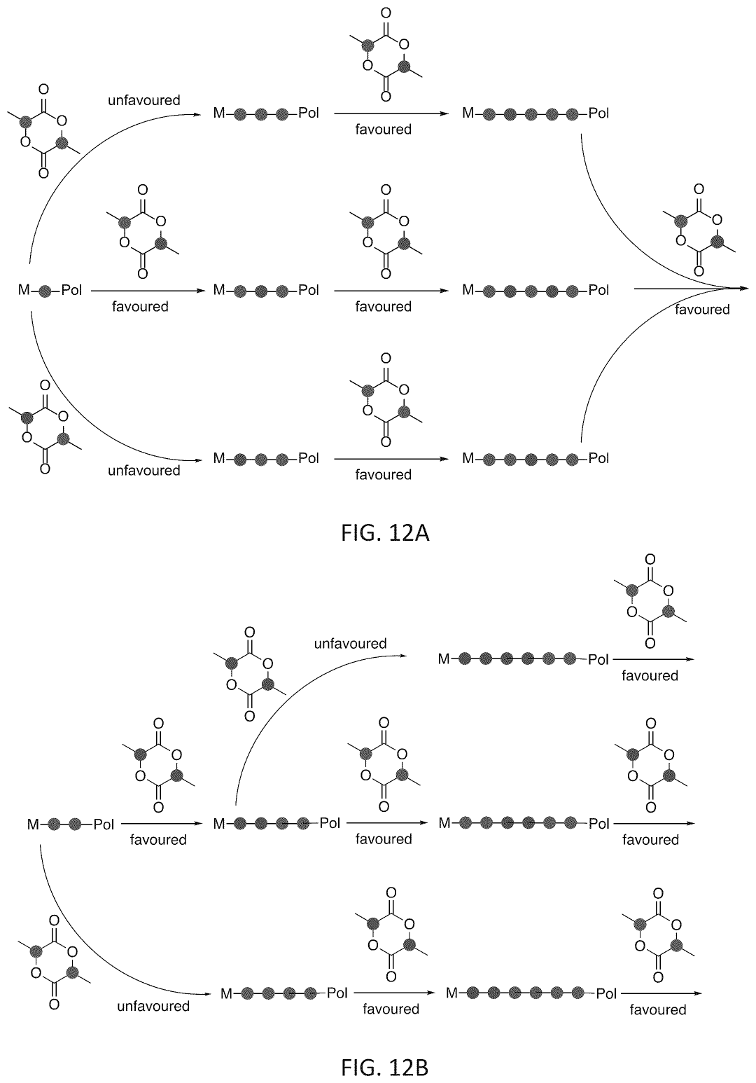

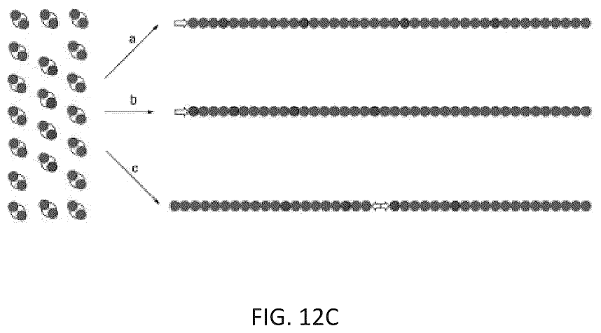

FIG. 12A is a scheme depicting a proposed stereocontrolled mechanism exhibited by a catalyst with preference to polymerize meso-lactide over the homochiral L-lactide or D-lactide. A catalyst that exhibits high syndioselectivity in polymerization of meso-lactide following the chain-end stereocontrol mechanism, should also consume meso-lactide preferentially in polymerizations of meso-lactide/L-lactide mixtures. As outlined in FIG. 12A, such catalysts prefer to open a meso-lactide ring next to a stereogenic center which is opposite to the last inserted one, and consequently regenerate the stereogenicity at the metal center, favoring another insertion of meso-lactide. An unfavoured insertion of L-lactide would retain the stereogenicity at the metal center which would still favor the insertion of meso-lactide. An opposite insertion of meso-lactide, may correct itself by insertion of L-lactide, and altogether this would generate a self-repairing mechanism for enhanced meso-lactide consumption. The resulting polymers would best be defined as stereogradient copolymers, wherein the segment of the chains proximal to the initiation point would be enriched in stereoerrors, while the segment(s) remote from the initiation point would be depleted of stereoerrors. The crystallinity of stereoregular polymers is mainly determined by the length of stereoerror-free sections. It is therefore hypothesized that, for a given number of stereoerrors, the presence of stereoerror-depleted regions in the stereogradient copolymers would lead to their enhanced crystallinity relative to random-stereoerror copolymers. This scheme demonstrates that production of stereogradient polyesters can preferably be performed in the presence of catalysts that exhibit an appreciable degree of syndioselectivity at the high temperatures characteristic of the industrial processes, as demonstrated in FIG. 12C.

FIG. 12B is a scheme depicting a proposed stereocontrolled mechanism exhibited by a catalyst with preference to polymerize rac-lactide over the homochiral L-lactide or D-lactide. A catalyst that exhibits high heteroselectivity in polymerization of rac-lactide, should also consume the minor enantiomer preferentially in polymerizations of non-racemic D-lactide/L-lactide mixtures. As outlined in FIG. 12B, such catalysts prefer to react with a lactide enantiomer which is opposite to the last inserted one, thus favoring the altogether consumption of the minor lactide enantiomer. An unfavoured insertion of the non-opposite enantiomer (i.e., the same enantiomer) would still retain the tendency of the catalyst to insert the opposite enantiomer in the next step. The preferred consumption of the minor enantiomer leads to stereogradient copolymers, wherein the segment of the chains proximal to the initiation point would be enriched in stereoerrors (caused by excessive insertions of the minor lactide enantiomer), while the segment(s) remote from the initiation point would be depleted of stereoerrors. The crystallinity of stereoregular polymers is mainly determined by the length of stereoerror-free sections. It is therefore hypothesized that, for a given number of stereoerrors, the presence of stereoerror-depleted regions in the stereogradient copolymers would lead to their enhanced crystallinity relative to random-stereoerror copolymers. This scheme demonstrates that production of stereogradient polyesters from non-racemic mixtures of L-lactide/D-lactide can preferably be performed in the presence of catalysts that exhibit an appreciable degree of heteroselectivity in polymerization of rac-lactide, as demonstrated in FIG. 12C. The effect of the preference to consume meso-lactide over L-lactide was tested in the polymerization of a mixture of meso-lactide and L-lactide monomers, under varying conditions, as follows.

### Aliquots Characterization of a Polymerization of a 10/90 Meso-Lactide/L-Lactide Monomer Mixture by Lig¹Zr(Oi-Pr)(i-PrOH) (Complex 2) at Room Temperature:

To gain insight on the relative consumption of meso-lactide and L-lactide from their mixture at room temperature, a polymerization of a mixed monomer composition in dichloromethane was performed at room temperature. The molar ratio of the monomers was 10:90 meso-lactide:L-lactide. Lig¹Zr(Oi-Pr)(i-PrOH) (complex 2) was employed as catalyst. 2-propanol was employed as initiator. Dichloromethane was used as solvent. The ratio of catalyst:initator:monomer mixture was 1/20/2000. The amount of catalyst employed was 1.25 micromol, and the initial volume of dichloromethane was 2 mL.

Aliquots were taken by extracting a small volume of the polymerization flask every five minutes for thirty minutes, and the polymerization was then allowed to proceed for 24 hours. Each aliquot was exposed to air to stop the polymerization and the volatiles were removed under vacuum. The remaining material consisted of unreacted monomers and formed polymer. This material was analyzed by ¹H NMR.

The conversion was calculated from the ratio of integration of the peak corresponding to the formed polymer to the integration of the peak corresponding to unreacted monomers. The composition of the remaining monomer was calculated from the ratio of integration of the peak corresponding to the unreacted L-lactide to the integration of the peak corresponding to the unreacted meso-lactide. The results are summarized in Table 4 below.

TABLE 4

| Time | Conv. | [L-LA/meso-LA] |
|---|---|---|
| [min] | [%] | ratio after quench |
| 5 | 11.5 | 96.2/3.8 |
| 10 | 16.4 | 97.5/2.5 |
| 15 | 20.1 | 98.3/1.7 |
| 20 | 23.7 | 99.0/1.0 |
| 25 | 26.0 | 99.4/0.6 |
| 30 | 29.3 | 99.6/0.4 |
| 1440 | 66.2 | — |

The obtained data demonstrate that the meso-lactide was consumed preferentially. Already after 5 minutes and overall monomer conversion of 11.5%, the composition of the unreacted monomer mixture changed from 10:90 meso-lactide:L-lactide to 3.8:96.2 meso-lactide:L-lactide, signifying a preferred polymerization of meso-lactide over L-lactide in the mixture. After 20 minutes, for example, 24% of the monomer mixture has been converted to polymer, and the composition of the unreacted monomer consisted of 1% of meso-lactide and 99% of L-lactide. Namely, while more than 90% of the meso-lactide have reacted after 20 minutes, only 16% of the L-lactide have reacted. After 24 hours, 67% of the monomer mixture was converted to PLA, and no meso-lactide could be detected. Thus, the segment (0-to-24%) of the polymer chains consisted of 37% meso-lactide and 63% of L-lactide, whereas the next segment (24%-to-67%) consisted of 2% meso-lactide and 98% of L-lactide, demonstrating a stereogradient structure of the formed PLA copolymer.

Polymerizations of Meso-Lactide/L-Lactide Monomer Mixtures with Lig¹Zr(Oi-Pr)(i-PrOH) (Complex 2) in the Melt:

Further polymerization runs of a meso-lactide/L-lactide mixtures of various ratios were conducted on a 10 gram scale in a pressure glass vessel with magnetic stirring employing a ratio of catalyst/initiator/monomer of about 1:59:59000.

Generally, in a heavy-walled 75 mL glass reactor were charged 1.17 micromol of the catalyst, an initiator (58.6 mol equivalents), and 9.91 grams (58600 mol equivalents) of a mixture of the lactide stereoisomers meso-lactide and L-lactide pre-purified by sublimation, at the indicated ratio. A magnetic stir bar was introduced and the reactor was sealed with a Teflon stopper. The reactor was heated to 180° C. by means of pre-heated wax-bath placed on a magnetic stir-plate. After the indicated time, the polymerization was stopped by removing the reactor from the heating bath, and opening it to air. The conversion of the monomer mixture to polymer and the relative amounts of each of the unreacted monomers were determined by ¹H NMR analyses.

To gain a preliminary indication on the activity of the catalyst towards the monomer mixture, and the possible selectivity of the catalyst towards meso-lactide under the harsh melt conditions, a short polymerization run of 10 minutes of a 10:90 mixture of meso-lactide/L-lactide was conducted with Lig¹Zr(Oi-Pr)(i-PrOH) (complex 2) as catalyst and benzyl alcohol as initiator.

¹H NMR analysis of the polymerization mixture revealed that 76% of the total monomer were converted to polymer. The remaining monomer was found to consist of more than 99% L-lactide, signifying that the meso-lactide was nearly completely consumed, and indicating the preference of the tested catalyst to polymerize meso-lactide over L-lactide even under the harsh melt conditions employed. Performing a similar polymerization run with tin-octanoate as a catalyst resulted in very similar conversion of 74%. However, the remaining monomer comprised both meso-lactide and L-lactide, in a proportion similar to that of the original polymerization mixture (10:90), signifying that tin octanoate does not exhibit noticeable preference for meso-lactide. These polymerization runs are consistent with the formation of a stereogradient copolymer attained when employing Lig¹Zr(Oi-Pr)(i-PrOH) (complex 2) as catalyst, and an essentially-random copolymer attained when employing tin-octanoate.

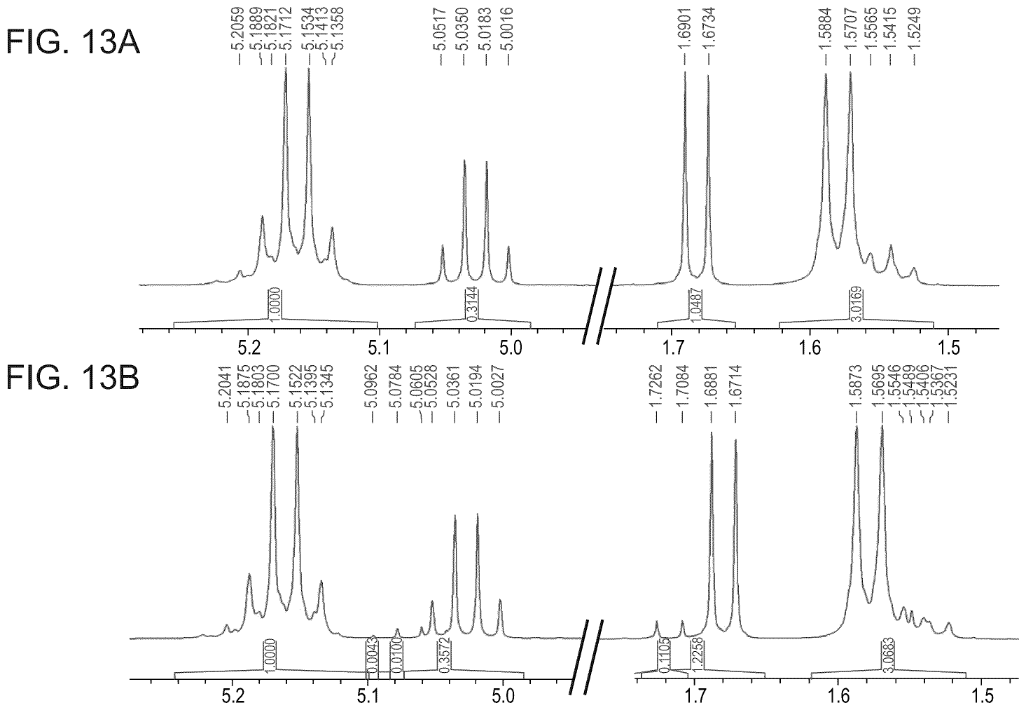

The differences between the crude polymerization samples attained with catalyst Lig¹Zr(Oi-Pr)(i-PrOH) (complex 2) and tin ocatanoate are readily visible in the corresponding ¹H NMR spectra shown in FIGS. 13A-B.

FIG. 13A, corresponding to polymerization with Lig¹Zr(Oi-Pr)(i-PrOH) (complex 2), shows that the remaining monomer is composed of L-lactide monomer only, namely all meso-lactide has already been consumed after 76% monomer conversion. This is apparent from a remaining monomer quartet at 5.025 ppm and a doublet at 1.68 ppm, both corresponding to L-lactide, but no apparent absorptions corresponding to meso-lactide.

FIG. 13B, corresponding to polymerization with tin octanoate, shows that the remaining monomer is composed of a mixture of meso-lactide and L-lactide in which the meso-lactide ratio had not changed relative to the original monomer mixture, namely, tin octanoate does not exhibit a preference to polymerize meso-lactide relative to L-lactide after 74% monomer conversion. This is apparent from a remaining monomer quartet at 5.025 ppm and a doublet at 1.68 ppm, both corresponding to L-lactide, and in addition a remaining monomer quartet at 5.07 ppm and a doublet at 1.715 ppm both corresponding to meso-lactide.

To gain insight on the properties of the stereogradient copolymers as a function of the relative amounts of stereoerrors, a series of melt polymerizations were run under the conditions described above. The meso-lactide/L-lactide monomer compositions included 10:90, 5:95, 2.5:97.5, 1:99, as well as pure L-lactide. These ratios represent typical compositions of lactide stereoisomers generated by various two-step as well as one-step lactide production processes. Three different catalyst/initiator combinations were tested: 1. Lig¹Zr(Oi-Pr)(i-PrOH) (complex 2) and benzyl alcohol (a single-headed initiator), which is expected to produce stereogradient copolymers wherein the stereoerrors concentrate in the terminus of the chain proximal to the initiator; 2. Lig¹Zr(Oi-Pr)(i-PrOH) (complex 2) and 1,4-benzenedimethanol (a double-headed initiator), which is expected to produce stereogradient copolymers wherein the stereoerrors concentrate in the central part of the chains proximal to the initiator; and 3. Tin-octanoate and benzyl alcohol, which is expected to produce essentially-random copolymers.

The obtained data is summarized in Table 5 below.

TABLE 5

| | | [L-LA/meso-LA] | Time | Conv. | Mₙ₍ₑₓₚ₎ | | M_{n(calc)} | Solubility |
|---|---|---|---|---|---|---|---|---|
| Entry | Catalyst | ratio | [min] | [%] | [g/mol]^{a} | PDI^{a} | [g/mol]^{b} | [mg/mL]^{c} |
| 11 | Complex 2 | 90/10 | 10 | 76 | 66400 | 1.10 | 109500 | 93 |
| 12 | Complex 2 | 90/10 | 30 | 90 | 92900 | 1.31 | 129700 | 70 |
| 13 | Complex 2 | 95/5 | 30 | 91 | 81600 | 1.22 | 131200 | 44 |
| 14 | Complex 2 | 97.5/2.5 | 30 | 91 | 107500 | 1.31 | 131200 | 18 |
| 15 | Complex 2 | 99/1 | 30 | 94 | 92700 | 1.14 | 135500 | 11 |
| 16 | Tin octanoate | 90/10 | 10 | 74 | 68600 | 1.40 | 106700 | ≥100 |
| 17 | Tin octanoate | 90/10 | 30 | 81 | 69300 | 1.50 | 116700 | ≥100 |
| 18 | Tin octanoate | 95/5 | 30 | 83 | 94600 | 1.45 | 119600 | ≥100 |
| 19 | Tin octanoate | 97.5/2.5 | 30 | 88 | 87900 | 1.69 | 126800 | 70 |
| 20 | Tin octanoate | 99/1 | 30 | 87 | 91700 | 1.57 | 125400 | 21 |
| 21^{d} | Complex 2 | 90/10 | 20 | 93 | 105500 | 1.19 | 134000 | 76 |
| 22^{d} | Complex 2 | 95/5 | 20 | 90 | 87200 | 1.12 | 129700 | 71 |
| 23^{d} | Complex 2 | 97.5/2.5 | 20 | 92 | 105300 | 1.22 | 132600 | 22 |
| 24^{d} | Complex 2 | 99/1 | 20 | 94 | 109000 | 1.20 | 135500 | 14 |
| 25 | Tin octanoate | 100/0 | 20 | 87 | 92700 | 1.58 | 125400 | 6 |
| 26 | Complex 2 | 100/0 | 7 | 84 | 102000 | 1.09 | 121100 | 6 |
| 27^{e} | Complex 2 | 95/5 | 60 | 94 | 95700 | 1.18 | 135500 | 36 |

^{a}The molecular weights and the PDI values of the polymers were determined by GPC relative to polystyrene standards and multiplied by a correction factor of 0.58.
${}^{b} Calculated according to the monomer conversion : {Mn}_{( calc )} = \frac{meso - {LA}_{( eq )}}{{iPrOH}_{( eq )}} \times 144.13 \frac{g}{mol} \times conv .$ ^{c}The solubility was measured according to the general PLA dissolution in THF procedure that is described above.
^{d}The polymerization was performed with 1,4-benzenedimethanol as an initiator.
^{e}The polymerization was performed in a ratio of 1/214/214000; cat/BnOH/LA.

The viscosity of the polymerization mixtures increased with time, and after several minutes (2-3 minutes for complex 2, and 6-7 minutes for tin octanoate) the stir-bar ceased to rotate. The polymerizations were quenched after either 20 or 30 minutes, in attempt to attain high conversions on one hand, while not promoting side-reactions on the other hand. According to ¹H NMR analysis of the polymerization mixtures, high conversions of 90-94% were obtained with Lig¹Zr(Oi-Pr)(i-PrOH) (complex 2) and lower conversions of 81-88% were obtained with tin octanoate, signifying a higher activity of Lig¹Zr(Oi-Pr)(i-PrOH) (complex 2) relative to tin octanoate.

¹H NMR analysis of the crude polymerization mixtures showed that, as expected, for all the polymerizations conducted with Lig¹Zr(Oi-Pr)(i-PrOH) (complex 2), no meso-Lactide could be detected in the remaining monomer. In contrast, for the 10:90 and 5:95 monomer compositions polymerized with tin octanoate, appreciable amounts of meso-lactide were detected in the remaining monomer albeit the relatively high conversions. When taking into consideration that, in the polymerization of the 10:90 meso-lactide/L-lactide monomer mixture with Lig¹Zr(Oi-Pr)(i-PrOH) (complex 2), essentially no meso-lactide remained after 76% conversion, then the 76%-to-90% segment of the polymer chains should be stereoerror-free. This is consistent with a stereoblock microstructure. For the monomer compositions lower in meso-lactide, the lengths of the stereoerror free segments are expected to be longer. A similar preference for meso-lactide was found when benzenedimethanol was employed as initiator together with Lig¹Zr(Oi-Pr)(i-PrOH) (complex 2), supporting the formation of stereogradient copolymers.

Removal of the remaining monomer gave the polymers as white powders which appeared similar to each other to the naked eye. All polymers were found to be of high molecular weights. Narrower molecular weight distributions were found for the polymers derived from Lig¹Zr(Oi-Pr)(i-PrOH) (complex 2) relative to those derived from tin octanoate, consistent with a better behaved polymerization by the former. The ¹H NMR and ¹³C NMR spectra were found to reflect the total number of stereoerrors in the obtained polymers, as exemplified in FIGS. 13A-B.

The difference between the samples became more apparent when their properties were assessed. A simple test enabling the comparative estimation of PLA crystallinity is measuring its solubility in THF. As can be seen in Table 5, for all catalyst/initiator combinations, a decrease in solubility was found as the relative amount of meso-lactide in the monomer mixture decreased. With the exception of the PLLA samples prepared with pure L-lactide, the samples prepared with the stereoselective Lig¹Zr(Oi-Pr)(i-PrOH) (complex 2) and either benzyl alcohol or benzenedimethanol were consistently less soluble than the samples prepared with tin octanoate, supporting the higher crystallinity of the stereogradient copolymers relative to the random copolymers. The differences in solubility are particularly notable for the high meso-lactide compositions. For example, the polymers prepared with tin octanoate and either 10% or 5% of meso-lactide showed a solubility of >100 mg/mL, whereas those prepared with Lig¹Zr(Oi-Pr)(i-PrOH) (complex 2) and benzyl alcohol showed a solubility of 70 and 44 mg/mL, respectively. Since the conversions are lower than 100% for all monomer compositions, the total number of stereoerrors in the stereogradient copolymers, for which all meso-lactide has been embedded, are higher than those found in the random copolymers, for which not all meso-lactide has been embedded. The higher crystallinity of the stereogradient copolymers is therefore even more impressive.

As can further be seen in Table 5, for all monomer ratios prepared with Lig¹Zr(Oi-Pr)(i-PrOH) (complex 2), lower solubilities were found for the polymers prepared with benzyl alcohol relative to benzenedimethanol. This suggests higher crystallinities for stereogradient copolymers which include a long single stereoerror-free segment rather than two shorter ones.

Differential scanning calorimetry (DSC) revealed several trends that were distinctly different for the polymers synthesized using Lig¹Zr(Oi-Pr)(i-PrOH) (complex 2) and tin octanoate.

The melting-crystallization behavior of the polymer samples with identical thermal history was comparatively examined. DSC thermograms, recorded during the second heating at 10° C. per minute temperature ramps after erasing the preceding thermal history and controlled cooling, were characterized in terms of temperatures and energies of thermal effects associated with melting and reorganization of the crystalline structures. The obtained data is presented in Table 6 below and exemplary data is also shown in FIGS. 14A-B and 15A-B.

As can be seen in Table 6 and FIGS. 14A-B and 15A-B, all polymer samples prepared from monomer mixtures poorer in meso-lactide showed higher melting temperatures and enthalpies. The polymers synthesized using benzyl alcohol rather than benzenedimethanol showed slightly higher melting temperatures indicating a better organized crystalline structure of the stereogradient copolymers having a single stereoerror-free segment. For all monomer compositions, the polymers synthesized using Lig¹Zr(Oi-Pr)(i-PrOH) (complex 2) showed systematically higher melting temperatures and enthalpies as compared with their tin octanoate synthesized counterparts. These differences were more pronounced for the polymers synthesized from the monomer mixtures richer in meso-lactide. For example, for the polymers synthesized from the monomer mixture containing 10% meso-lactide, no melting endotherm was detected for the sample synthesized using tin octanoate, whereas the sample prepared using Lig¹Zr(Oi-Pr)(i-PrOH) (complex 2), showed a melting peak temperature of 164.2° C. and a melting enthalpy of 5.9 J/g (Table 6 entries 12 and 17; FIGS. 14A-B). Similarly, for the monomer mixture containing 5% meso-lactide the polymer synthesized using tin octanoate showed a broad low intensity melting endotherm with peak temperatures and melting enthalpies of 161.3° C./1.6 J/g, respectively, while the polymer prepared with Lig¹Zr(Oi-Pr)(i-PrOH) (complex 2) demonstrated a prominent melting endotherm with two peaks (167.1 and 172.4° C.) and a melting enthalpy of 28.7 J/g. The differences in melting-crystallization behavior of the two types of the polymers, reflecting their important structural difference, are clearly seen in FIGS. 14A-B, presenting the melting temperatures as a function of the meso-lactide comonomer content in the monomer mixture. A monotonous decrease of the melting temperatures observed for the polymers derived from tin octanoate is characteristic for copolymers with random insertion of the comonomer units. In contrast, the essential independence of the melting temperatures at low comonomer contents followed by a gentle decrease at the higher contents, observed for the polymers produced using Lig¹Zr(Oi-Pr)(i-PrOH) (complex 2), are more in line with a block-type copolymers structure.

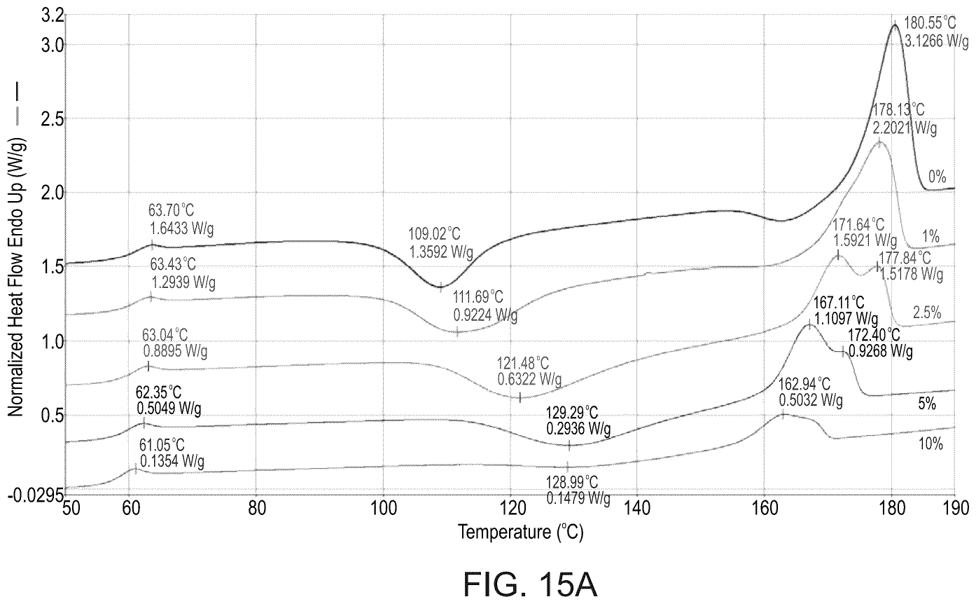

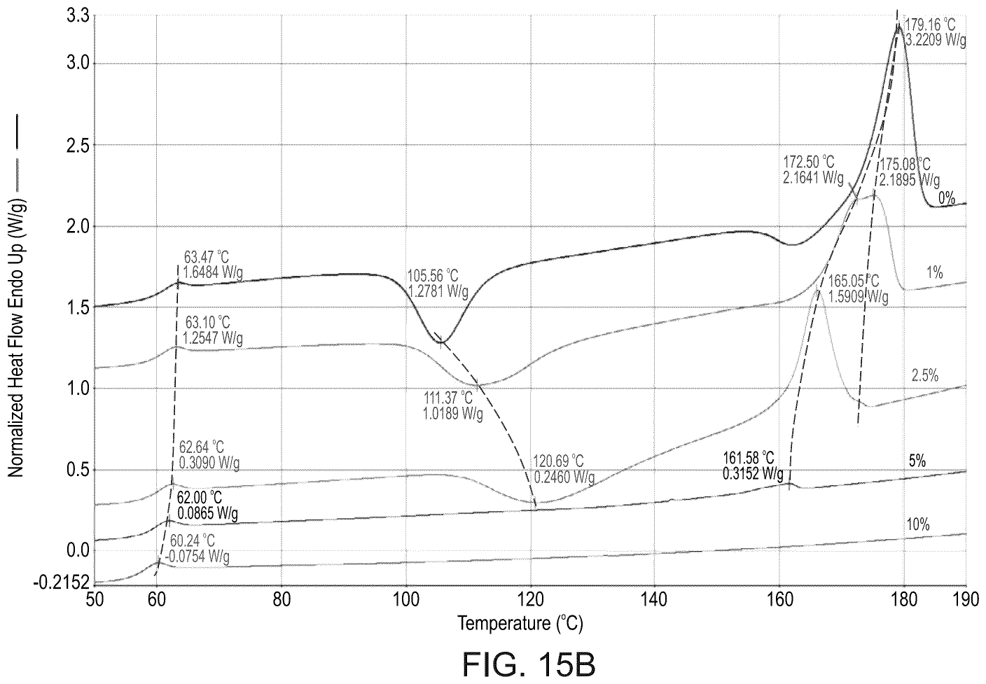

Comparative analysis of double-peak endotherms observed in some thermograms and associated with melting-reorganization of α′ and α PLA crystalline phases is shown in FIGS. 15A-B and further demonstrate that the polymers derived from Lig¹Zr(Oi-Pr)(i-PrOH) (complex 2) have significantly higher tendency for forming stable and better ordered α-crystallites than their tin octanoate derived counterparts.

The provision of stereogradient copolymers while employing a lower loading of Lig¹Zr(Oi-Pr)(i-PrOH) (complex 2) for a prolonged period of time was tested. A melt polymerization of meso-lactide/L-lactide mixture (5/95) employing Lig¹Zr(Oi-Pr)(i-PrOH) (complex 2)/benzyl alcohol/monomer ratio of 1:214:214000 (4.7 ppm catalyst) for 60 minutes led to 94% monomer conversion in which all meso-lactide was consumed, and the PLA obtained was of high molecular weight and narrow molecular weight distribution of 95700/1.18. The THE solubility (36 mg/mL) and thermal characteristics (Tₘ=166.6/173.6° C., deltaHₘ=31.7 J/g) were consistent with those of the stereogradient copolymers described above.

Thus, stereogradient copolymers featuring enhanced crystallinities are attained also under very low catalyst loadings and are not perturbed markedly by side reactions even after extended reaction times.

The data presented herein show that in the presence of catalysts that exhibit appreciable stereoselectivities stereogradient copolymers derived from mixtures of meso-lactide and L-lactide can be obtained. These sterereogradient copolymers were found to exhibit enhanced crystallinities relative to the corresponding random copolymers derived from the same monomer mixtures and employing the non-stereoselective tin octanoate. By employing such catalysts, polymers of desired crystallinity can be obtained from monomer mixtures of lower chiral purity. Tolerating the stereoimpurities in the polymer backbone rather than having to remove the impurities in the monomer stream that caused them, recudes the production cost of PLLA, contributing to its widespread replacement of non-degradable plastics.

TABLE 6

| | | | 2nd heating crystallization | | 2nd heating melting | | |
|---|---|---|---|---|---|---|---|
| | | [meso-LA] | Peak temp | Enthalpy | LT peak HT | peak | Enthalpy |
| Entry | Catalyst | % | (° C.) | (J/g) | (° C.) | (° C.) | (J/g) |
| 11 | Complex 2 | 10 | No crystallization exotherm | | 159.3 | No peak | 1.4 |
| 12 | Complex 2 | 10 | 136 | 3.2 | 164.2 | No peak | 5.9 |
| 13 | Complex 2 | 5 | 129.3 | 32.1 | 167.1 | 172.4 | 28.7 |
| 14 | Complex 2 | 2.5 | 121.5 | 44.3 | 171.7 | 177.8 | 33.6 |
| 15 | Complex 2 | 1 | 112 | 38.9 | No peak | 178.1 | 38.1 |
| 16 | Tin octanoate | 10 | No crystallization exotherm | | No melting endotherm | | |
| 17 | Tin octanoate | 10 | No crystallization exotherm | | No melting endotherm | | |
| 18 | Tin octanoate | 5 | No crystallization exotherm | | No peak | 161.3 | 1.6 |
| 19 | Tin octanoate | 2.5 | 120.7 | 39.8 | 166 | No peak | 30.7 |
| 20 | Tin octanoate | 1 | 111.5 | 44.8 | 172.4 | 175.1 | 34.1 |
| 21^{a} | Complex 2 | 10 | 132.3 | 7.8 | 163.8 | 166.5 | 5.6 |
| 22 | Complex 2 | 5 | 128.9 | 18 | 165.2 | No peak | 14.4 |
| 23^{a} | Complex 2 | 2.5 | 118.8 | 39.5 | 169.5 | 175.9 | 36.9 |
| 24^{a} | Complex 2 | 1 | 108.5 | 38.4 | No peak | 176.5 | 33.1 |
| 25 | Tin octanoate | 0 | 105.6 | 33.1 | No peak | 179.2 | 44.6 |
| 26 | Complex 2 | 0 | 109.2 | 30.3 | No peak | 180.6 | 45.1 |
| 27^{b} | Complex 2 | 5 | 126.2 | 32.8 | 166.6 | 173.6 | 31.9 |

^{a}The polymerization was performed with 1,4-benzenedimethanol as an initiator.
^{b}The polymerization was performed in a ratio of 1/214/214000; cat/BnOH/LA.

Polymerizations of Meso-Lactide/L-Lactide Monomer Mixtures with Lig¹Zr(Oi-Pr)(i-PrOH) (Complex 2) in the Melt Under More Demanding Conditions:

Polymerization of a 5:95 meso-lactide/L-lactide monomer mixture with a reduced loading of catalyst:

A lower loading of complex 2 was employed for a prolonged period of time. Melt polymerization of a meso-lactide/L-lactide mixture (5:95) employing complex 2/benzyl alcohol/monomer ratios of 1:214:214000 (4.7 ppm of catalyst) for 60 minutes led to 94% monomer conversion in which all meso-lactide was consumed, and the PLA obtained was of high molecular weight and narrow dispersity of 95700/1.18. The THF solubility (36 mg/mL) and thermal characteristics (Tₘ=166.6/173.6° C., ΔHₘ=31.7 J/g) are consistent with those of the stereogradient copolymers that were attained with higher catalyst loading.

Polymerization of 10:90 and 5:95 Meso-Lactide/L-Lactide Monomer Mixture with “Technical-Grade” Monomer:

A production of a stereogradient PLA from simulated “industrial-grade” lactide was performed. Monomer mixtures composed of meso-lactide/technical L-lactide in the ratios of 10:90 and 5:95 were polymerized at 180° C. for 60 minutes to promote high conversions for this slower-reacting technical monomer, employing complex 2/benzyl alcohol/monomer ratios of 1:59:59000.

In both cases high conversions of 94% were found, and the remaining monomer contained no meso-lactide, consistent with formation of stereogradient PLA copolymers.

In comparison to the samples prepared from the purified monomers, the THF-solubilities of the current samples (84 and 55 mg/mL, respectively) were slightly higher, possibly because of their lower molecular weights, while their heats of melting (6.4 and 31.0 J/g, respectively) were slightly higher consistent with the higher conversions. Diffusion NMR experiments, albeit being of relatively high errors (in particular for the 5:95 polymer sample), pointed to identical diffusion coefficients for the stereo-error containing and the stereo-error depleted portions of the polymer samples, giving further support for a stereogradient copolymer microsteructure rather than a mixture of polymers of different degrees of stereoregularities.

Polymerization of Meso-Lactide/L-Lactide Monomer Mixture with Lig⁵Zr(Oi-Pr)(i-PrOH) (Complex 3):
Polymerization of a 10:90 Meso-Lactide/L-Lactide Monomer Mixture with High Conversion Employing Lig¹Zr(Oi-Pr)(i-PrOH) (Complex 3) as Catalyst and Benzyl Alcohol as Initiator:

The polymerization followed the procedure and quantities described herein for Lig¹Zr(Oi-Pr)(i-PrOH) (complex 2), except for being pursued for 20 minutes. ¹H NMR analysis revealed that the conversion of monomer mixture to polymer was 93%, and that only homochiral L-lactide remained in the unreacted monomer. The amount of meso-lactide in the polymer was calculated to be 10.75%. Gel permeation chromatography analysis of the polymer revealed a molecular weight of Mₙ '₂ 106700 relative to a polystyrene standards calibration curve, and a molecular weight distribution of PDI=1.18. 25% of a 100 mg polymer sample were found to be insoluble in 1.0 mL of THF at 30° C. Differential Scanning Calorimetry (DSC) measurements showed a first heating double melting peak at 162.7 and 168.4° C. and deltaH melting of 36.0 J/g, and second heating melting peak at 166.8° C. and deltaH melting of 2.5 J/g.

Polymerization of a 5:95 Meso-Lactide/L-Lactide Monomer Mixture with High Conversion Employing Complex Lig⁵Zr(Oi-Pr)(i-PrOH) (Complex 3) as Catalyst and Benzyl Alcohol as Initiator:

The polymerization followed the procedure and time described hereinabove, except for employing a 5:95 meso-lactide/L-lactide monomer mixture. ¹H NMR analysis showed that the conversion of monomer mixture to polymer was 91%, and that only homochiral L-lactide remained in the unreacted monomer. The amount of meso-lactide in the polymer is calculated to be 5.5%.

Gel permeation chromatography analysis of the polymer revealed a molecular weight of Mₙ=95400 relative to a polystyrene standards calibration curve, and a molecular weight distribution of PDI=1.14. 47% of a 100 mg polymer sample were found to be insoluble in 1.0 mL of THF at 30° C. Differential Scanning Calorimetry (DSC) measurements showed a first heating melting peak at 167.3° C. and deltaH melting of 40.8 J/g, and second heating melting peak at 168.1° C. and deltaH melting of 26.8 J/g.

The obtained data is summarized in Tables 7 and 8 below.

TABLE 7

| | | [L-LA/meso-LA] | Time | Conv. | Mₙ₍ₑₓₚ₎ | | M_{n(calc)} | Solubility |
|---|---|---|---|---|---|---|---|---|
| Entry | Catalyst | ratio | [min] | [%] | [g/mol]^{a} | PDI^{a} | [g/mol]^{b} | [mg/mL]^{c} |
| 28 | Complex 3 | 90/10 | 20 | 93 | 106700 | 1.18 | 134000 | 75 |
| 29 | Complex 3 | 95/5 | 20 | 91 | 95400 | 1.14 | 131200 | 53 |

^{a}The molecular weights and the PDI values of the polymers were determined by GPC relative to polystyrene standards and multiplied by a correction factor of 0.58.
^{b}Calculated according to the monomer conversion.
^{c}The solubility was measured according to the general PLA dissolution in THE procedure described above.

TABLE 8

| | | | 2nd heating melting | | |
|---|---|---|---|---|---|
| | | meso-LA | LT peak | HT peak | Enthalpy |
| Entry | Catalyst | [%] | [° C.] | [° C.] | [J/g] |
| 28 | Complex 3 | 10 | 166.8 | No peak | 1.5 |
| 29 | Complex 3 | 5 | 168.1 | No peak | 26.8 |

Polymerization of D-Lactide/L-Lactide Monomer Mixture with Lig^{l}Zr(Oi-Pr)(i-PrOH) (Complex 2) and Comparative Polymerization with Tin Octanoate:
Polymerization of a 2.5:97.5 D-Lactide/L-Lactide Monomer Mixture with High Conversion Employing Lig¹Zr(Oi-Pr)(i-PrOH) (Complex 2) as Catalyst and Benzyl Alcohol as Initiator:

The polymerization followed the procedure, quantities and time described above except for employing a 2.5:97.5 D-lactide/L-lactide monomer mixture. ¹H NMR analysis revealed that the conversion of monomer mixture to polymer was 90%. Gel permeation chromatography analysis of the polymer revealed a molecular weight of Mₙ '₂ 94800 relative to a polystyrene standards calibration curve, and a molecular weight distribution of PDI=1.21. 68% of a 100 mg polymer sample were found to be insoluble in 1.0 mL of THF at 30° C. Differential Scanning Calorimetry (DSC) measurements showed a first heating double melting peak at 166.8 and 171.9° C. and deltaH melting of 47.8 J/g, and second heating double melting peak at 168.55° C. and 172.3° C. and deltaH melting of 15.9 J/g.

Comparative Polymerization of a 2.5:97.5 D-Lactide/L-Lactide Monomer Mixture with High Conversion Employing Tin Octanoate as Catalyst and Benzyl Alcohol as Initiator:

The polymerization followed the procedure, quantities and time described above, except for employing a 2.5:97.5 D-lactide/L-lactide monomer mixture. ¹H NMR analysis revealed that the conversion of monomer mixture to polymer was 88%. Gel permeation chromatography analysis of the polymer revealed a molecular weight of Mₙ '₂ 86500 relative to a polystyrene standards calibration curve, and a molecular weight distribution of PDI=1.47. 27% of a 100 mg polymer sample were found to be insoluble in 1.0 mL of THF at 30° C. Differential Scanning Calorimetry (DSC) measurements showed a first heating melting peak at 161.1 and ° C. and deltaH melting of 41.15 J/g, and second heating melting peak at 160.8° C. ° C. and deltaH melting of 12.91 J/g.

The obtained data is summarized in Tables 9 and 10.

TABLE 9

| | | [L-LA/D-LA] | Time | Conv. | Mₙ₍ₑₓₚ₎ | | M_{n(calc)} | Solubility |
|---|---|---|---|---|---|---|---|---|
| Entry | Catalyst | ratio | [min] | [%] | [g/mol]^{a} | PDI^{a} | [g/mol]^{b} | [mg/mL]^{c} |
| 30 | Complex 2 | 97.5/2.5 | 30 | 90 | 94800 | 1.21 | 129700 | 32 |
| 31 | Tin octanoate | 97.5/2.5 | 30 | 88 | 86500 | 1.47 | 126800 | 73 |

^{a}The molecular weights and the PDI values of the polymers were determined by GPC relative to polystyrene standards and multiplied by a correction factor of 0.58.
^{b}Calculated according to the monomer conversion
^{c}The solubility was measured according to the general PLA dissolution in THE procedure as mentioned herein.

TABLE 10

| | | | 2nd heating melting | | |
|---|---|---|---|---|---|
| | | D-LA | LT peak | HT peak | Enthalpy |
| Entry | Catalyst | [%] | [° C.] | [° C.] | [J/g] |
| 30 | Complex 2 | 2.5 | 168.55 | 172.3 | 15.9 |
| 31 | Tin octanoate | 2.5 | 160.8 | No peak | 12.9 |

Polymerization of Meso-Lactide/L-Lactide Monomer Mixture with Lig⁶Zr(Oi-Pr)(i-PrOH) (Complex 4):
Polymerization of a 10:90 Meso-Lactide/L-Lactide Monomer Mixture with High Conversion Employing Lig⁶Zr(Oi-Pr)(i-PrOH) (Complex 4) as Catalyst and Benzyl Alcohol as Initiator:

The polymerization followed the procedure employing a ratio of catalyst/initiator/monomer of 1:50:50000. A glass pressure flask was charged with 0.94 micromol of the catalyst, an initiator (50 mol equivalents), and 6.76 grams (50000 mol equivalents) of a mixture of the lactide stereoisomers meso-lactide and L-lactide pre-purified by sublimation, at the indicated ratio.

¹H NMR analysis revealed that the conversion of monomer mixture to polymer was 93%, and that only homochiral L-lactide remained in the unreacted monomer. The amount of meso-lactide in the polymer was calculated to be 10.75%. Gel permeation chromatography analysis of the polymer revealed a molecular weight of Mₙ=107800 relative to a polystyrene standards calibration curve, and a molecular weight distribution of PDI=1.56. Differential Scanning Calorimetry (DSC) measurements showed a first heating melting peak at 168.0° C. and deltaH melting of 35.8 J/g, and second heating melting peak at 167.0° C. and deltaH melting of 4.2 JIg.

To find out whether the syndioselective catalysts would exhibit a higher tendency to polymerize meso-lactide over L-lactide at lower temperature, further polymerization runs of a meso-lactide/L-lactide mixtures of various ratios were conducted on a 7 gram scale in a pressure glass vessel with magnetic stirring employing a ratio of catalyst/initiator/monomer of 1:50:50000 at 130° C.

The obtained data is summarized in Tables 11 and 12 below.

TABLE 11

| | L-LA/ | | | | | | |
|---|---|---|---|---|---|---|---|
| | meso-LA | Temp | Time | Conv. | M_{n (exp)} | | M_{n (calc)} |
| Entry | ratio | [° C.] | [min] | [%] | [g/mol]ª | Ð^{a} | [g/mol]^{b} |
| 21 | 90/10 | 180 | 30 | 93 | 107800 | 1.56 | 128900 |
| 22 | 90/10 | 137-130 | 30 | 89 | 93500 | 1.12 | 123300 |
| 23 | 90/10 | 130 | 30 | 77 | 71000 | 1.06 | 106700 |
| 24 | 90/10 | 130 | 60 | 85 | 72500 | 1.07 | 117800 |
| 25 | 85/15 | 130 | 30 | 77 | 66400 | 1.06 | 106700 |
| 26 | 85/15 | 130 | 30 | 79 | 55500 | 1.07 | 109500 |
| 27 | 85/15 | 130 | 60 | 84 | 60700 | 1.07 | 116400 |
| 28 | 80/20 | 130 | 60 | 92 | 89900 | 1.09 | 123300 |

^{a}The molecular weights and the PDI of the polymers were determined by GPC relative to polystyrene standards and multiplied by a correction factor of 0.58.
^{b}Calculated according to the monomer conversion:
${Mn}_{( calc )} = \frac{{LA}_{( equiv . )}}{{iPrOH}_{( equiv . )} + X} \times 144.13 g / mol \times conv .$ (X is the number of monodentate alkoxide and alcohol groups bound to the metal).

TABLE 12

| | First | | Cooling | Second heating run | | | |
|---|---|---|---|---|---|---|---|
| | heating run | | T_{c} − ΔH_{c} | | | | T_{c} − ΔH_{c} |
| | Tₘ | ΔHₘ | [° C. − | T_{g} | Tₘ | ΔHₘ | [° C. − |
| Entry | [° C.] | [J/g] | J/g] | [° C.] | [° C.] | [J/g] | J/g] |
| 21 | 168.0 | 35.8 | — | 58.6 | 167.0 | 4.2 | 139.3 − 4.4 |
| 22 | 173.9^{c} | 35.8 | — | 58.2 | 170.6 | 16.2 | 139.3 − 13.3 |
| 23 | 168.3 | 29.2 | — | 58.1 | 163.9 | 7.3 | 139.5 − 6.5 |
| 24 | 169.2 | 28.5 | — | 57.7 | 166.1 | 19.1 | 136.0 − 21.0 |
| 25 | 162.9 | 22.1 | — | 55.5 | 164.8 | 0.4 | — |
| 26 | 162.4^{d} | 21.9 | — | 56.2 | 164.5 | 0.8 | 139.4 − 0.7 |
| 27 | 164.9 | 24.6 | — | 55.5 | 167.2 | 2.7 | 139.2 − 1.4 |
| 28 | 169.3^{e} | 25.9 | — | 55.5 | 170.8 | 2.9 | 145.1 − 3.7 |

^{c}Additional peak at 165° C. (35.8 J/g).
^{d}Additional peak at 151° C. (21.9 J/g).
^{e}Additional peak at 160° C. (25.9 J/g).

Additional experiments were performed while adding toluene in different amounts in order to further decrease the polymerization temperature to below 130° C. The data obtained in these experiments is presented in Tables 13 and 14

TABLE 13

| | | L-LA/ | | | | | | |
|---|---|---|---|---|---|---|---|---|
| | | meso-LA | Temp | Time | Conv. | M_{n (exp)} | | M_{n (calc)} |
| Entry | Toluene | ratio | [° C.] | [min] | [%] | [g/mol]^{a} | D^{a} | [g/mol]^{b} |
| 29 | 3 mL | 80/20 | 100 | 60 | 83 | 88700 | 1.05 | 115000 |
| 30 | 7 mL | 80/20 | 100 | 60 | 92 | 107500 | 1.06 | 127500 |
| 31 | 8 mL | 80/20 | 100 | 120 | 86 | 87000 | 1.04 | 119200 |
| 32 | 15 mL | 80/20 | 100 | 120 | 78 | 73600 | 1.05 | 108100 |

TABLE 14

| | First | | Cooling | Second heating run | | | |
|---|---|---|---|---|---|---|---|
| | heating run | | T_{c} − ΔH_{c} | | | | T_{c} − ΔH_{c} |
| | Tₘ | ΔHₘ | [° C. − | T_{g} | Tₘ | ΔHₘ | [° C. − |
| Entry | [° C.] | [J/g] | J/g] | [° C.] | [° C.] | [J/g] | J/g] |
| 29 | 172.9^{f} | 29.7 | — | 55.7 | 173.2 | 6.5 | 143.8 − 6.7 |
| 30 | 175.7^{g} | 22.5 | — | 56.7 | 174.0 | 4.7 | 144.1 − 3.5 |
| 31 | 172.9 | 28.0 | — | 55.0 | 174.8 | 7.9 | 145.4 − 9.4 |
| 32 | 172.1^{h} | 24.6 | — | 55.0 | 171.7 | 7.3 | 145.0 − 4.9 |

^{f}Additional peak at 162° C. (29.7 J/g).
^{g}Additional peak at 166° C. (22.5 J/g).
^{h}Additional peak at 160° C. (24.6 J/g).

It can be seen that Complex 4 was found, unexpectedly, to be even more syndioselective in its polymerization of meso-lactide in comparison, for example, to the zirconium complex of Ligi.

### Reversed Stereogradient Polymer

To find out whether the syndioselective catalysts could produce crystalline syndiotactic PLA even from less pure meso-lactide that includes a higher proportion of L-lactide, polymerization of a meso-lactide/L-lactide mixture of 85/15 ratio was conducted at room temperature, using complex 4. Such a mixture is commercially available from, for example, Natureworks. Studies were conducted using a ratio of 1:10:10000 of Lig⁶Zr(Oi-Pr)(i-PrOH)/iPrOH/total lactides in 7 mL of dichloromethane at room-temperature with aliquots taken during the polymerization. The polymerization was stopped after 90 minutes.

¹H NMR analysis of the aliquots revealed that the meso-lactide was consumed preferentially, as evident from a growing proportion of the L-lactide in the unreacted monomer, namely, the polymerization followed a kinetic resolution profile. After 90 minutes, 89.6% of the monomer mixture was converted to polymer, and the ratio of meso-lactide/L-lactide in the unreacted monomer was 19.7:80.3, namely, the remaining meso-lactide was now the minor stereoisomer, and the remaining L-lactide was now the major stereoisomer. The amount of L-lactide in the polymer was calculated to be 7.4%. Some of the samples were characterized by DSC and were all found to show a first heating melting endotherm. The crystallinity of the samples, manifested in their melting temperatures, was found to decrease as a function of conversion, because of accumulating errors caused by L-lactide insertion. Still, even the sample taken at the end of the polymerization process was found to be crystalline. The obtained data is summarized in Table 15 below.

TABLE 15

| | | | | | | [meso-LA / L- | | | |
|---|---|---|---|---|---|---|---|---|---|
| | | | | | | LA] ratio | | | |
| Time | Conv. | | Mₙ₍ₑₓₚ₎ | | M_{n(calc)} | unreacted | Tₘ | ΔHₘ | T_{g} |
| [min] | [%] | Pₛ | [g/mol] | PDI | [g/mol] | monomer | [° C.]^{e} | [J/g]^{e} | [° C.]^{f} |
| 2 | 4.5 | 0.956 | 7800 | 1.07 | 5400 | 84.8/15.2 | — | — | — |
| 4 | 9.2 | 0.956 | 13000 | 1.07 | 11000 | 84.1/15.9 | 132^{a} | 23.2 | 40 |
| 7 | 18.8 | 0.950 | 20700 | 1.07 | 22600 | 82.2/17.8 | — | — | — |
| 10 | 25.7 | 0.940 | 28500 | 1.08 | 30900 | 81.1/18.9 | 123^{b} | 20.4 | 37 |
| 30 | 67.2 | 0.939 | 75200 | 1.09 | 80700 | 62.4/37.6 | 121^{c} | 4.4 | 36 |
| 60 | 82.5 | 0.917 | 81800 | 1.14 | 99100 | 37.2/62.8 | 99^{d} | 0.9 | 41 |
| 90 | 89.6 | 0.938 | 70500 | 1.27 | 107600 | 19.7/80.3 | 99 | 29.6 | 41 |

^{a}Thermogram presents a double peak at 120° C. (ΔH = 23.2 J/g). Another peak appears at 84° C. (ΔH = 1.7 J/g).
^{b}Thermogram presents a double peak at 103° C. (ΔH = 20.4 J/g).
^{c}Thermogram presents a double peak at 98° C. (ΔH = 4.4 J/g).
dThermogram presents a double peak at 83° C. (ΔH = 0.9 J/g).
^{e}DSC first heating run.
^{f}DSC second heating run.

Theses data demonstrate that the complex is able to produce crystalline syndiotactic PLA also from a mixture enriched with meso-lactide because of its kinetic resolution—it reacts faster with the meso-lactide than with the L-lactide.

### Example 9

### PEG-Polyester Copolymers

ROP of meso-lactide using the catalysts described herein was practiced with a polymeric co-catalyst that bears a hydroxy group, with the aim of preparing block copolymers. Poly(ethylene glycol) (PEG) featuring hydroxy groups on its two termini and an average molecular weight of 5,000 Da was selected as a representative example as it is used in various medical applications for providing PEG-polyester block copolymers.

Polymerization in Solution at Room Temperature with PEG₅₀₀₀ (OH)h as Initiator:

In 2 mL of dichloromethane at room-temperature were dissolved 2.3 mg of complex Lig¹Zr(Oi-Pr)(i-PrOH) (complex 2) as catalyst and 124.9 mg of PEG₅₀₀₀(OH)₂ as initiator and the solution was stirred for 15 minutes. Thereafter, 360 mg of meso-lactide of 98% sterochemical purity—molar ratios of catalyst/PEG/meso-lactide of 1:10.7:1070—was added. The polymerization was pursued for 6 hours, and was thereafter quenched by opening the reaction to air. ¹H NMR showed that the conversion was 72%. GPC analysis showed a formation of a copolymer rather than a mixture of PEG and PLA, according to the narrow molecular weight distribution. Calculation of the number average molecular weight by NMR gave a value of Mₙ '₂ 15900. The polymer featured a degree of syndiotacticity, similar to that obtained with 2-propanol. Differential scanning calorimetry analysis revealed two melting transitions in the first heating run corresponding to the PEG block at a temperature of 44.4° C. and heat of melting of 21.5 J/g and to the syndiotactic-PLA block at a temperature of 123.5° C. and heat of melting of 25.7 J/g.

Polymerization of a 10:90 Meso-Lactide/L-Lactide Monomer Mixture at 130° C. with Lig¹Zr(Oi-Pr)(i-PrOH) (Complex 2) as Catalyst and PEG₅₀₀₀(OH)₂ as Initiator to Obtain a Low Molecular Weight PEG-(Stereogradient)PLA Block Copolymer:

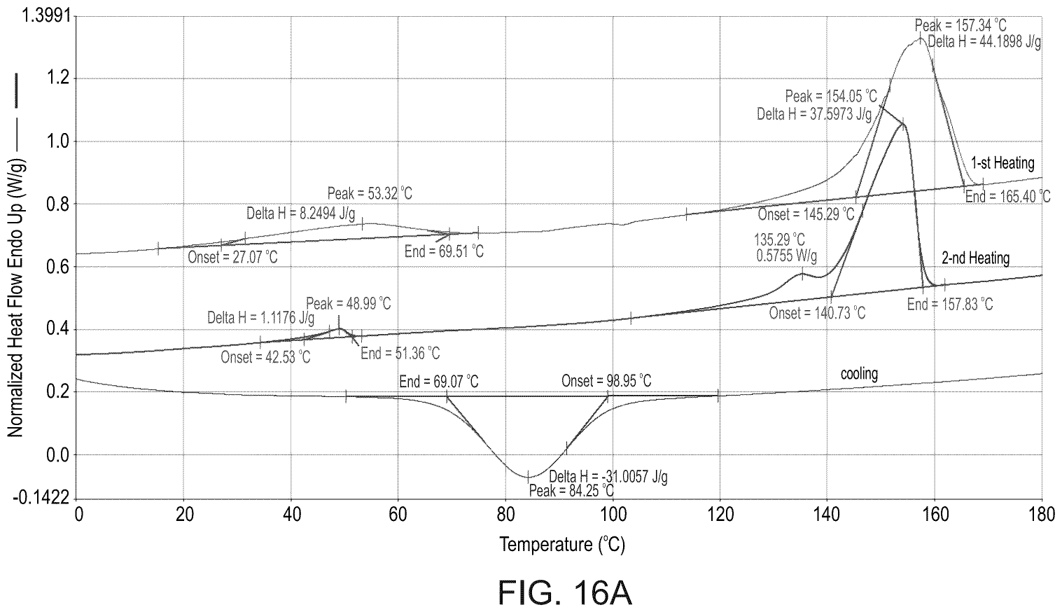

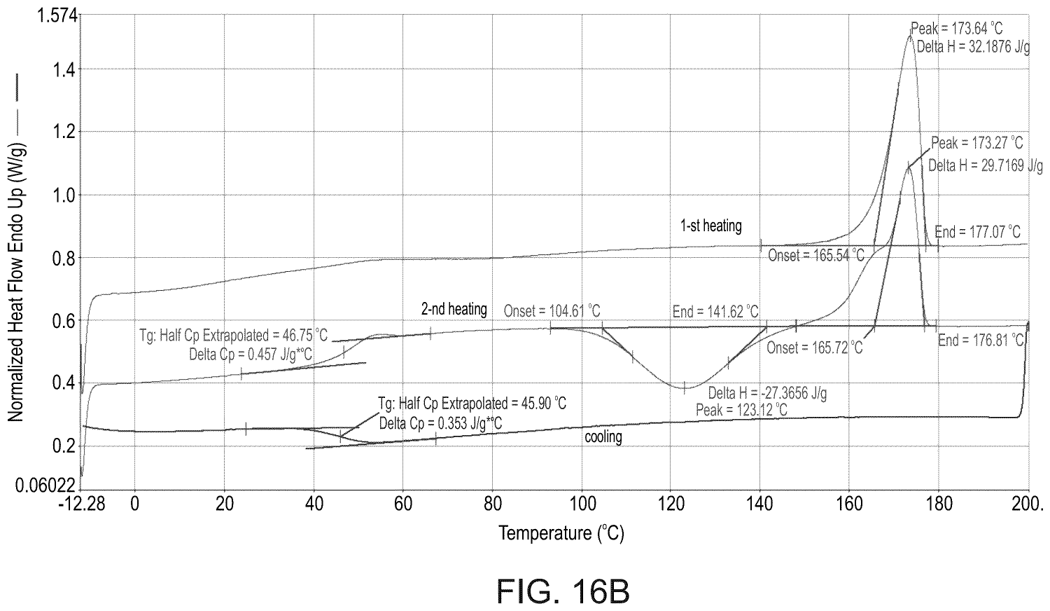

2.3 mg of Lig¹Zr(Oi-Pr)(i-PrOH) (complex 2) as catalyst, 124.9 mg of PEG₅₀₀₀(OH)₂ as initiator and 360 mg of a lactide monomer mixture in a ratio of 10:90 meso-lactide/L-lactide-molar ratios of catalyst/initiator/monomer 1:10.7:1070 was introduced in a glass vial, and was heated up 130° C. for 10 minutes. The polymerization was thereafter quenched by opening the reaction to air. ¹H NMR revealed that the conversion was 93%. GPC analysis revealed the formation of a copolymer rather than a mixture of PEG and PLA, according to the narrow molecular weight distribution. Calculation of the number average molecular weight by NMR gave a value of MX=18600. Differential scanning calorimetry analysis revealed two melting transitions in the first heating run corresponding to the PEG block at a temperature of 53.3° C. and heat of melting of 8.25 J/g and to the srtereogradient-PLA block at a temperature of 157.3° C. and heat of melting of 44.2 J/g, a crystallization exotherm at 84.3° C. and deltaH crystallization of 31.0 J/g, and a mlting transition in the second heating run at a temperature of 154.0° C. and heat of melting of 37.7 J/g, and is portrayed in FIG. 16A.

Polymerization of a 10:90 Meso-Lactide/L-Lactide Monomer Mixture at 130° C. with Lig¹Zr(Oi-Pr)(i-PrOH) as Catalyst and PEG₅₀₀₀(OH)₂ as Initiator to Obtain a High Molecular Weight PEG-(Stereogradient)PLA Block Copolymer:

2.0 mg of Lig¹Zr(Oi-Pr)(i-PrOH) (complex 2) as catalyst, 53.3 mg of PEG₅₀₀₀(OH)₂ as initiator and 1.538 grams of a lactide monomer mixture in a ratio of 10:90 meso-lactide/L-lactide—molar ratios of catalyst/initiator/monomer 1:5:5000 was introduced in a glass vial, and was heated up 130° C. for 30 minutes. The polymerization was thereafter quenched by opening the reaction to air. ¹H NMR revealed that the conversion was 96%. GPC analysis revealed the formation of a copolymer rather than a mixture of PEG and PLA, according to the narrow molecular weight distribution. Calculation of the number average molecular weight by NMR gave a value of M=141000. Differential Scanning Calorimetry (DSC) measurements showed a first heating melting peak at 173.6 and ° C. and deltaH melting of 32.2 J/g, and second heating melting peak at 173.3° C. ° C. and deltaH melting of 29.7 J/g, and is portrayed in FIG. 16B.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. An organometallic complex represented by Formula I: 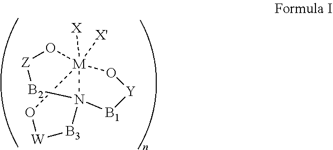
wherein:
n is 1, 2, 3 or 4, representing the nuclearity of the complex;
the dashed line represents a covalent or a coordinative bond representing a bond between a donor atom and a metal;
M is a tetravalent (group 4) metal;
X is a monoanionic ligand;
X′ is a neutral ligand, such as an alcohol, or is absent;
W, Y and Z are each independently arylelne or heteroarylene, at least one of W, Y and Z being a substituted arylene or heteroarylene, said at least one substituted arylene or heteroarylene comprising at least one aromatic (aryl or heteroaryl) substituent; and
B1, B2 and B3 are each independently a bridging moiety linking between the respective aryl or heteroaryl and the nitrogen atom, or is absent.

2. The complex of claim 1, wherein M is zirconium or hafnium.

3. The complex of claim 1, wherein X is selected from alkyl, alkaryl, cycloalkyl, aryl, amide, alkoxy, thioalkoxy, aryloxy, thioaryloxy, halo and amine.

4. The compound of claim 1, wherein X′ is a neutral ligand selected from alkyl alcohol, aryl alcohol, aralkyl alcohol, and amine.

5. The compound of claim 1, wherein X and X′ form together a monoanionic bidentate ligand.

6. The compound of claim 1, wherein each of said bridging moieties is independently a hydrocarbon of from 1 to 6, or from 1 to 4, or from 1 to 2, carbon atoms in length.

7. The complex of claim 1, being represented by Formula II: 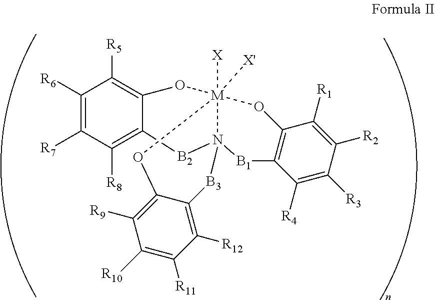
wherein:
R₁-R₁₂ are each independently selected from hydrogen, alkyl, cycloalkyl, heteroalicyclic, aryl, heteroaryl, halo, alkoxy, and amino, or alternatively, two of R₁-R₄, and/or two of R₅-R₈, and/or two of R₉-R₁₂ independently form together a cyclic ring (fused to the phenolate ring),
wherein at least one of R₁-R₁₂ is a substituted or unsubstituted aryl or heteroaryl.

8. The complex of claim 1, being represented by Formula III: 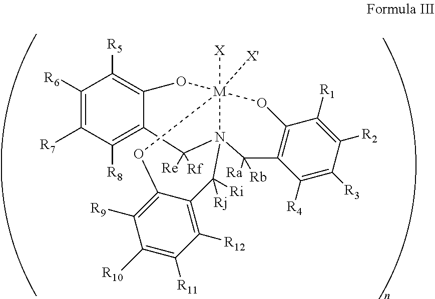
wherein:
R₁-R₁₂ are each independently selected from hydrogen, alkyl, cycloalkyl, heteroalicyclic, aryl, heteroaryl, halo, alkoxy, and amino, or alternatively, two of R₁-R₄, and/or two of R₅-R₈, and/or two of R₉-R₁₂ independently form together a cyclic ring (fused to the phenolate ring), wherein at least one of R₁-R₁₂ is a substituted or unsubstituted aryl or heteroaryl; and
Ra, Rb, Re, Rf, Ri and Rj are each independently hydrogen, alkyl, cycloalkyl, aryl, heteroaryl, heteroalicyclic, hydroxyl, alkoxy, thiol, thioalkoxy, aryloxy, and amine, or, alternatively, Ra and Rb and/or Rc and Rd, if present, form together a 5-membered, 6-membered or 7-membered alicyclic, heteroalicyclic, aromatic or heteroaromatic ring.

9. The complex of claim 8, wherein at least one of R₁, Rₛ and R₉ is a substituted or unsubstituted aryl or heteroaryl and/or at least one of R₂-R₄, R₆-R₈ and R₁₀-R₁₂ is an alkyl.

10. The complex of claim 1, being represented by Formula IIa: 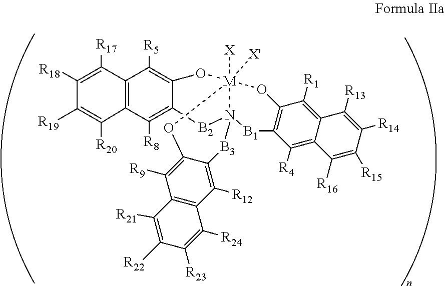
wherein:
R₁, R₄, R₅, R₈, R₉, R₁₂, R₁₃-R₁₆, R₁₇-R₂₀ and R₂₁-R₂₄ are each independently selected from hydrogen, alkyl, cycloalkyl, heteroalicyclic, aryl, heteroaryl, halo, alkoxy, and amino, or alternatively, two or more of R₁, R₄, and R₁₃-R₁6, and/or two or more of R₅, R₈, and R₁₇-R₂₀, and/or two or more of R₉, R₁₂ and R₂₁-R₂₄ independently form together one or more a cyclic ring(s) (fused to the phenolate ring),
wherein at least one of R₁, R₄, R₅, R₈, R₉, R₁₂, R₁₃-R₁₆, R₁₇-R₂₀ and R₂₁-R₂₄ is a substituted or unsubstituted aryl or heteroaryl.

11. The complex of claim 1, being represented by Formula IIIa: 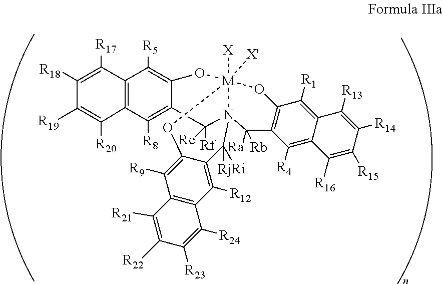
wherein:
Ra, Rb, Re, Rf, Ri and Rj are each independently hydrogen, alkyl, cycloalkyl, aryl, heteroaryl, heteroalicyclic, hydroxyl, alkoxy, thiol, thioalkoxy, aryloxy, and amine, or, alternatively, Ra and Rb and/or Re and Rd, if present, form together a 5-membered, 6-membered or 7-membered alicyclic, heteroalicyclic, aromatic or heteroaromatic ring.

12. The complex of claim 11, wherein at least one of R₁, R₅ and R₉ is said substituted or unsubstituted aryl or heteroaryl.

13. A process of ring opening polymerization of a cyclic ester, the process comprising contacting the cyclic ester with a catalyst system comprising an organometallic complex according to claim 1, to thereby obtain a polyester-containing polyester material.

14. The process of claim 13, wherein said catalyst system further comprises a co-catalyst.

15. The process of claim 13, wherein said cyclic ester is selected from a lactide and a lactone.

16. The process of claim 15, wherein said lactide is or comprises a meso-lactide.

17. The process of claim 13, wherein said organometallic complex is formed in situ such that said contacting is with a ligand precursor represented by Formula IV: 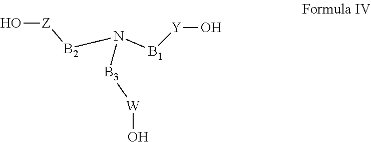
wherein:
M and X are as defined herein for Formula I and X₁, X₂ and X₃ are each independently a monoanionic ligand; and
B1, B2, B3, X, Y and W are each independently as defined herein for Formula I.

18. The process of claim 17, wherein said ligand is represented by Formula V or by Formula VI: 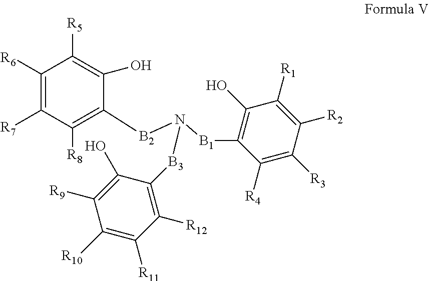
wherein B1, B2, B3 and R₁-R₁₂ being as defined herein for Formula II; 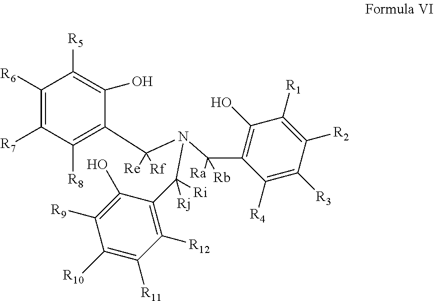
wherein Re, Rf, Ra, Rb, Ri, Rj and R₁-R₁₂ being as defined herein for Formula IIa.

19. The process of claim 13, wherein said contacting is at a temperature at which said polyester is in a molten state.

20. A process according to claim 13, being for preparing a stereoblock copolymer comprised of at least one unit of polymerized monomers of a cyclic ester featuring a first stereoconfiguration and at least one unit of polymerized monomers of a cyclic ester featuring a second stereoconfiguration, said first and said second stereoconfigurations being different from one another, the process comprising sequentially contacting a plurality of monomers of said cyclic ester featuring said first stereoconfiguration and a plurality of monomers of said cyclic ester featuring said second stereoconfiguration with said catalyst system.

21. The process of claim 13, being for preparing a stereogradient polyester which comprises at least two segments of said polyester, each segment comprising a first plurality of backbone units of a first lactide featuring a first stereoconfiguration and a second plurality of backbone units of a second lactide featuring a second stereoconfiguration, said first and second stereoconfigurations being different from one another, wherein each segment comprises a different mol ratio of said first and second pluralities of backbone units, the process comprising contacting a mixture of said first and second lactides with said catalyst system.

22. The process of claim 21, wherein one of said first and second lactides is a meso-lactide.

23. The process of claim 13, wherein said catalyst system comprises a polymeric co-catalyst, the process being for preparing a block copolymer that comprises one block of said polymeric moiety derived from said co-catalyst and at least one block of said polyester.

24. A polyester-containing polymeric material obtainable by the process of claim 13.
